(19) United States
(12) Patent Application Publication
(10) Pub. No.: US 2026/0120120 A1
(43) Pub. Date: Apr. 30, 2026

(54) SYSTEM AND METHOD FOR ACCELERATING AND AUTOMATING REGULATORY DOSSIER AND SYSTEMATIC REVIEW PLANNING AND WRITING FROM MULTIPLE COMPLEX INPUTS, IN ALIGNMENT WITH GUIDELINES, USING AI

(71) Applicant: Tehistark LTD, London (GB)

(72) Inventors: Meelis Lootus, London (GB); Lulu Zhao Beatson, London (GB)

(73) Assignee: Tehistark LTD, (omitted)

(21) Appl. No.: 19/368,774

(22) Filed: Oct. 24, 2025

Related U.S. Application Data
(60) Provisional application No. 63/711,679, filed on Oct. 24, 2024.

(51) Int. Cl. G06Q 30/018

(52) U.S. Cl. CPC G06Q 30/018

(57) ABSTRACT

Systems and methods for automating generation of dossiers that are compliant with regulatory guidelines are disclosed. The system comprises dossier generation logic configured to generate a regulatory-compliant dossier for a target. The system further comprises a first processing engine configured to take as input a set of source documents associated with the target and a set of dossier requirements associated with the regulatory-compliant dossier. The first processing engine is configured to process source documents in dependence upon dossier requirements in the set of dossier requirements and to determine one or more source sections. The system comprises a second processing engine, in communication with the first processing engine, and configured to take as input the one or more source sections in the source documents and section-wise guidelines for generating the corresponding dossier sections. The second processing engine is configured to generate as output the regulatory-compliant dossier.

### PRIORITY DATA

This application claims the benefit of and priority to U.S. Provisional Patent Application No. 63/711,679, titled “SYSTEM AND METHOD FOR ACCELERATING AND AUTOMATING REGULATORY DOSSIER AND SYSTEMATIC REVIEW PLANNING AND WRITING FROM MULTIPLE COMPLEX INPUTS, IN ALIGNMENT WITH GUIDELINES, USING AI,” filed on Oct. 24, 2024 (Attorney Docket No. TEHI1000USP01). The priority provisional application is incorporated herein by reference in its entirety and for all purposes as if completely and fully set forth herein.

### FIELD OF THE TECHNOLOGY DISCLOSED

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. In particular, the technology disclosed relates to use of artificial intelligence and machine learning techniques to plan, create, organize and manage complex structured documents.

### BACKGROUND OF THE TECHNOLOGY DISCLOSED

In various industries, the planning, preparation, quality control and submission of regulatory and compliance documents are critical processes for product approval, safety assessments, and compliance with governmental standards. These documents, often referred to as dossiers, involve the organization and presentation of vast amounts of intricate data from multiple sources, which must adhere to strict, often complex and changing regulatory frameworks. This process is particularly complex in pharmaceuticals and biotechnology, where dossiers such as Investigational New Drug (IND) applications, New Drug Applications (NDA), Clinical Study Reports (CSR), and Marketing Authorization Applications (MAA), Health Technology Assessment (HTA) submissions are required by regulatory agencies like the U.S. Food and Drug Administration (FDA), the European Medicines Agency (EMA), and other national authorities.

Traditionally, the planning, preparation, review, quality control and maintenance of such dossiers has been a manual, time-intensive process, involving data collection, formatting, and compliance checks across multiple stages of drug development. The data collection can include searching public and/or private data sources such as searching regulator websites to get desired data. This manual process is prone to human error and inefficiency, particularly as the volume and complexity of required data increase.

Therefore, an opportunity arises to develop systems and methods for efficient planning, preparation, quality control and management of dossiers and other documents with complex structures with minimal chances of human errors.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 presents a high-level architecture of a data comprehender subsystem that can access public and private data sources to generate various types of derived data for use by the technology disclosed.

FIG. 2 is a schematic representation of an encoder-decoder architecture.

FIG. 3 shows an overview of an attention mechanism added onto an RNN encoder-decoder architecture.

FIG. 4 is a schematic representation of the calculation of self-attention showing one attention head.

FIG. 5 is a depiction of several attention heads in a Transformer block.

FIG. 6 is an illustration that shows how one can use multiple workers to compute the multi-head attention in parallel, as the respective heads compute their outputs independently of one another.

FIG. 7 is a portrayal of one encoder layer of a Transformer network.

FIG. 8 shows a schematic overview of a Transformer model.

FIG. 9 is a depiction of a Vision Transformer (ViT).

FIG. 10 illustrates a processing flow of the Vision Transformer (ViT).

FIG. 11 shows example software code that implements a Transformer block.

FIG. 12 presents an example high-level architecture of Auto-Dossier subsystem comprising processing engines for generating regulator-compliant dossiers.

FIG. 13 presents an illustration of mapping logic that maps portions of input data to sections of output documents such as dossiers.

FIG. 14 presents an example user interface comprising various user interface elements that allow users to select input data for use in preparation of output documents such as dossiers.

FIG. 15A presents an example user interface for processing selected input data to generate output documents such as dossiers.

FIG. 15B presents examples of additional user interface elements that are part of the example user interface of FIG. 15A.

FIG. 16A presents an example user interface that can display portions of output documents generated using portions of various input documents or input data sources.

FIG. 16B presents an example user interface element that is part of the example user interface of FIG. 16A.

FIG. 16C presents a process flowchart illustrating process operations for generating regulator-compliant dossiers.

FIG. 16D presents an example document comprehension coarse-to-fine algorithm for automatically generating an optimal regulator-compliant dossier.

FIG. 17A presents a graphical illustration depicting initiation of artificial intelligence (AI) agents with tasks based on goal hierarchy and dependency graph.

FIG. 17B presents the Auto-Dossier process (or dossier generation process) using large language models (LLMs).

FIG. 17C presents an example implementation of the study report semantic mapper (SRSM) algorithm.

FIGS. 17D, 17E and 17F present an example user interface for document organization and presentation in a rapidly examinable format.

FIG. 18 presents a high-level schematic of process operations for systematic literature review (also referred to as Auto-SLR) as implemented by the Auto-SLR subsystem.

FIGS. 19, 20, 21, 22, 23, 24A, 24B, 25, 26, 27, 28, 29A, 29B, 30A and 30B present examples of user interfaces that can be used for Auto-SLR functionality.

FIG. 31 presents an example user interface that allows users to provide inputs during the systematic literature review process.

FIG. 32 presents an example high-level architecture for setting up Auto-SLR functionality to perform systematic literature review.

FIG. 33A presents an example user interface presenting data elements during extraction of data from various input data sources for use in systematic literature review.

FIG. 33B presents an example user interface displaying one selected data source (such as an article or a research paper).

FIG. 34 presents an example user interface for creating a prompt for use in article screening.

FIG. 35 illustrates an example configuration of a computing device that can be used to implement the systems and techniques described herein.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

In various industries, the preparation and submission of regulatory and compliance documents are critical processes for product approval, safety assessments, and compliance with governmental or international standards. These documents, often referred to as dossiers (or regulator-compliant dossiers or regulatory-compliant dossiers), involve the organization and presentation of vast amounts of intricate data from multiple sources, which must adhere to strict, often complex and changing regulatory frameworks. This process is particularly complex in pharmaceuticals and biotechnology, where dossiers such as Investigational New Drug (IND) applications, New Drug Applications (NDA), Clinical Study Reports (CSR), and Marketing Authorization Applications (MAA) are required by regulatory agencies like the U.S. Food and Drug Administration (FDA), the European Medicines Agency (EMA), and other national authorities.

Traditionally, the preparation of such dossiers has been a manual, time-intensive process, involving data collection, formatting, and compliance checks across multiple stages of drug development. This manual process is prone to human error and inefficiency, particularly as the volume and complexity of required data increase. The technology disclosed provides systems and methods for efficient preparation and management of dossiers and other documents with complex structures with minimal chances of human errors.

Various other industries and fields of endeavor, in addition to pharmaceuticals, including healthcare, chemical, food, environmental, finance, and legal sectors, face similar challenges in the creation of structured compliance reports and documents. Technology disclosed addresses these issues by providing an automated system for generating, organizing, and managing regulatory dossiers and similar structured documents across a wide range of industries, starting with pharmaceuticals and extending to other sectors where compliance documentation is critical.

Existing techniques require the preparation and submission of regulatory dossiers to be carried out by experts with deep knowledge and skills in regulatory fields, chemistry, clinical and preclinical research, and operational processes. These experts include analysts and medical writers who work closely with internal teams in biotechnology companies or are employed by large pharmaceutical companies with external consultancy support.

In smaller biotech companies, the process is often managed by external consultants working in conjunction with internal teams. In larger pharmaceutical companies, these tasks are split between internal departments and consultants.

Typically, a dossier preparation process begins with consultants analyzing the company's product roadmap and competitive landscape to draft a regulatory strategy. This involves determining the indication and product form for submission, understanding the evidence needed from preclinical and clinical trials to meet regulatory requirements, and performing a gap analysis. The information regarding regulatory requirements may be posted by regulators on their web sites or shared by the regulators in public or private meetings between the organization (planning to submit the dossier) and the regulator directly. This gap analysis identifies what data the organization has and what additional data is required to meet regulatory and commercial objectives.

This process then results in multiple go-to-market plan options, balancing cost, risk, and timelines, while also taking into account the potential revenue from various label claims. A broader label claim might bring greater commercial returns but demands more robust evidence, increasing the cost and time to regulatory approval.

The technology disclosed simplifies and accelerates the process of planning, compiling, organizing, quality controlling and submitting regulatory documentation by integrating multiple sources of preclinical, clinical, and operational data into a structured dossier format compliant with various global regulatory standards (e.g., FDA, EMA, etc.).

The technology disclosed further incorporates advanced computational mechanisms to identify gaps between available data and regulatory requirements, suggesting and implementing strategies to optimize evidence gathering and submission. It facilitates automated project planning and dossier generation, from initial product development to post-market reporting, reducing reliance on manual work by consultants and medical writers.

The systems and subsystems, disclosed herein, comprise logic for generating regulatory-compliant dossiers, and for conducting systematic literature reviews (SLRs), using various artificial intelligence and machine learning techniques. In one implementation, the technology disclosed uses large language models (LLMs) to perform one or more tasks. The dossier can be, for example, an investigational new drug (IND), a marketing authorization Application (MAA), or a health technology assessment (HTA). The dossier can be constructed based on past documents that are taken as input, according to relevant regulatory guidelines.

The technology disclosed comprises two closely related and synergistic but distinct subsystems: (1) Auto-Dossier subsystem (also referred to as AutoDossier subsystem), for the construction of dossiers from proprietary documents, (2) Auto-SLR subsystem (also referred to as AutoSLR subsystem), for the construction of (systematic) literature reviews (SLRs) given a research question, using AI. In addition, the technology disclosed comprises a data comprehender subsystem that can be used independently or in combination with the Auto-Dossier and Auto-SLR subsystems for scouting data, gathering data, organizing and processing data for use in dossier generation and for performance of systematic literature reviews.

The output depends on the goals of the organization or the manufacturer that is planning to prepare the dossier. The goals are characterized by multiple factors: the geography they go after, the dossier type, the regulatory strategy, resource constraints, experimental evidence available. The goals are formalized into machine-readable format by a processing algorithm.

In one implementation, the technology disclosed comprises an Auto-Dossier subsystem. The Auto-Dossier subsystem is configured with logic to optimally combine user inputs from human workers (or experts) with artificial intelligence (or AI) workers to produce regulatory submissions at speed without sacrificing quality. The AI workers are also referred to as AI agents or simply as agents. The Auto-Dossier subsystem is configured to process the documents in the background. An LLM is used to prioritize the processing of the documents. The Auto-Dossier subsystem is configured with logic to give AI agents access to tools. AI agents are implemented throughout the document creation subsystem and can perform various tasks. The AI agents can be large language models (LLMs). The Auto-Dossier subsystem may be configured with logic to call a data comprehender subsystem to process regulatory submissions at speed without sacrificing quality.

The technology disclosed relates to methods, systems and processes for the planning, creation, organization and management of complex structured documents in particular for regulatory and compliance purposes across a variety of industries. Specifically, it applies to processes that generate comprehensive dossiers, reports and submissions required for regulatory approvals and oversight. The system is adaptable to multiple sectors, including pharmaceuticals, biotechnology, healthcare, and legal compliance, while enabling users to automate data collection, analysis, format standardization, and submission.

The technology disclosed facilitates the automation of regulatory document generation, with immediate application in the pharmaceutical industry, addressing the preparation and submission of investigational new drug (IND) applications, clinical study reports (CSR), new drug applications (NDA), and other dossier components required by regulatory bodies such as the U.S. Food and Drug Administration (FDA) and the European Medicines Agency (EMA). However, the application of technology disclosed is not limited to these industries, and can be applied elsewhere.

The dossier construction process using the Auto-Dossier subsystem can comprise four steps: (1) upload (or input or setup), (2) route, (3) write, (4) iterate-review-output. Throughout the four steps, artificial intelligence techniques (such as LLMs) can be applied to assist in the process and automate the process. Calls are made to large language models (LLMs) and/or other processors through the process. The LLMs can be interacted with through any of chat, voice, video, Virtual Reality (VR) interfaces, and other user interface interactions (such as point, click, select) and through AI agents. The LLMs are called by both backend processes and through the frontend by the user. The backend processes can implement logic for tasks such as data extraction, document classification, document element classification, etc. The backend processes are prioritized based on the requirements in the output and the gaps in the output. It takes more computational cost to perform fine grained analysis. The analysis runs from coarse to fine levels. The backend processes in any of the subsystem can send requests to the user through the frontend and trigger notifications to users through external systems such as email, text, phone call. These requests may ask the user to provide additional input to the Auto-Dossier subsystem, or any of the other subsystems or the whole system described herein. The purpose of such requests may be to aid completion of the tasks, such as fill gaps in task definition or instructions or data made available to the Auto-Dossier subsystem and the other systems disclosed herein.

The technology disclosed comprises AI-based platform (or engine) for highly regulated industries to help take their product to market faster, with less labor, and better results, by helping them achieve the following: (1) understanding the competitive landscape, (2) understanding the regulations, the submission formats and processes, (3) become confidently and specifically aware of the regulatory pathways applicable to them and generate a set of possible go-to-market and strategies available to them which could help them succeed, (4) to understand the relevant trade-offs of those pathways (e.g. risk-return, investment upfront, likelihood to succeed, size of potential win), (5) to understand the status, potential and shortcomings of the material that is currently at their disposal—the technology they have created, the set of evidence they have available, (6) to understand the gap between what they have and what is required by the regulator, (7) to write up the information that they have available, into the templates that are provided by the harmonization bodies and other organizations according to the guidelines recommendations and requirements by the regulators as relevant to the specific domain of the drug or device they are going to the market with (this is often called “writing the dossier”), (8) to allow the users to interrogate both the input data (this may also be called “source data”) they have available, the regulations that are relevant to them, and the application that they have generated, with the purpose to find the weak spots and get them improved by the AI system or by human experts, (9) to enable them to make updates to their applications over time, (10) to predict questions that regulatory authorities may ask about their dossier, (11) to identify mistakes and inconsistencies in a given dossier draft.

Further, to help applicants understand the regulatory landscape and put together their applications, it can also be applied to help regulators and other assessors evaluate submissions. This could lead to data being submitted in richer, easier to analyze formats that could result in both less labor intensive, faster and more thorough application building and evaluation.

### Data Comprehender Subsystem

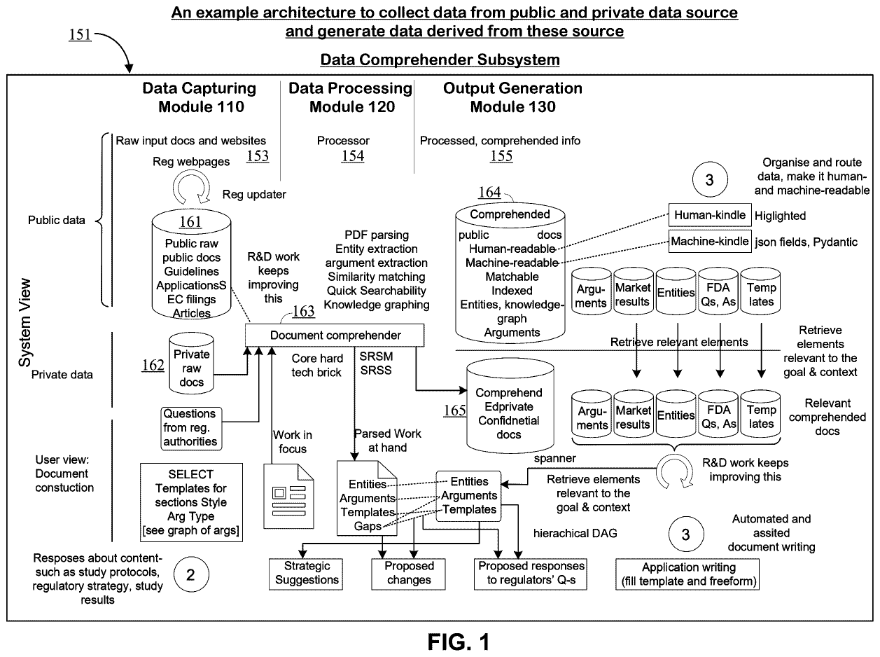

The technology disclosed comprises a subsystem to gather data from various public and private data sources. A high-level architecture of this subsystem (also known as a document comprehender) is shown in FIG. 1. This subsystem is configured with logic to create a library of pre-processed data elements from past documents for an organization. The subsystem is configured with logic to process publicly available documents, that a user can draw upon for improved application processing and customization. The document elements can comprise examples of particular paragraphs, passages, sections, etc. in regulatory applications, protocols, style guides. The document organization step prepares the data for including but not limited to gap analysis and for regulatory question-asking, making the user understand their dataset better.

The technology disclosed is configured with logic to find source documents desired for a dossier or another type of output using AI agents and automatically run queries to download the source documents for further use in Auto-Dossier or Auto-SLR processes. For example, a regulatory authority or agency such as the FDA has departments and sub-departments, and a dossier submission gets routed to one of them depending on the properties (or characteristics or parameters) of the submission (e.g., the molecular structure, the disease area, and so on). The guidelines that are relevant to a given submission are determined by matching the target product profile (TPP) or the pharmaceutical product development plan (PDP) or another relevant document or user input to guidelines. The technology disclosed can achieve this by using AI agents to search and interpret the website of the regulator. An example implementation of such search system is described below and is referred to as an Auto-SLR subsystem. This subsystem can generate queries to find the documents and run the queries and download the documents.

FIG. 1 presents a high-level architecture (151) of the data comprehender subsystem. Three stages of data processing are illustrated in FIG. 1, namely, capturing of data (153), processing of data (154) and output generation that includes processed and comprehended information (155). The data processing operations are performed by a data capturing module 110 that is configured with logic to access public and private data sources. The data capturing module can access online and offline data sources and scout the Internet for searching and accessing required data. The data processing operations are performed by a data processing module 120 that is configured with logic to process data captured from various data sources and extract desired entities, arguments, etc. from the input documents. An output generation module 130 is configured with logic to generate comprehended data that can be used for generation of regulator-compliant dossiers. The three modules (or components) 110, 120 and 130 are illustrated in FIG. 1 with partitions to indicate the data flow and operations performed by respective modules. During the first stage (also referred to as first step), raw data is captured from public data sources (161) and private data sources (162) by the data capturing module 110. The collection of raw input data (153) comprises documents from public data sources, repositories, websites, etc. or other types of data from public data sources. Some examples of data sources include, regulator web pages, clinical sites, pharmaceutical company websites, SEC filings, public health organization databases, etc. The raw collected data is then processed by a processor (also referred to as a data processor) 154 producing comprehended information or data (155) that is stored in various databases or data stores for further use in generation of dossiers, reports, deliverables, etc. The one or more databases disclosed herein are stored on one or more non-transitory computer readable media. As used herein, no distinction is intended between whether a database is disposed “on” or “in” a computer readable medium. Additionally, as used herein, the term “database” does not necessarily imply any unity of structure. For example, two or more separate databases, when considered together, still constitute a “database” as that term is used herein. The raw data can include various guidelines, applications, filings to SEC or other regulatory agencies, research articles, white papers, etc. A document comprehender data processor (163) takes the raw inputs and generates comprehended public data 164 and comprehended private data 165. The public data is further categorized into various categories (or classes) such as arguments, market results, entities, FDA questions and answers (Qs & As), templates, etc. This data can be stored in one database or in separate databases and are also referred to as derived data. Similar data elements can be extracted from private comprehended data (165). The respective data elements from public and private data sources can be stored together. These derived data elements are then made available for various downstream processes such as for dossier generation, etc. During the process of taking inputs from public and private data sources, processing of the raw data and generation of comprehended information, one or more user interfaces allow users to review the progress of the data comprehender subsystem and review in-progress data. The user can provide inputs via the user interfaces to select or de-select various portions of the source raw data for further processing by the data comprehender. The inputs provided by the user can be stored and used in processing of raw input data in the future. Therefore, the efficiency and performance of the data comprehender subsystem continuously improves as it processes more data. The data comprehender is configured with logic to provide suggestions to users in selection of various portions (such as sections, chapters, paragraphs, sentences, tables, charts, graphs, images, figures, etc.) of data from raw data sources. The data comprehender is configured with logic to propose changes to raw data for use in preparation of dossiers. The data comprehender is configured with logic to propose responses to questions asked by various regulators.

The technology disclosed can use various types of artificial intelligence (AI) and machine learning (ML) techniques to implement the data comprehender subsystem, dossier or document generation (also referred to as Auto-Dossier) subsystem and systematic literature review (Auto-SLR) subsystem. The following sections present examples of selected AI and ML techniques that can be used to implement these subsystems.

### Examples of Artificial Intelligence and Machine Learning Techniques

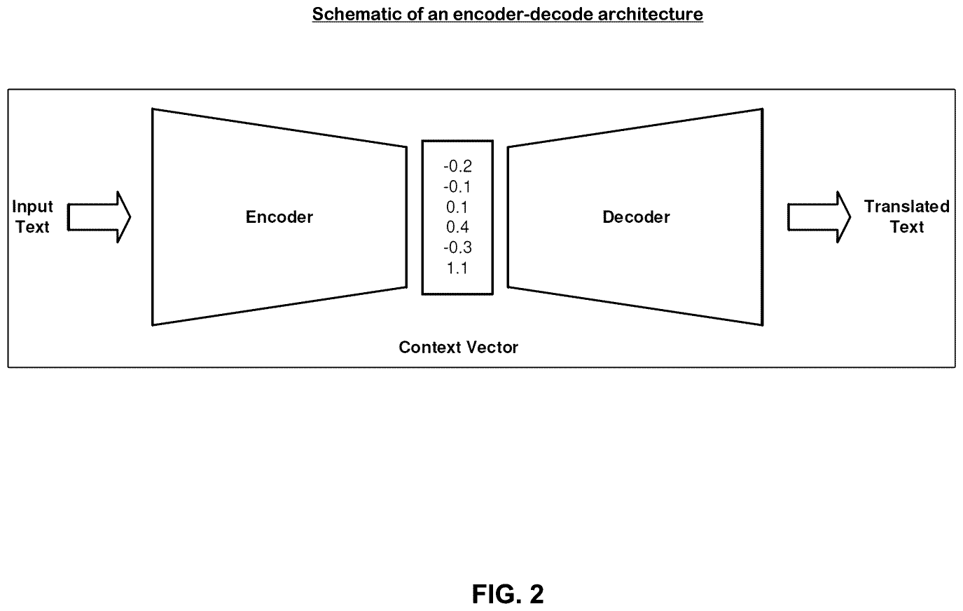

The system described in conjunction with FIG. 1 and FIGS. 12 to 35 comprises one or more subsystems based on Artificial Intelligence (AI). Implementation of these subsystems based on the Artificial Intelligence (AI) subsystems, techniques and models is illustrated by FIGS. 2 to 11.

Some implementations of the technology disclosed relate to using a Transformer model to provide an AI system. In particular, the technology disclosed proposes an AI management system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, one or more of the disclosed AI system (and subsystems) are a multilayer perceptron (MLP). In another implementation, the disclosed AI system and subsystems are a feedforward neural network. In yet another implementation, the disclosed AI system and subsystems are a fully connected neural network. In a further implementation, the disclosed AI system and subsystems are a fully convolution neural network. In a yet further implementation, the disclosed AI system and subsystems are a semantic segmentation neural network. In a yet another further implementation, the disclosed AI system and subsystems are a generative adversarial network (GAN) (e.g., CycleGAN, StyleGAN, pixelRNN, text-2-image, DiscoGAN, IsGAN). In a yet another implementation, the disclosed AI system and subsystems include self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLaMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCIT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the technology disclosed (also referred to as an AI system and AI subsystems) uses a convolution neural network (CNN) with a plurality of convolution layers. In another implementation, the disclosed uses a recurrent neural network (RNN) such as a long short-term memory network (LSTM), bi-directional LSTM (Bi-LSTM), or a gated recurrent unit (GRU). In yet another implementation, the technology disclosed includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 2 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

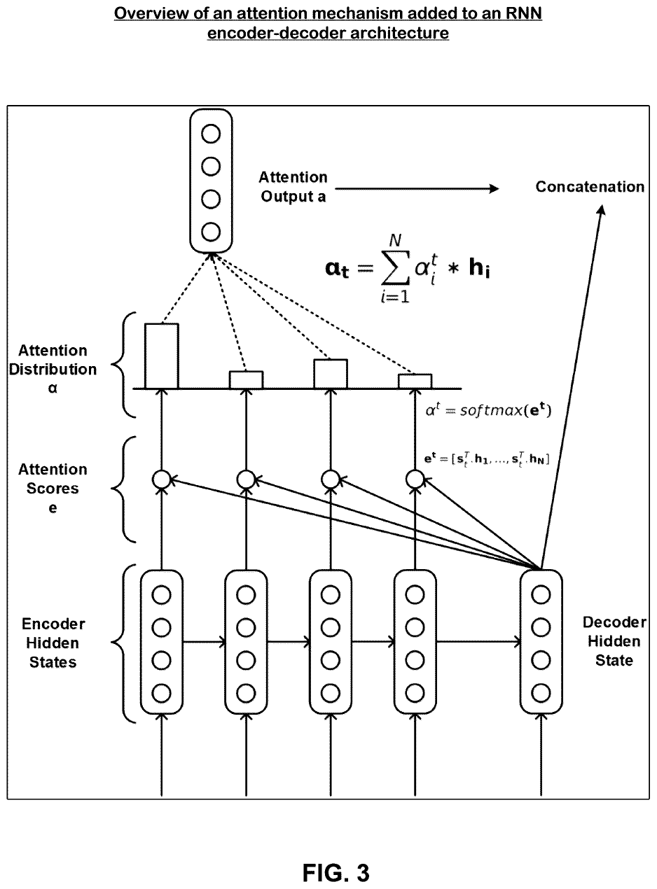

Attention mechanisms distinguish Transformers from other machine learning models. The attention mechanism provides a solution for the vanishing gradient problem. FIG. 3 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

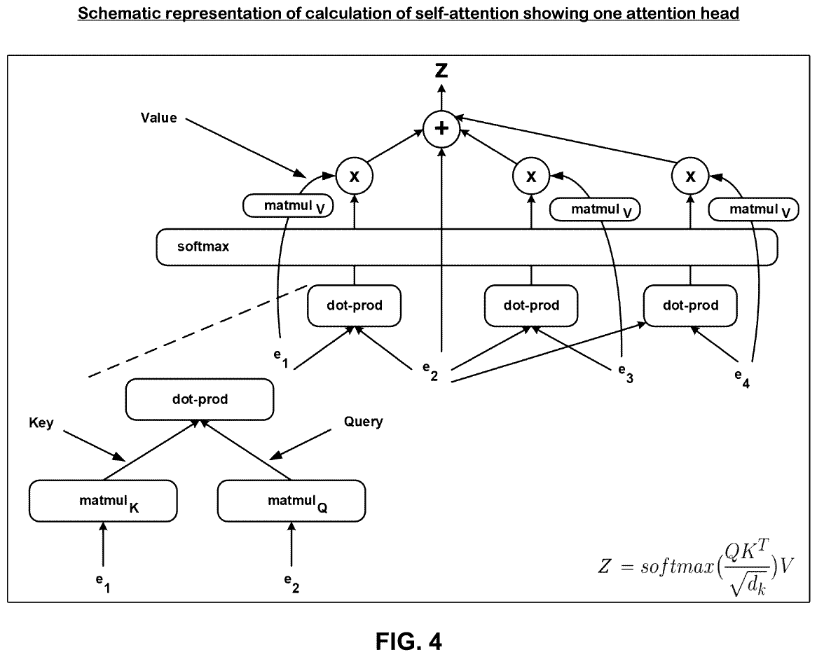

Multi-headed attention is executed in the Transformer. FIG. 4 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

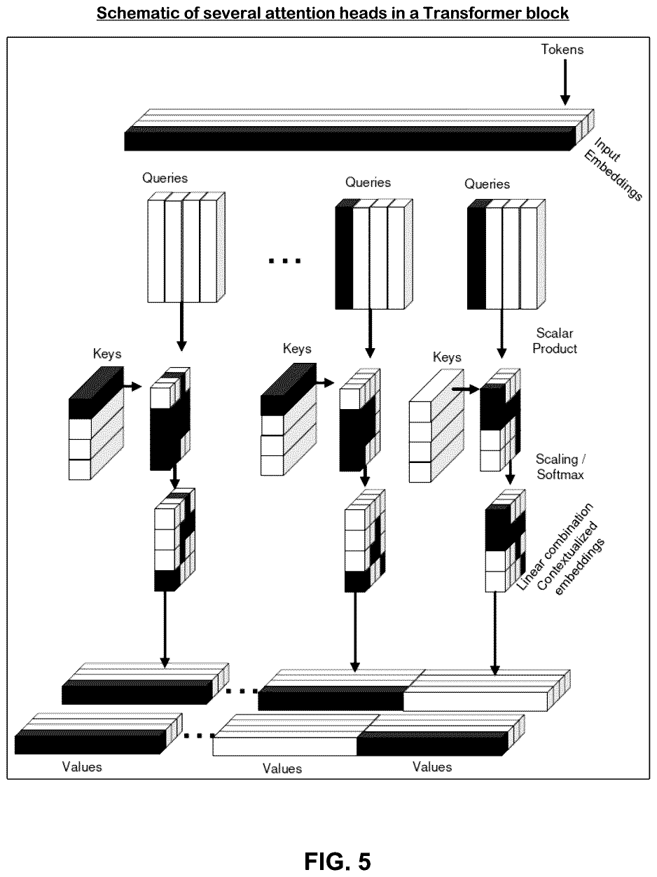

FIG. 5 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and dis the hidden representation of each element (also called the hidden vector). Attention is then computed as:

$$Attention ( Q , K , V ) = SoftMax ( \frac{{QK}^{T}}{\sqrt{dk}} ) V$$

$$where Q , K , V are computed as :$$

$$X \cdot {W}_{Q} , X \cdot {W}_{K} , X \cdot {W}_{V}$$

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where {head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

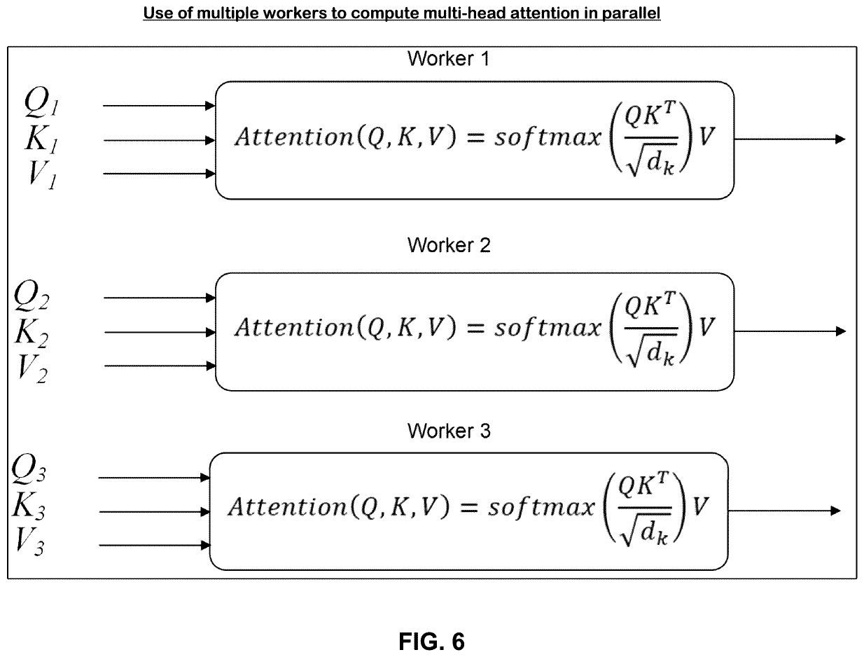

As shown in FIG. 6, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

$$a \cdot b \cdot c$$

For matrices of shape (a, b) and (c, d), to obtain values Q, K, V, we need to compute the operations:

$$X \cdot {W}_{Q} , X \cdot {W}_{K} , X \cdot WV$$

The matrix X is of shape (n, d) where n is the number of patches and dis the hidden vector dimension. The weights W_{Q}, W_{K}, W_{V} are all of shape (d, d). Omitting the constant factor 3, the resulting complexity is:

$$n \cdot {d}^{2}$$

We can proceed to the estimation of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

$${n}^{2} \cdot d$$

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$SoftMax ( \frac{{QK}^{T}}{\sqrt{dk}} ) \cdot V$$

is between matrices of shapes (n, n) and (n, d) and so its complexity is:

$${n}^{2} \cdot d$$

The final asymptotic complexity of scaled dot-product attention is obtained by summing the complexities of computing Q, K, V, and of the following attention function:

$$n \cdot {d}^{2} + {n}^{2} \cdot d .$$

The asymptotic complexity of multi-head attention is the same since the original input matrix X is projected into h matrices of shapes (n, d/h), where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

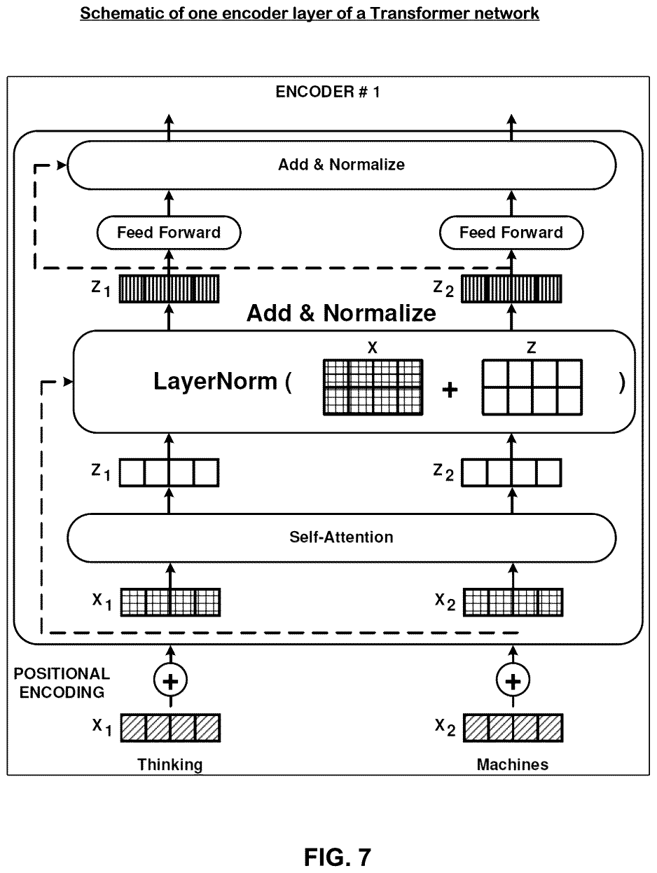

FIG. 7 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

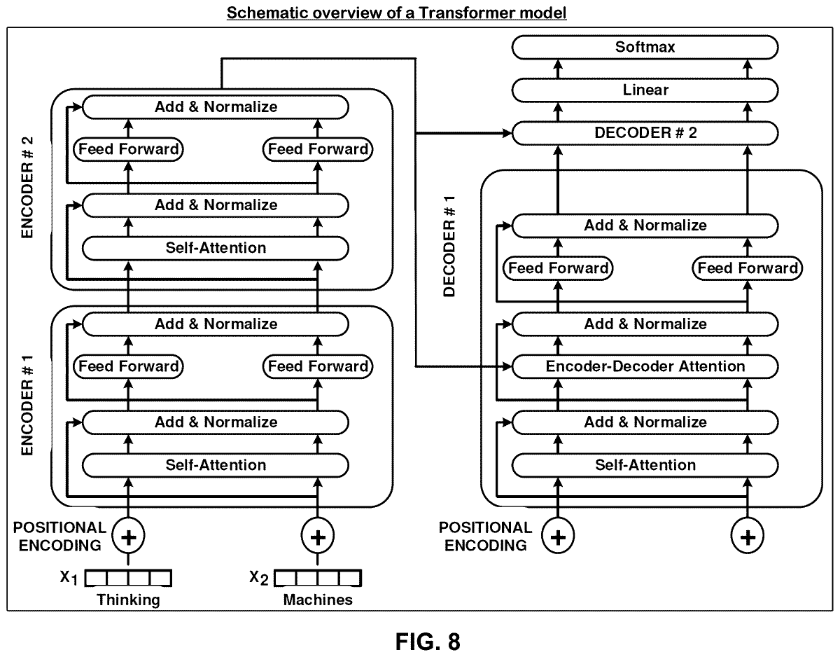

FIG. 8 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

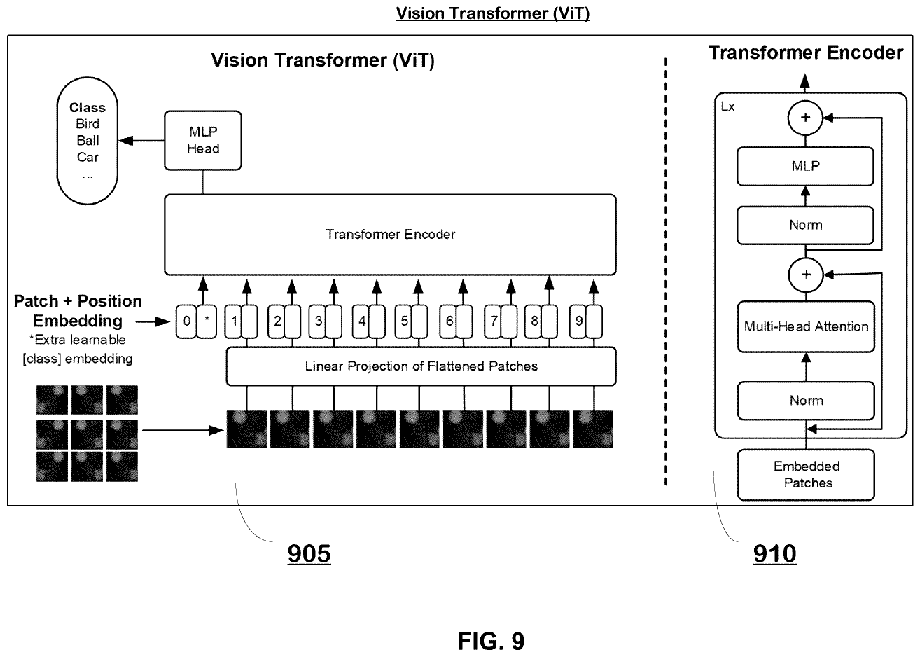

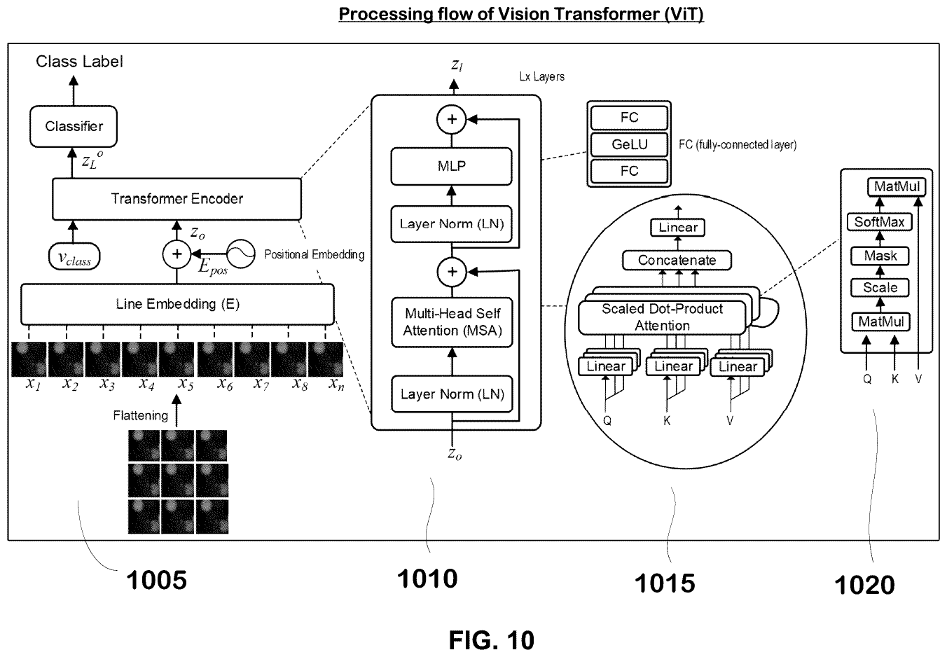

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 9 (905, 910) and FIG. 10 (1005, 1010, 1015, 1020). Unfortunately, important positional information is lost because image sets are position-invariant. This problem is solved by adding a learned positional encoding into the image patches.

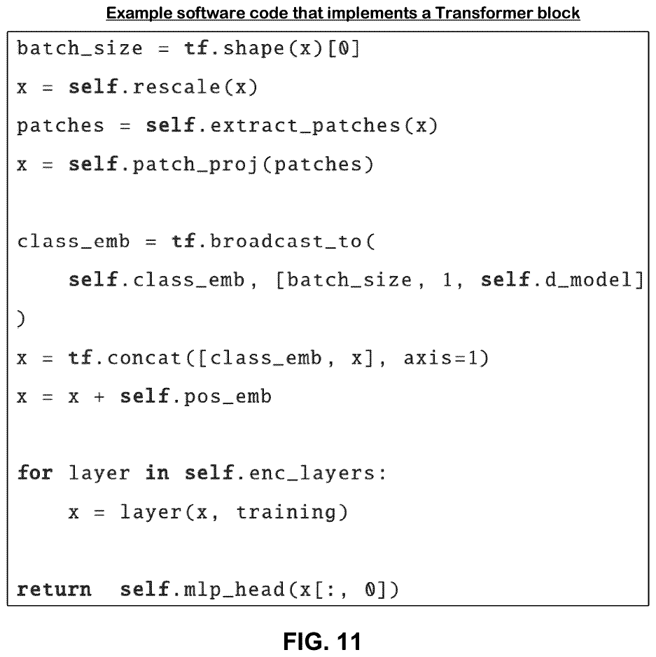

The computations of the ViT architecture can be summarized as follows. The first layer of a ViT extracts a fixed number of patches from an input image (905 in FIG. 9). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 11.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block 910 in FIG. 9, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input. In the following sections, details of the Auto-Dossier subsystem are presented.

### Auto-Dossier Subsystem for Dossier Generation

The following sections present details of dossier generation subsystem 1201 (also referred to as Auto-Dossier or Auto-Dossier subsystem).

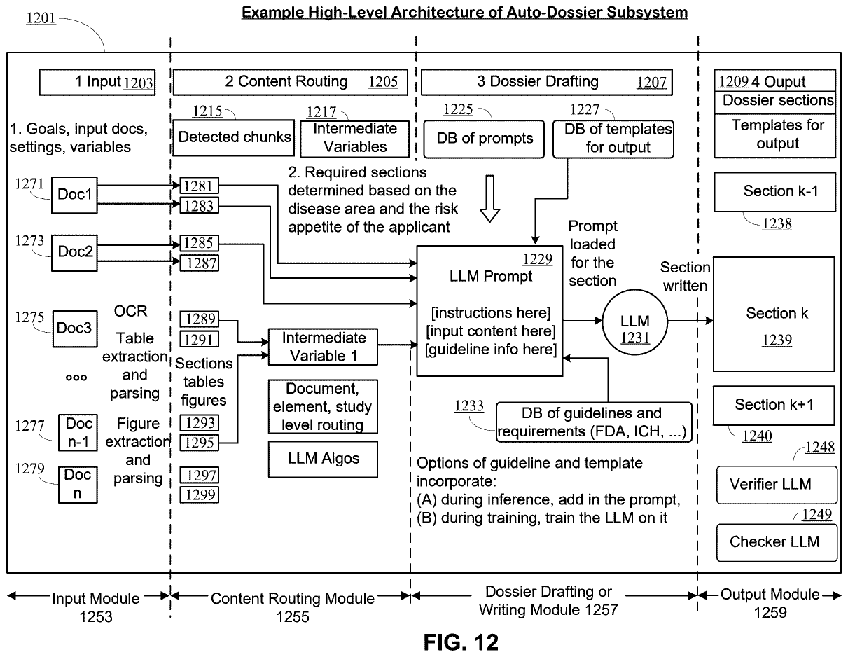

FIG. 12 presents a high-level architecture of the Auto-Dossier subsystem 1201. In one implementation, the Auto-Dossier subsystem comprises four components or modules known as an input processing module 1253, a content routing (or routing) module 1255, a dossier drafting (or dossier writing or writing) module 1257 and an output generation (or an output) module 1259. In one implementation, the functionality of these four modules are presented to the user via four different user interfaces that are designed to receive inputs from users, provide statuses of work-in-progress and to present final work products to users. The input module 1253 is configured with logic to take as input (1203) a set of source documents associated with the target. The source documents can be accessed from public or private data sources. The source documents may be imported from the internal systems of the company such as Enterprise Document Management System (EDMS), Trial Master File (TMF). The source documents can be the documents that are to be used with the corresponding sections in the regulatory compliant dossier. The source documents can be public documents. The source documents can be scouted from the Internet. In one implementation, the Auto-SLR subsystem is configured with logic to scout source documents from the Internet. It is understood that this logic can be implemented as part of the Auto-Dossier subsystem. The output documents can also be directly uploaded to internal systems of the company such as Regulatory Information Management (RIM) system. In one implementation, the Auto-Dossier subsystem can access online data for use in generation of the dossier. In another implementation, the Auto-Dossier subsystem can access offline data for use in generation of the dossier. In another implementation, the Auto-Dossier subsystem can access both online data and offline data for use in generation of the dossier. In some implementations, the input module 1253 can invoke data comprehender subsystem as presented above to access the various data sources and to get data required for the “target”. The target can be an entity, a medical device, a drug, a drug molecule, a chemical, a food, etc. FIG. 12 shows various parameters or arguments that are used by the input module when accessing and processing raw data from public and private data sources. Examples of these parameters include, the goals, input documents, settings, variables, etc. FIG. 12 shows various documents labeled as “doc 1” (1271), “doc 2” (1273), “doc 3” (1275), “doc n−1” (1277), “doc n” (1279), etc. The input module 1253 is configured with Optical Character Recognition (OCR) processing logic, table extraction and parsing logic, figures extraction and parsing logic to extract desired data from public and private data sources. The inputs (1203) are then passed to content routing module 1255 for further processing. In some implementations, the Auto-Dossier subsystem or the system described herein as a whole can have voice, video and other modality inputs and outputs. These voice, video and other modality inputs and outputs can contain requests and responses from the system to the user and they may contain requests and responses from the user to the system.

The content routing module (1255) is configured with logic to process source documents and/or sections of source documents associated with the regulator-compliant dossier and perform content routing operations (1205). The content writing module 1255 is configured with logic to process source documents in the set of source documents in dependence upon dossier requirements in the set of dossier requirements. The source documents or portions of source documents that are processed by the content writing module can comprise text such as paragraphs, sentences, etc. The source documents or portions of source documents that are processed by the content writing module can also comprise tabular data and figures, graphs, charts, etc. The content writing module 1255 is configured with logic to determine one or more source sections in the source documents that are correlated with corresponding dossier sections in the regulatory-compliant dossier (or regulator-compliant dossier). The source sections can include tables of content, figures, tables, and studies, etc. The detected chunks (1215) for various input documents in FIG. 12 are illustrated. For example, a chunk 1281 and a chunk 1283 are detected from “doc 1” (1271). A chunk 1285 and a chunk 1287 are detected from “doc 2” (1273). A chunk 1289 and a chunk 1291 are detected from “doc 3” (1275). A chunk 1293 and a chunk 1295 are detected from “doc n−1” (1277). A chunk 1297 and a chunk 1299 are detected from “doc n” (1279). The content writing module 1255 is configured with logic to determine source sections from source documents and/or detected chunks of source documents based on variables (1217) such as disease area, risk appetite of the applicant, etc. In one implementation, the chunks 1215 are detected based on variables 1217 (also referred to as intermediate variables) and therefore, in this implementation, the source sections are the same as detected chunks. The source documents can include one or more study reports. A study report can be a clinical study report. The study report can also be a non-clinical study report. The source sections of the study report can include one or more tables that summarize toxicology data in model organisms. The source sections of the study report can also include one or more tables that summarize pharmacokinetic data in model organisms. The source sections of the study report can include one or more tables that summarize pharmacology data in model organisms. The source documents can include one or more tables, figures and/or sections that explain or summarize chemistry, manufacturing and control data. The source sections of the study report can include one or more tables that estimate maximal safe dose across model organisms. The source sections of the study report can include one or more tables that estimate minimal therapeutic dose across model organisms adverse effect result tables. The source sections of the study report can include one or more sections that describe toxic effects in particular individual animals. The source sections of the study report can include sections that describe pharmacokinetic effects in particular individual animals. The source sections of the study report can include sections that describe pharmacological effects in particular individual animals. The source sections of the study report can include sections that describe the methodology applied for data analysis. The source sections of the study report can include one or more figures that show the maximal safe dose across model organisms. The source sections of the study report can include one or more figures that show the minimal therapeutic dose across model organisms.

In one implementation, the input module 1253 and the content routing module 1255 are collectively referred to as a first processing engine. The first processing engine is configured to independently process each of the source documents. The first processing engine is configured to detect a table of contents in each of the source documents. The first processing engine is further configured to use the table of contents in each of the source documents to determine the source sections that satisfy the dossier requirements. The dossier requirements specify a dossier writing task such as for a particular regulatory body (e.g., FDA). The dossier writing task can be determined from at least one of the source documents. The source documents can include at least one target product profile (TPP). The dossier writing task can be determined in part or in full from the target product profile. The dossier requirements can specify a plurality of variables. The plurality of variables can include application type, target population, target indication, product dose form, approval geography, regulatory pathway, use endpoint, location of clinical trials, applicant's commercial preferences, approval likelihood, budget constraints, timeline constraints, etc. The dossier type includes clinical trial applications, market authorization applications, reimbursement applications, compliance applications, etc. The clinical trial applications can include first-in-human clinical trial applications and investigational new drug applications. The market authorization applications can include label claim applications, new drug applications, and biologics license application. The dossier type can include reimbursement applications such as health technology applications. The detected chunks 1215 (text, paragraphs, sections, tables, figures, etc.) and the variables 1217 (such as described above) are passed by the first processing engine to a second processing engine. The first processing engine of the Auto-Dossier subsystem is further configured to chunk the source documents into multiple chunks. The Auto-Dossier subsystem is further configured to perform an initial processing based on extraction from part of the source documents, and then perform a later more granular extraction and routing and writing done based on substantial portions of the source documents. The first processing engine is configured to plan the construction of the regulatory-compliant dossier. The regulatory-compliant dossier can include FDA meeting minutes or meeting minutes from other regulatory authorities or agencies. The regulatory-compliant dossier can include clinical study reports. The regulatory-compliant dossier can include global value dossiers (GVDs). The regulatory-compliant dossier includes health technology assessments (HTAs). In one implementation, the second processing engine can comprise the dossier drafting module 1257. Details of the second processing engine are presented below.

The second processing engine (also referred to as the dossier drafting module 1257) is in communication with the first processing engine, and configured to take as input the source documents and section-wise guidelines for generating the corresponding dossier sections. The second processing engine is configured to perform dossier drafting operations 1207. The second processing engine is configured to generate as output the regulatory-compliant dossier containing the corresponding dossier sections. The second processing engine can further be configured to generate the corresponding dossier sections in a Common Technical Document (CTD) data format or a data format of the user's choice. The user can define the data format by uploading example documents in that format to the system. The target can be a drug molecule, an entity, a medical device, a drug, a chemical, a food, etc. The source documents can include Chemistry, Manufacturing, and Controls (CMC) information about the drug molecule. The CMC information can be stored in a Drug Master File. The target can be at least one of medical devices, patent applications, proposals, and legal contract. Input documents can include documents describing intellectual property rights such as granted patents or pending patent application about the molecule. The second processing engine is configured to include molecular structure information of the drug molecule in the regulatory-compliant dossier. The second processing engine is further configured to include manufacturing process flowcharts of the drug molecule in the regulatory-compliant dossier. The second processing engine is configured to include batch records of the drug molecule in the regulatory-compliant dossier. The second processing engine is further configured to include clinical information of the drug molecule in the regulatory-compliant dossier.

In one implementation, the first processing engine is further configured to generate summaries of at least some of the source sections. In such an implementation, the second processing engine is further configured to take as the input the summaries, and to generate as the output the regulatory-compliant dossier containing the corresponding dossier sections. In one implementation, the section-wise guidelines are configured to specify output information to be included in the corresponding dossier sections. The section-wise guidelines are further configured to specify authoring information (or authoring instructions) on how the corresponding dossier sections are to be authored. In such an implementation, the authoring information is configured to specify information sequencing, summarization ways, style, tone, and text length. The section-wise guidelines can be in an unstructured natural language format. The section-wise guidelines can be in a structured prescriptive format. In one implementation, the section-wise guidelines can be sourced from The International Council for Harmonisation of Technical Requirements for Pharmaceuticals for Human Use (ICH). The section-wise guidelines can be sourced from the United States Food and Drug Administration (FDA or US FDA). The section-wise guidelines can be sourced from expertise of consultants with prior experience in dossier drafting. The section-wise guidelines can be sourced from example dossiers. The section-wise guidelines can be sourced from dossier templates. In one implementation, the section-wise guidelines are generated by a large language model (LLM). The LLM is configured to generate the section-wise guidelines as prompts in response to processing the example dossiers and the dossier templates, along with some explanatory directives (e.g., papers on prompt writing).

The second processing engine is further configured to take as the input, example pairs of source sections and corresponding dossier sections from the example dossiers, and the second processing engine is configured to generate as the output the regulatory-compliant dossier containing the corresponding dossier sections. The second processing engine is further configured to take as the input certain contextual information about the regulatory-compliant dossier. The second processing engine is configured to generate as the output, the regulatory-compliant dossier containing the corresponding dossier sections. The certain contextual information can include overall goal of the regulatory-compliant dossier, overall goal of the target, and overall goal of a company seeking the regulatory-compliant dossier. The second processing engine is further configured to generate as the output provenance information mapping which portions of the corresponding dossier sections are generated from which portions of the source sections. The mapping can be at a word resolution, a sentence resolution, a paragraph resolution, a page resolution, a section resolution, or another resolution of some content unit. In some implementations, the mapping can be implemented by inserting using logic distinct tokens with unique identifier to the beginning and end of every source section portion. In one implementation the tokens are implemented using HTML tags such as “span” tag (example: <span id=“p26-s10”>Text 1</span> in document doc-1 where the unique id is “id” and its value is “p26-s10”). The mapping can further be implemented by subsequently configuring the second processing engine to provide in its output the values of the distinct id-s next to every corresponding dossier section (example tokens inserted to dossier sections corresponding to Text 1 in doc 1: <span data-document-id= “doc-1” data-id=“p26-s10″>This text refers to Text 1 in doc 1. </span>). In one implementation, the first processing engine can be a first large language model (LLM). In one implementation, the first processing engine can comprise more than one LLMs. In one implementation, the second processing engine can be a second large language model (LLM). In one implementation, the second processing engine can comprise more than one LLMs.

The second processing engine is shown as dossier drafting module 1257 in FIG. 12. It receives the outputs from content routing module 1255. One or more prompts from a database of prompts (1225) and one or more output templates from a database of templates (1227) are used to generate a prompt (1229) for input to a large learning model (LLM) 1231. In one implementation, the prompt 1229 is provided to the LLM for generating a particular section of the dossier. In one implementation, the prompts for LLMs can be generated by an LLM. In one implementation, the prompts for LLMs can be generated by the user through microphone speech or keyboard text input. The dossier drafting module 1257 has access to a database of guidelines and requirements for dossiers for respective regulators (e.g., FDA, ICH, etc.). The dossier requirements can specify a guideline or a set of guidelines from the regulator. The guidelines or the set of guidelines is applied based on precedents of the department and matches of the plurality of variables. The set of guidelines can be applied based on advice from consultants selected based on their recent experience in similar disease area. One or more guidelines can be selected based on regulator guideline matching to target product profile variables, public precedent matching to regulator guideline variables, private precedent matching to TPP variables, and/or published research around the subject. The LLM prompt 1229 can also include one or more guidelines or portions of guidelines for generating sections of the output (i.e., dossiers). In one implementation, the LLM 1231 is provided at least a portion of the templates and at least a portion of the guidelines during inference as part of the prompt. The LLM 1231 can be trained using at least a portion of the guidelines and at least a portion of the templates. The LLM 1231 can be trained using at least a portion of past dossiers or other relevant documents such as published articles on clinical and preclinical studies. The output (1209) from dossier drafting module (1257) can be a section such as a section labeled as “k” (1239). The LLM 1231 can generate sections of the output (e.g., a dossier) using respective prompt 1229 for each section. For example, an LLM prompt is used to generate section “k−1” of the output prior to generation of the section “k” (1238) of the output. Similarly, a respective LLM prompt 1229 is used to generate a subsequent section “k+1” (1240) of the output. In one implementation an output module (1259) can implement output generation logic, a verification or validate logic and a checking logic. The verification logic can be implemented by a verifier module (1248) and a checking logic can be implemented by a checker module (1249). In one implementation, the Auto-Dossier subsystem comprises more than two processing engines to complete the various tasks related to input gathering and input processing, routing of inputs to various sections of the outputs (i.e., the dossier), drafting or writing of the dossier and generation of output. The technology disclosed can implement these operations using various AI agents that work as a team of AI agents to complete the dossier generation process by receiving inputs from other AI agents and/or other systems and providing outputs to other AI agents and/or other systems. The Auto-Dossier subsystem can comprise a verifier module (1248) or a verifier component that is configured with logic to verify the regulatory-compliant dossier. The verifier module 1248 can be implemented using a large language model and referred to as a “verifier LLM” as shown in FIG. 12. The verifier LLM is configured with logic to verify that the regulatory-compliant dossier generated as output by the Auto-Dossier subsystem 1201 is compliant with regulator's guidelines. The verifier can check the compliance of the dossier using guidelines from the database of guidelines (1233) or by accessing guidelines from other sources. The verifier LLM is also configured to verify that facts in the regulatory-compliant dossier are coherent with each other. The Auto-Dossier subsystem is configured with logic to receive user input and make changes to the regulatory-compliant dossier based on the user input. The Auto-Dossier subsystem can provide one or more user interfaces or user interface elements to receive input and/or feedback from users. The input from users is then processed to determine changes to the dossier. The user input comprises user clicks to portions of the regulatory-compliant dossier. The portions of regulatory-compliant dossiers can be sentences in the dossier, sections of the dossier or other content in the dossier such as tables, graphs, figures, images, etc. The Auto-Dossier subsystem comprises a checker module (1249) or checker component also referred to as a checker-LLM (1249) that is configured with logic to check the work of prior LLMs. Checker LLM can check and verify that the LLMs implemented as part of the Auto-Dossier subsystem are working as per their desired requirements. The checker-LLM (1249) is also configured with logic to check human works. The Auto-Dossier subsystem is configured with publishing logic. The publishing logic pushes (or transmits or sends) the regulatory-compliant dossier to one or more regulators. The Auto-Dossier subsystem is configured with logic to integrate the regulatory-compliant dossier with EDMS systems, TMF systems, CRO systems, and/or consultants. The Auto-Dossier subsystem is configured with logic to deploy the regulatory-compliant dossier at least partially on cloud including public data, and partially on local compute including user data and/or proprietary data. The Auto-Dossier subsystem is configured with logic to anonymize at least some the proprietary data by masking out that proprietary data. The regulatory-compliant dossier can be sent to regulators in FHIR standard. The source documents can be checked for self-consistency and for whether they meet regulator acceptance criteria based on regulator guidelines, meeting minutes, public precedence parts, and/or proprietary precedents. The Auto-Dossier subsystem and the Auto-SLR subsystems are configured to inform later studies. The Auto-Dossier subsystem and the Auto-SLR subsystems can have multiple logins and multiple users working concurrently.

In one implementation, the Auto-Dossier subsystem is configured with logic to receive feedback on the regulatory-compliant dossier and automatically update parameters of the one or more processing engines (i.e., the first processing engine and the second processing engine) to improve future dossier generation based on the feedback. Examples of the parameters can include: (1) model weights and biases in machine learning models, (2) prompt templates and prompt engineering instructions used to query large language models, (3) temperature settings and other sampling parameters that control output generation, (4) confidence thresholds for accepting or rejecting generated content, (5) rules and heuristics for section mapping and content selection, (6) document parsing configurations, (7) output formatting specifications, (8) validation criteria and verification rules, (9) domain-specific vocabularies and terminology databases, (10) reference examples and few-shot samples, (11) attention weights or emphasis factors for different types of source content, (12) chunking strategies and context window configurations, (13) routing logic that determines which processing pathways to use for different document types. For example, in such an implementation, when the Auto-Dossier subsystem receives feedback indicating that a regulatory authority rejected a dossier section for insufficient detail, the parameters updated might include, increase the length parameters for that section type, adjust the prompt template to request more comprehensive analysis, modify the confidence threshold to include more source material, or update the few-shot examples to include successful submissions with greater detail. Positive feedback on concise summaries might result in adjusting summarization parameters to favor brevity, updating prompt templates to emphasize key findings, or modifying the attention weights to focus on conclusion sections of source documents. The updating of parameters may be accomplished through various mechanisms including, supervised fine-tuning using feedback-labeled examples, reinforcement learning from regulatory outcomes, prompt optimization through iterative refinement, A/B testing of parameter configurations, automated hyperparameter tuning, knowledge distillation from successful submissions, or manual adjustment by domain experts based on aggregated feedback patterns. The updates to parameters can be applied at varying scopes. For example, (1) global updates that affect all users and all document types, (2) domain-specific updates that apply only to certain therapeutic areas or document types, (3) customer-specific updates that customize behavior for individual organizations while maintaining data isolation, (4) session-specific updates that temporarily adjust parameters for a particular dossier generation task. The feedback-driven parameter updates may be subject to governance policies, requiring approval before deployment, validation on test cases, or gradual rollout to monitor impact.

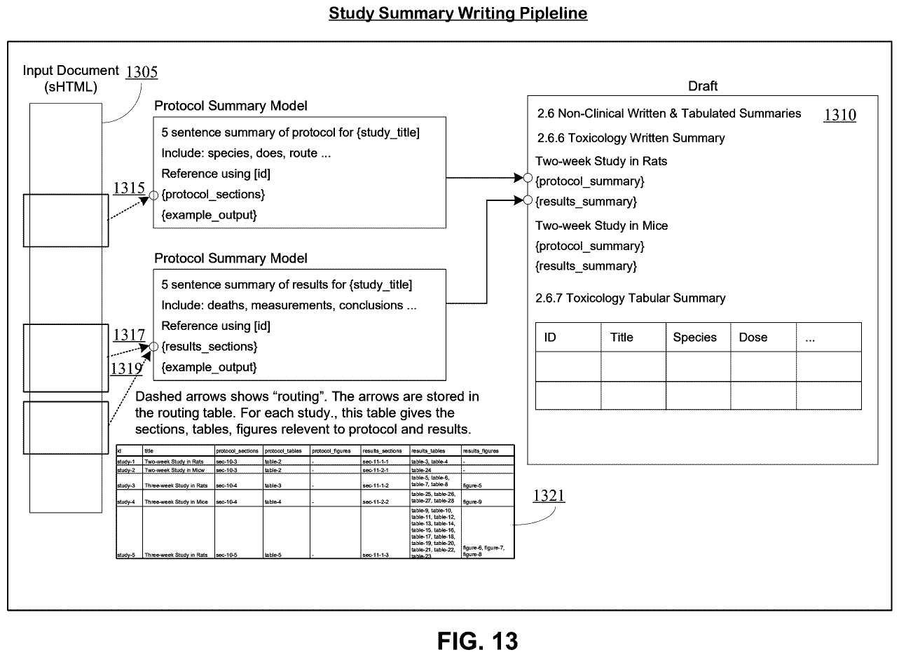

FIG. 13 presents an illustration of mapping logic that maps portions of input data to sections of output documents such as dossiers. Portions of an input document 1305 are shown as mapped to an output (e.g., a dossier) 1310. Arrows in FIG. 13 show flow of data from source (input document) to output draft. Arrows (1315, 1317, 1319) drawn with broken lines indicate routing of data from source documents to outputs (e.g., dossiers or other types of documents, etc.). These arrows are stored in a table, also referred to as a “routing table” (1321). For each type of source document (using a study identifier and/or study title), the routing table 1321 identifies sections or portions of the source document that are relevant to the protocol and output results. For example, the table 1321 identifies “protocol sections”, “protocol tables”, “protocol figures”, “results sections”, “results tables”, and “results figures” for each study that are relevant for the output document. It is understood that other types of fields, sections, portions, tables, etc. can be identified for use in mapping of the source documents to output drafts.

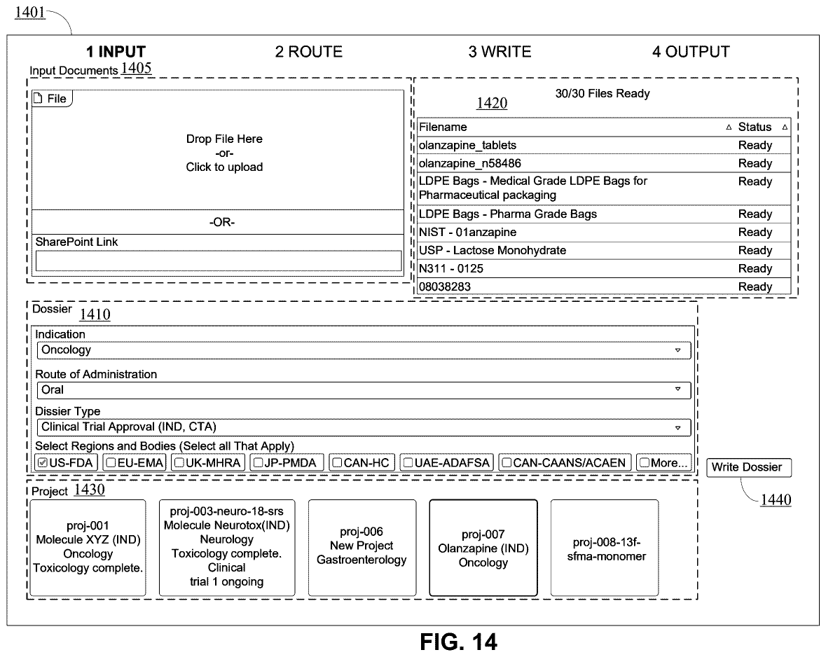

The technology disclosed provides a plurality of user interfaces to allow selection of inputs and processing of the inputs to generate outputs (e.g., dossiers). The user interfaces allow users to provide inputs at various stages of the process and review the progress of the process at various stages of the process. In one implementation, the technology disclosed provides four user interfaces, an input user interface, a route user interface, a write user interface and an output user interface, for allowing users to interact with the Auto-Dossier subsystem during generation of dossiers from source documents. FIGS. 14, 15A, 15B, 16A and 16B present examples of some of these user interfaces. It is understood that less than four or more than four user interfaces can be provided by the technology disclosed to implement the Auto-Dossier functionality to efficiently generate dossiers from a plurality of input source documents.

FIG. 14 presents an example user interface comprising various user interface elements that allow users to select input data for use for preparation of output documents such as dossiers. In the example user interface (1401) shown in FIG. 14, the input screen (or input user interface) comprises at least four sections labeled as input documents (1405), dossier (1410), files ready (1420), and project (1430). Finally, a write dossier user interface element (such as a button) 1440 can be selected by the user to initiate drafting of the dossier document (i.e., the output). The input documents (1405) section can be used to take as input, from a user, one or more source files that can be used for creation of the dossier. The input documents (1405) user interface element comprises various options allowing a user to either select a file from a local or a remote directory, drag and drop a file or provide a link (such as a uniform resource locator or a URL) to a location where the source file is stored. The input documents user interface element 1405 allows user to access documents from secure document repositories such as SharePoint, etc. The technology disclosed allows secure connections to remote locations and repositories for access to source files. The dossier (1410) section user interface element provides information about the dossier such as an indication, route of administration, dossier type, geographies (regions) and regulatory body names, etc. A user can enter the data in these input fields and select appropriate options. This data can be automatically uploaded from one or more uploaded documents such as target product profile, etc. The project (1430) section user interface provides user interface elements that can be selected by a user to open and interact with various projects. Each project can represent creation of one or more dossiers (or other types of outputs and documents). New projects can be created and existing projects can be selected for edits, etc. New projects can be uploaded as well. The section 1420 of the user interface 1401 presents list of files (or source documents) that have been uploaded using the input document user interface. A name of the file (filename) and a status (such as ready) can be displayed in a user interface element presenting the files. A count of the files can also be displayed indicating the number of files (or source documents) that have been uploaded. The count can display a number of files with a particular status such as the number of files (or source documents) that are in ready status and the number of files that are not in ready status or that may require further attention from the user. Such files can have parts that have not yet been processed by the system. Such files can have missing data or missing sections that are required by the technology disclosed for generation of the output. The verification module and the checking module of the system can determine whether such files have such missing data or missing sections or whether they require further attention from the user. The verification module or checking module can be run on all input documents one by one to make such determination. A status bar (or progress bar) can be presented for each file indicating the processing status of the documents. The progress bar can be color coded indicating various statuses using different colors such as a red color for incomplete file, an orange color for in progress file, a green color for ready file, etc. Percentages and other numbers can be used along the progress bars to indicate the approximate completed and in progress status of a file. The user can select the user interface elements labeled as “write dossier” (1440) to initiate the output drafting process.

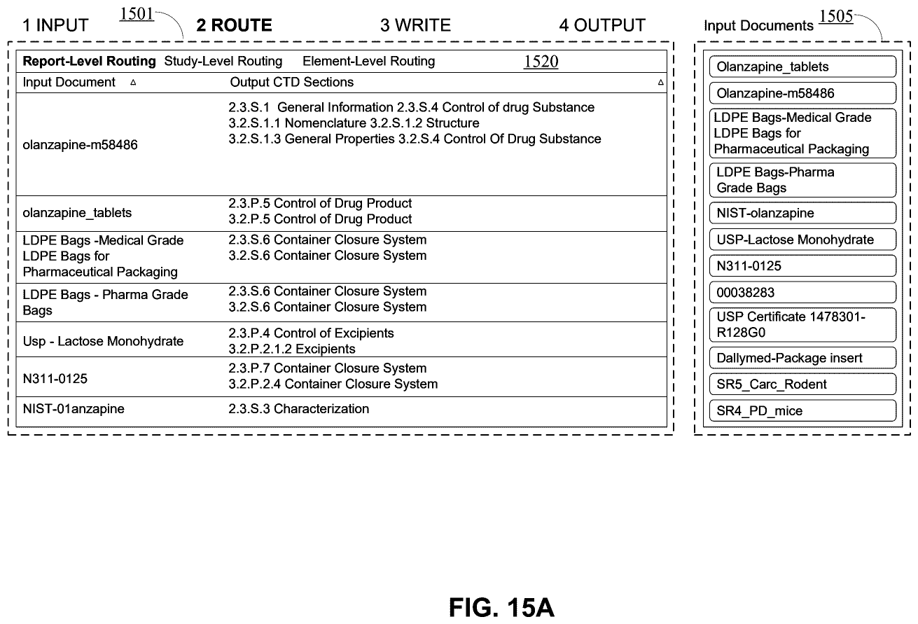

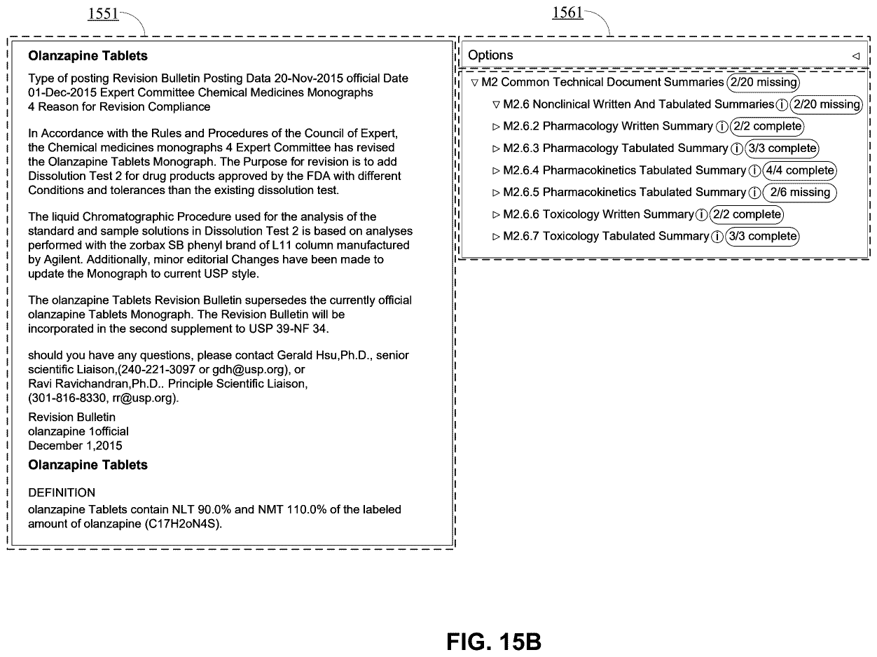

FIG. 15A presents an example user interface for processing (or routing) selected input data to generate output documents such as dossiers. A routing table in the user interface 1501 shows for each input document, the corresponding section of the output document for which it is to be used. Routing is performed at different levels of details or different levels of granularity. For example, element-level routing, study-level routing and report-level routing (1520). The element-level routing comprises the highest level of granularity while report-level routing indicates lowest level of granularity. A user interface element 1505 illustrates input documents and is also referred to as an input document pane. The input document user interface element (also referred to as input documents pane) 1505 presents the documents that the user has provided (or uploaded). Selecting a document label (such as the document name or identifier) in the input documents pane 1505 causes the selected document to open in another user interface 1551 (presented in FIG. 15B). An options panel user interface element 1561 presents a drop down menu allowing users to review statues of various documents. For each document, a number of sections that are incomplete, missing and complete are displayed.

FIG. 15B presents examples of additional user interface elements that are part of the example user interface of FIG. 15A. The user interface elements 1501, 1505, 1551 and 1561 (in FIGS. 15A and 15B) can be presented on a same screen in a user interface for routing operation. The user interface or screen for routing is also referred to as routing area and it shows which input documents are used for the writing of which sections of the output document. In the example shown in FIGS. 15A and 15B, report-level routing pane is displayed for illustration purposes. Other tabs (in user interface element 1520) can be selected to display study-level routing and element-level routing.

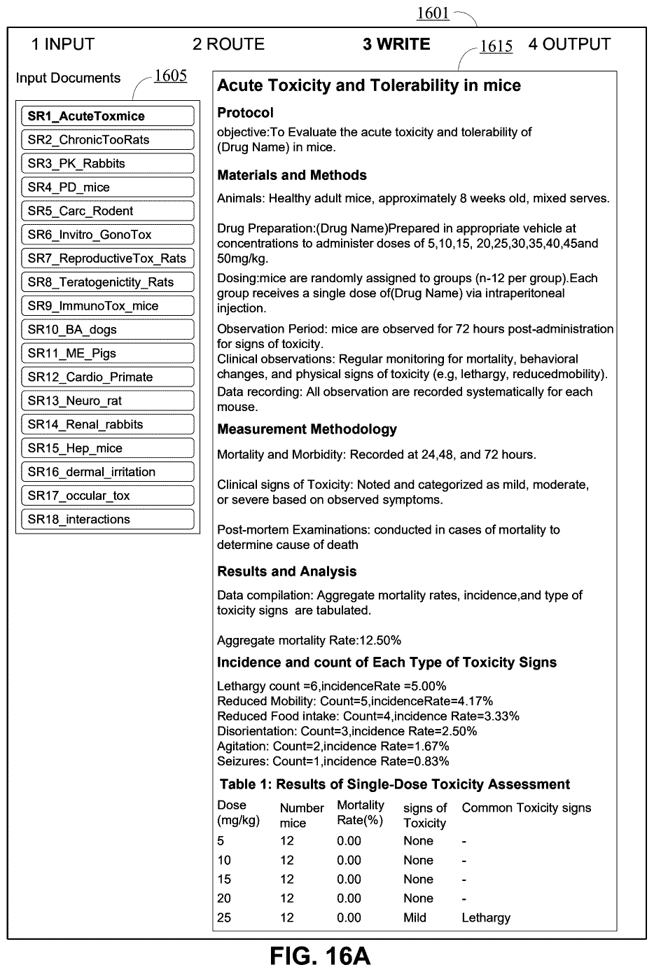

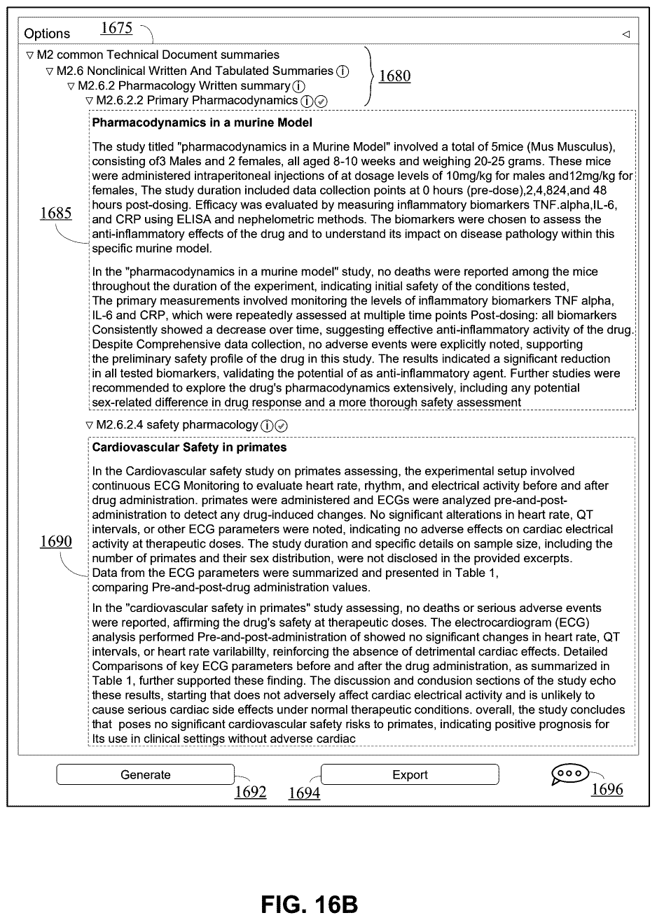

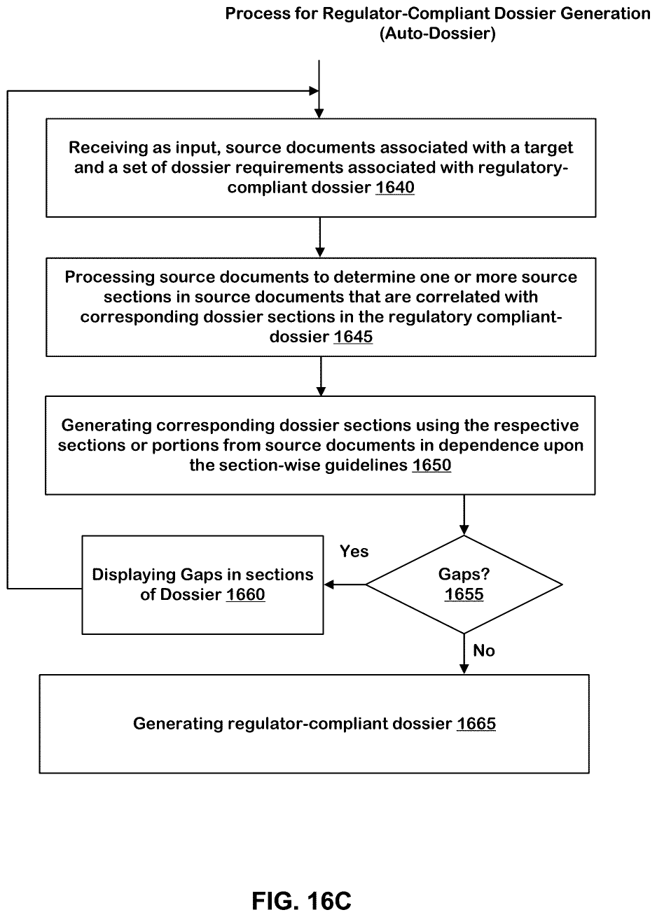

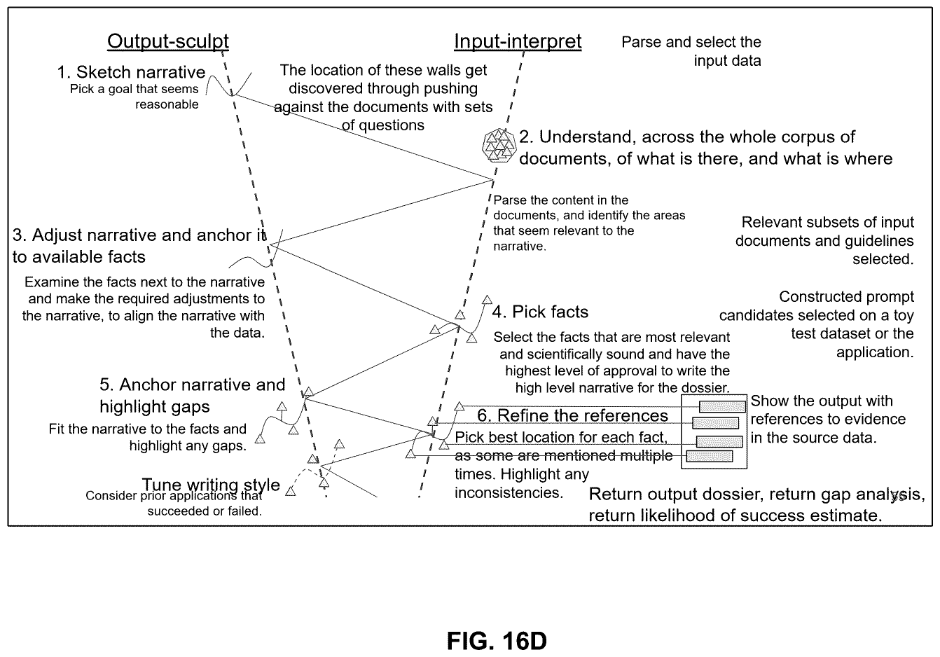

FIGS. 16A and 16B present example user interface elements for writing operation screen. FIG. 16A presents an example user interface (1601) that can display portions of output documents generated using portions of various input documents or input data sources. An input documents user interface 1605 comprises user interface elements for documents that are provided as inputs or source documents. A user can select an input document by selecting corresponding input document from input documents user interface element 1605 to view the details of the document in a user interface element 1615. The input documents user interface elements 1605 can be tabs or buttons or other types of user interface elements. Currently selected user interface element appears highlighted or in a different color to indicate that document that is currently open in user interface element 1615. The example in FIG. 16A shows a document “SR1_AcuteToxMice” as opened for review by a user. The document may contain text, tables, figures describing preclinical studies, clinical studies, molecules, or other information relevant to the dossier. The list of documents in user interface element 1605 includes the documents that were uploaded using the input screen in FIG. 14.

FIG. 16B presents example user interface elements that are part of the write screen user interface of FIG. 16A. A user interface 1675 as shown in FIG. 16B comprises subsections labeled as 1680, 1685 and 1690. The user interface element 1680 presents table of contents for the dossier in an expandable form. By selecting the user interface element 1680, a user can collapse (or expand) the table of contents for the dossier. The user interface element 1685 provides AI-written dossier section for one (preclinical) pharmacodynamics study. The description is generated by the LLM 1231 as shown in FIG. 12. The user interface element 1690 presents AI-written description for another (preclinical) study. A user interface element 1696 can be selected by a user to open a dialog box (or a window) user interface element and interact with the LLM (or another type or artificial intelligence or machine learning model). During the interaction, the user can ask questions, provide instructions or requests to the LLM to make changes in the summary or provide more details about a particular section. The user can target a particular section either by selecting that section using their mouse cursor or by referring to the section through voice or chat interface. The user can also ask to provide the description of one or more sections in a different language, etc. A user can select a user interface element 1692 to trigger automated generation (or writing) of sections of a dossier. A user can select a user interface element 1694 to trigger export of the dossier draft in a desired format such as in a MS Word document format, a portable document format (PDF), FDA SEND format, etc.

### Auto-Dossier—Dossier Generation Process Using Large Language Models (LLM)

In the following paragraphs, further details of the dossier generation process are presented with respect to use of machine learning models such as large language models (LLMs) in dossier generation process. This process is also referred to as Auto-Dossier or automatic dossier generation process. The process is presented with respect to the four process steps namely, input, routing, writing and outputs (or review and quality control). The input, routing and writing (or drafting) process steps map to the user interfaces shown in FIGS. 14, 15A, 15B, 16A and 16B, respectively.

The technology disclosed can provide four user interfaces (also referred to as screens or pages), namely, (1) input (also referred to as setup), (2) routing, (3) drafting, (4) review and quality control. The first user interface (e.g., as shown in FIG. 14), the source documents are uploaded, and the project goals selected by the user or detected from one of the source documents. The system is configured with logic to go through the documents uploaded via the input user interface (also referred to as user interface one), and parses them as illustrated in FIGS. 15A and 15B.

On the input page (e.g., as shown in FIG. 14), the user can upload their source documents and project goals into the system. The documents are uploaded and show up in Auto-Dossier subsystem on the input page. The project goals can be supplied either through document upload or through user interface elements such as drop-downs. The system can also ask the user for extra data. Some basic info about the contents and processing status is shown to the user in the interface as soon as it becomes available: number of pages, words, and contents of the documents, based on initial processing. Also on the input page, the user selects the dossier type that they are attempting to generate. This information on the dossier type can be used by the artificial intelligence model (such as the LLM) to organize the input data and route reports, report sections, tables, figures, etc. to the appropriate sections in dossier output. This will determine what is subsequently shown on the right hand side (RHS) in the routing page (such as shown in FIG. 16B). It is understood that various arrangements of the user interface design can be used to present the output comprising sections of the dossier. Additional user interface elements including pop-up windows or other forms of user interface elements can be used to present output to users and receive feedback from users, if any.

On the routing page (such as shown in FIG. 15A), the source documents are routed (mapped) to the dossier structure at multiple levels of precision. First, on report level, in seconds to minutes. Second, on report-element level (or element-level), in minutes to hours, depending on the length of the reports. Finally, study-level mapping is performed, in minutes to hours, depending on the complexity of the studies. For complex and nuanced studies, human expertise may be integrated, in a “human-in-the-loop” process here. With increased computational power, processing times can be reduced.

In one implementation, dossier generation (or dossier construction) process can include the following steps:

### Setup (Input User Interface 1401)

1. Upload Documents
   Preclinical study reports (tox, . . . )
   Drug Master File
   Clinical study reports
   TPP 2. Select application type
   IND/CTA
   MAA/NDA/BLA
   HTA
3. Select or confirm other variables, such as:
3.1. Select indication:
   Oncology
   Neurology
3.2 Select route of administration:
   Parse, route and gap-analyse the input documents
Infer the submission requirements, given the variables (application type, molecule, route of administration, geographical areas being aimed at)
4. Select source of the requirements (what provides the requirements given the variables):
   ICH and FDA guidelines and standards
5. Select source of status quo in that therapeutic field (e.g., chronic disease takes more testing, whereas oncology has easier access):
   Past applications for drugs in that therapeutic field

The Auto-Dossier process includes parsing the above input data for relevant information. The parsing is performed for each input (source document). Each source document is passed to the routing process step. The process includes finding the table of content (or TOC) for each input document. The process includes finding other types of content in each source (or input) document such as the tables, figures, sections, paragraphs, etc. If a table of content (or TOC) cannot be found for a given document, then a machine-readable table of content (or TOC) may be constructed for the document. The process (or method) includes making an estimate of where each input or source document is used. In one implementation, the technology disclosed is configured with logic to present one or more questions regarding content in input documents. Based on responses to these questions, the Auto-Dossier subsystem can determine the contents of the input documents and also determine which sections of the dossier (or output) a particular input document is mapped to and specify how it will be used there. Examples of such questions include: (1) what is the starting dose in mg? (2) what is the test animal species?, etc.

The input document parsing is dependent on the requirements. The process includes iteratively improving the estimate (or guess) where a particular source or input document is to be used in the dossier and how it can be used there (for example: as source material to describe a study or as source material to describe a chemical manufacturing batch). The process includes extracting information about the studies performed from the document. The process includes extracting information about the molecules tested from the document. The process includes extracting information about the various other information from the document.

The method includes performing a fine-grained gap-analysis to identify the parts in the dossier for which no source document provides appropriate (necessary and sufficient) data. The process includes cross-checking the input documents and mapping out what has been tested from the input documents such as the toxic, pharmacodynamic and pharmacokinetic profiles. The method includes identifying protocols and results across all the input documents and determining whether the toxic effects are identical or similar or different across the input documents. The method includes identifying the gaps across the various input documents. Example of some of the areas of portions of the input documents that are parsed and routed include, the formulation, the drug product, the toxicity, the pharmacology and/or the toxic effects by organ, the toxic effects by species, pharmacokinetics. The gap analysis includes comparing each of the requirements against each of the sections of the output dossier.

Once the routing process operations or steps are complete, dossier drafting process operations or steps are performed. The drafting (or writing) process operation (or step) comprises writing sections of the dossier such as the quality sections (M3.2 and M2.3), the formulation sections including chemistry, active ingredient, excipients, etc. The drafting process includes writing the drug product sections, route of administration. The drafting process includes writing the nonclinical sections (M2.6 and M2.4), the tabulated summaries (2.6), the written summaries (2.6), the narrative part (2.4), the clinical sections (M2.7 and M2.5), the tabulated summaries (2.7), the written summaries, the narrative part (2.5), the quality sections (M3.2, M2.3), the administrative section (M1), the clinical study protocols (M5), the clinical study reports (M5), etc.

Finally, in the review, quality assurance, and export process step (also referred to as the output process step), the dossier review is performed. The dossier is reviewed and quality controlled for formatting and content. Specific experts may be assigned to perform the review for specific sections (for example, chemistry experts for CMC section). For formatting, it is checked against the formatting requirements. For content, the content of each section is checked against the requirements that were previously identified as relevant for the given drug program. For content, the content of each section is checked for consistency and provenance against input sections and against dossier sections that it depends on. The Auto-Dossier subsystem can comprise processing modules or components that can verify the correctness of outputs generated by the Auto-Dossier subsystem. An example of such processing module or component is verifier LLM (1248) presented in FIG. 12.

Human experts can also review the outputs and provide comments or feedback via various user interface elements. Human experts can also write parts of the outputs. AI can ask human experts to provide further detail or help the AI with some tasks such as writing a section or routing a report. Authorized human experts can override any of the actions performed by AI. A checker LLM module or component (1249) can check operations of all other LLMs and work performed by human experts.

The technology disclosed includes logic to figure out submission requirements for the dossier from a variety of sources. For example, these requirements can be provided by regulators, or by a standards body (like ICH). The submission requirements can be inferred from past submissions (e.g., which submissions succeeded and which submissions did not succeed or which portions of the submissions were successful and which portions of the submission were not successful). The submission requirements are dependent on submission type. Examples of submission types include, regulatory submission, funding application submission, IT assessment submission, etc. The requirements (or SOP-s) for dossiers are dependent on the disease area, for example, oncology, neurology, cardiology, etc. The submission requirements can be determined by searching the set of all regulatory guidelines for the particular keywords determined about the entity submitted, then taking the subset of relevant guidelines and extracting from those that apply to the program at hand. The interpretation of the guidelines can be sharpened by looking at recent FDA reviews on similar precedent dossiers.

The dossier drafting process provided by the technology disclosed comprises iteratively improving the dossier or output drafts by reviewing the dossier or output drafts and using the feedback by AI agents or humans to revise the output draft. The technology disclosed also uses past examples of dossiers and other related documents and compares those with the current work product. These examples can be accessed from public databases and private databases. In some cases, proprietary examples (full or partial) are used by the technology disclosed to improve the current dossier. Using the above feedback mechanisms, the technology disclosed generates dossiers that have a good chance of getting approved by the corresponding regulatory body.

In the following sections, further details of mapping of the source documents or portions of source documents to sections or parts of the dossier (or outputs) are presented. In one implementation, the technology disclosed uses a study report semantic mapper or SRSM (also referred to as sematic study report mapper or SSRM) algorithm to map source documents to sections of outputs (such as dossiers).

The Semantic Study Report Mapper (SSRM) Algorithm The high-level process steps for semantic study report mapper (SSRM) or study report semantic mapper (SRSM) algorithm are presented below:
Step 1: Understand what needs to be generated as output, given the goals. The understanding is derived from regulatory bodies and agencies such as the International Council of Harmonisation (ICH) and from relevant regulations such as regulations from U.S. Food and Drug Administration (FDA) and from templates. The knowledge is obtained from either documents obtained from meetings between the applicant and the regulator, or from public documents published by the regulator. Self-referentially, self-comparatively parse each input report.
Step 2: Understand what data, content, information is present in this input report. Understand which output sections this data, content can go into.
Step 3: Understand which portions or parts in the input are the right ones from which to take the material for the output.

In the following sections, details of the Auto-Dossier process are presented with reference to SRSM algorithm.

Auto-Dossier Process with SSRM Algorithm

As described above, the Auto-Dossier process comprises four process steps comprising input, routing, writing and output. The core data sources used in Auto-Dossier are (1) the input documents provided by the user, (2) the goals and context provided by the user (either within the input documents, previously uploaded documents, or as separate input provided through the interface), (3) templates and formatting instructions for the output documents-included as defaults in the system for a number of different legislations and standards like the ICH, (4) laws and regulations for different regions such as the FDA; CFR; EMA; PDMA; MHRA, (5) guidelines specific to different disease areas (cardiology, neurology, and so on), (6) public research documents from PubMed, online sources such as available at <<clinicaltrials.gov>> and other sources, (7) (parts of) past submissions made by others that may be accessibly publicly. These documents together provide both the content that needs to end up in the output dossier, and the instructions for how the output dossier should be built from them and formatted, and the required set of content that should be included in the output dossier. The Auto-Dossier application further provides the user with regulatory feedback and answers to questions around their commercial and clinical strategy and tactics (e.g., which regulatory pathway, which market or indication to prioritize) by using frontier AI models in a safe, effective and secure manner.

The Auto-Dossier process as implemented by the Auto-Dossier subsystem reduces the time from application initiation to dossier submission, reduces the labor required to complete the application, and produces a stronger or better quality submission. The quality of the submission is increased due to machine assistance in detection of inconsistencies in the application, and the use of frontier models to churn through larger volumes of data and make connections that a human may not notice. Further details of this implementation are presented below.

LLM-based Auto-Dossier Implementation: In one implementation, the Auto-Dossier process operations or steps are performed using large language models (LLMs), which can be adjusted with prompts specialized to these tasks.

A user (who may work at a regulatory consultancy) can adapt the system based on their past applications in a way that preserves confidentiality and separation for projects that they have performed for particular customers (who may be biotechnology companies or pharmaceutical companies), and share other aspects between projects (for example if two projects are for the same pharmaceutical company).

The following paragraphs describe details of the four process steps of dossier generation using LLMs.

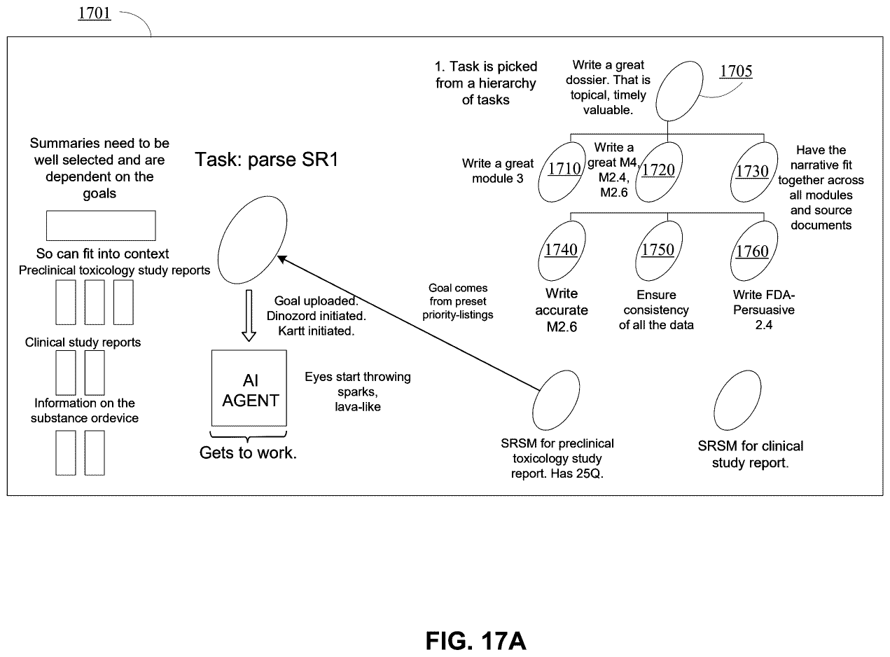

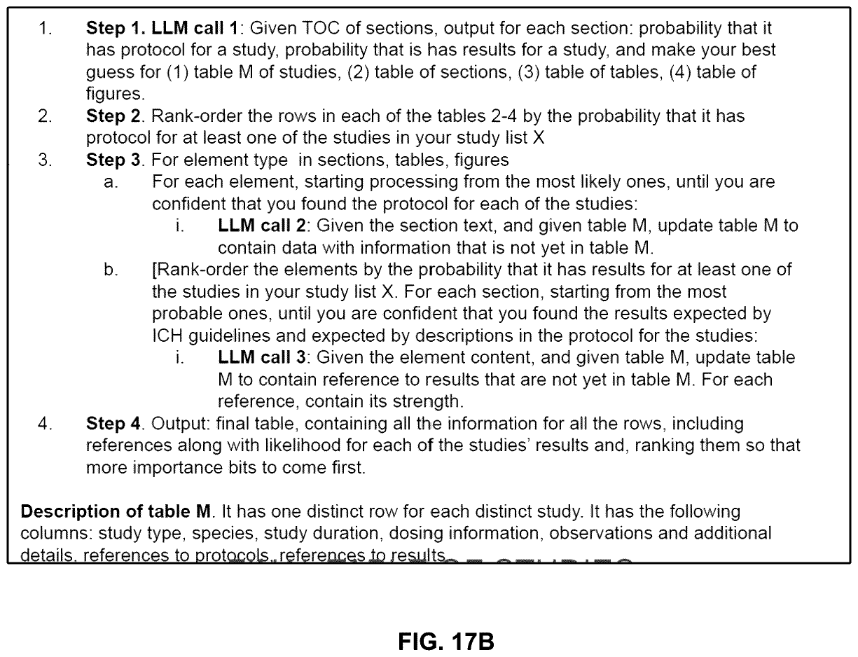

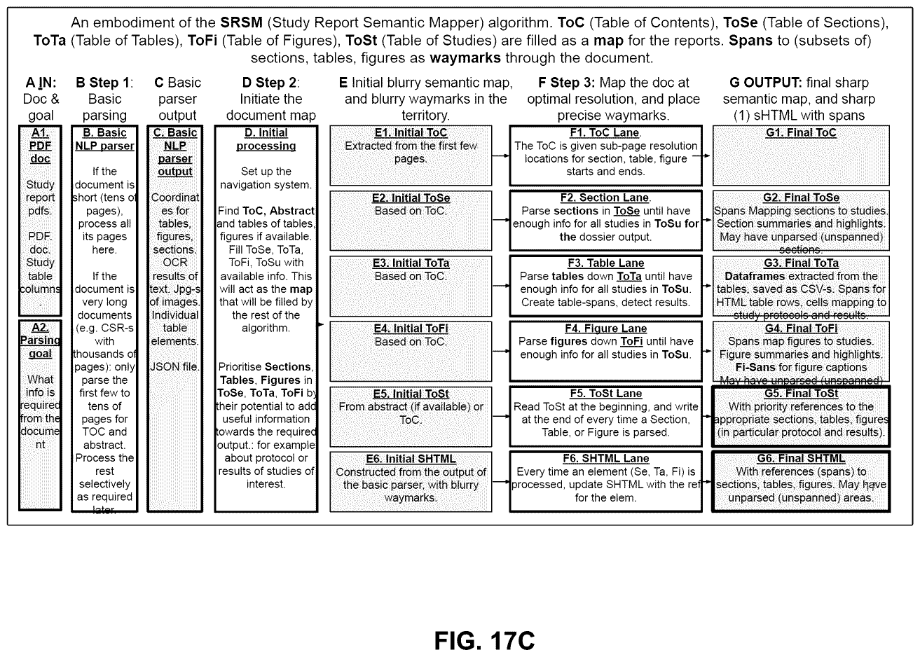

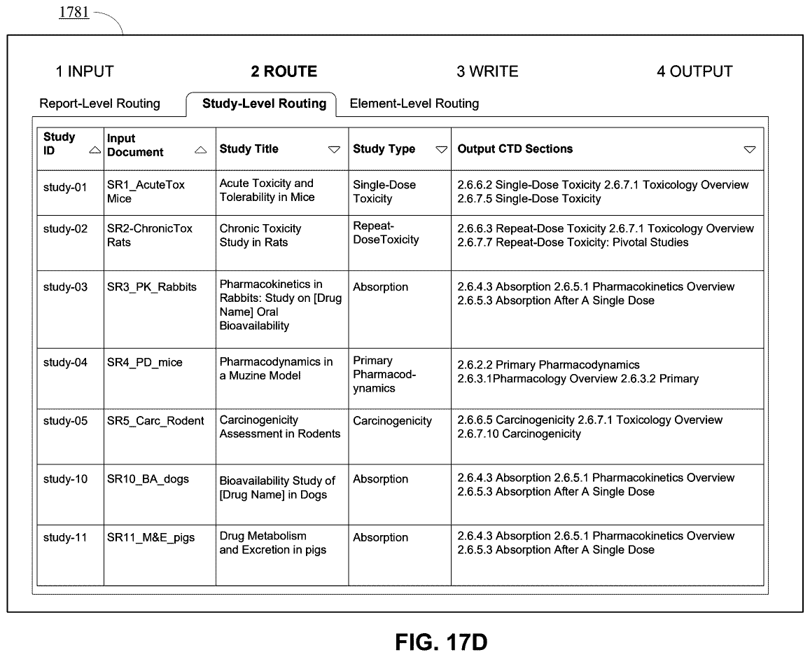

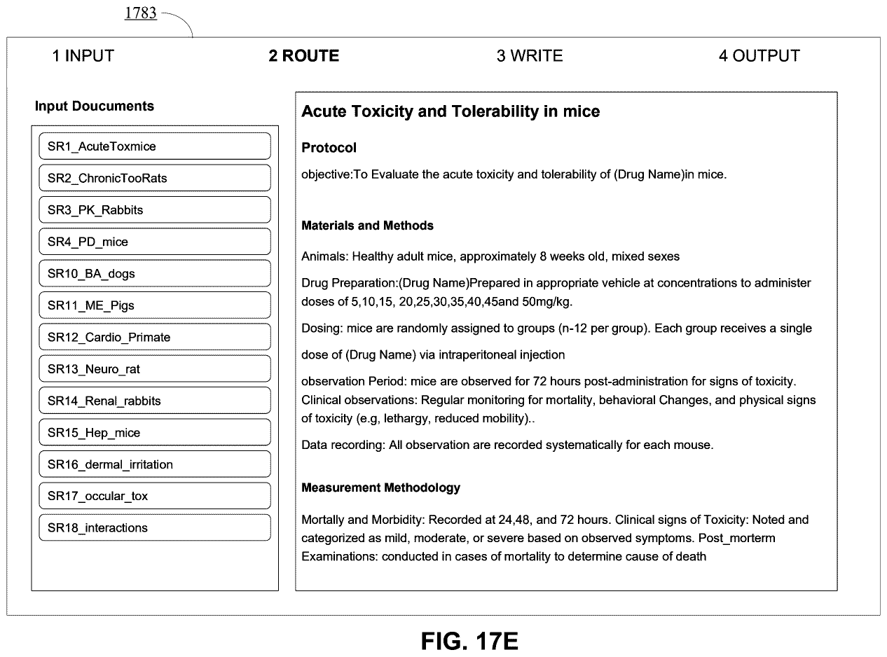

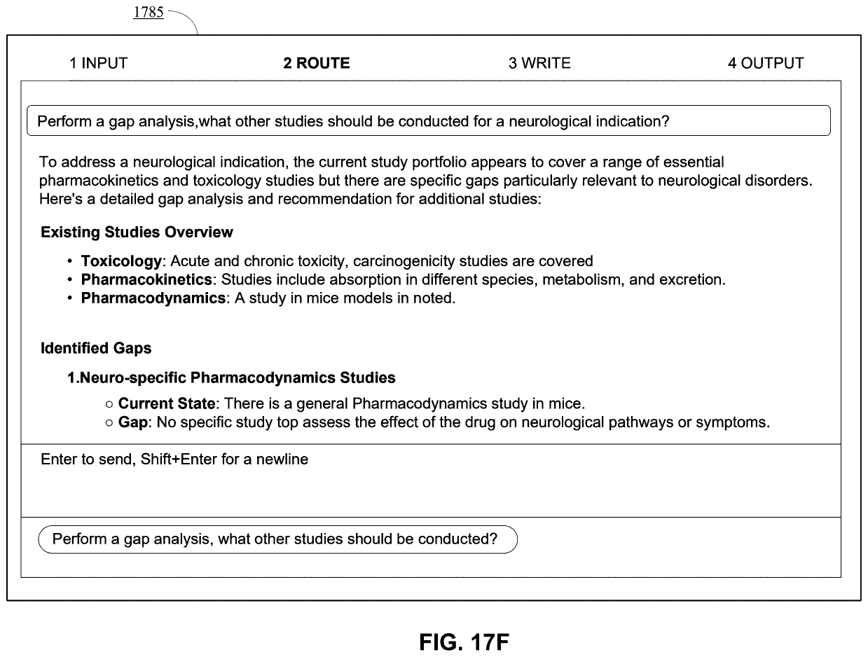

Process Step One—Setup (or Input): The setup operation (or step) of Auto-Dossier takes as input (1) user's goal for their target technology or drug or another entity that they want to evaluate, perhaps to go to market with, (2) a set of documents that target drug, technology, entity, etc. The setup operation of Auto-Dossier initializes the Auto-Dossier process, and passes the user input to processing by the subsequent steps. The goal for the user may be articulated in terms of commercial, clinical and technical goals. For example, a drug manufacturer may want to take a drug to the U.S. market in the Parkinson's therapeutic area. For this purpose, they need to submit an IND (investigational new drug), and then a New Drug Application, providing sufficient evidence for the quality (Chemistry, Manufacturing, Controls), nonclinical (pharmacology, toxicology, pharmacokinetics to demonstrate toxic effects and estimate safe human dose for first phase trial) and clinical (safety and efficacy studies) information. As soon as the user's documents finish uploading in process step one, the backend of Auto-Dossier is invoked and analysis begins on the documents, as presented in FIGS. 17B and 17C. FIG. 17B presents the Auto-Dossier process (or dossier generation process) using LLMs. The four steps (input, routing, writing and output) are listed down with respective LLM calls. FIG. 17C presents an example implementation of the study report semantic mapper (SRSM) algorithm showing how inputs in step one are processed through subsequent processing steps including routing (or initial processing), writing (step 3) and output generation (step 4). FIG. 17C presents specific examples of elements of data and portions of input documents that are processed through various intermediate processing steps to generate sections of the output document (e.g., a dossier).

The process steps in Auto-Dossier process are performed at increasing levels of granularity, and the process is driven by the goals and resource constraints of the user (for example, larger processing models are more expensive to run and may take longer time). Some of the variables that the user can select in step 1 include dossier type (clinical trial application, marketing authorization application, reimbursement application), geography (EU, US, UK, etc.), indication, product form. Alternatively, the user can upload a strategic plan in the form of TPP (target product profile) or another document which includes a subset or superset of these variables.

Process Step 2—Parse, route, and analyze: The second process operation (or step) of the Auto-Dossier takes as input the documents uploaded into the Auto-Dossier subsystem, along with the goals specified by the user through the interface of Auto-Dossier or written down in the uploaded documents, and provides as output (1) the documents in an organized and rapidly examinable format as shown in FIG. 17D (user interface 1781), FIG. 17E (user interface 1783) and FIG. 17F (user interface 1785) (2) an initial requirements analysis as shown in FIGS. 16A and 16B and (3) an initial gap analysis. The user interfaces 1781, 1783 and 1785 can be presented on one screen. The user interface 1785 is an example of rapidly examinable format of displaying the output. A user can interact with the output via user interface 1785 to provide feedback and/or ask questions, etc. The document organization, requirement analysis and gap analysis are performed driven by the goal for which the documents are to be used. The precise requirements for a given goal are determined by the regulatory body or another entity that makes a determination whether the user's submission should pass or fail the set of criteria to be allowed onto the market. The writing of a regulator-compliant dossier is generally preceded by a “pre-submission” or “scientific advice” meeting where the applicant can ask the regulator detailed questions to narrow down the requirements prior to finalizing their source data and prior to planning and submitting their dossier. The Auto-Dossier subsystem can also be used to suggest most informative questions to ask the regulator given the current source data and goals at hand. The Auto-Dossier subsystem can also be used to generate predicted regulator questions in response to a given dossier, and to generate answers to regulator questions. Any analysis requires a plan and targets for the analysis, and the requirements for acceptance or rejection inform the way that the LLMs or other processors are called to process and organize the Auto-Dossier input documents. The user interface for the second process step (i.e., route) is presented in FIGS. 15A and 15B as illustrated for one implementation of Auto-Dossier subsystem.

Sub-step 2.1: The document organization and routing sub-operation (or sub-step) in the second process operation (or step) takes as input the set of documents uploaded, and provides as output the set of output sections each of the input documents is relevant to, at increasing levels of granularity. At first, this is presented for each document as a whole; then for different elements of the document (e.g., which sections) and which variables from the document (e.g., which studies) and finally, the system detects the precise information from each document and presents more precisely which sections of the output it should be used in. This allows the system to start providing the user with some information straight away, while the rest is still processing. The processing status is indicated to the user. It can be performed in a number of different ways in different implementations of the technology disclosed, but one way is illustrated in FIG. 17B.

Sub-step 2.2: The requirements analysis sub-operation (or sub-step) in the second process step takes as input relevant information on the goals of the user and returns the set of input information and output sections to be written that should be present for a likely successful application. This analysis is based on specific feedback from the regulator if available, guidelines, laws and regulations relevant to the application, and examples of past successful and rejected applications where available. The requirement analysis can be performed by an LLM that takes these elements as input and provides the set of requirements as output.

Sub-step 2.3: The gap analysis sub-operation (or sub-step) in the second process operation (or step) takes as input the output from the requirements analysis function along with the output from the data organization or routing step, and provides as output the gaps between the regulatory requirements and what the user possesses, such as: missing or incomplete (pre) clinical study data, manufacturing or quality control deficiencies, unmet requirements for target labeling claims or safety evaluations. It identifies, which parts of the dossier can already be drafted, and makes suggestions on how to close the gaps.

Sub-step 2.4: The generate writing plan sub-operation (or sub-step) in the second process operation (or step) takes as input the output of organization and gap analysis and makes a determination regarding dossier sections that can be written and the dossier sections that cannot be written, and which inputs should be used for the writing which sections, and the order of writing the sections, and which processor instances are to write which sections, etc.

Calling the Auto-SLR for some dossier sections: Some of the sections in the dossier can be filled with information from relevant secondary research, which can be obtained from Auto-SLR. The Auto-SLR subsystem is configured with logic to perform systematic literature review. The Auto-Dossier subsystem can send a question to Auto-SLR subsystem, and the Auto-SLR subsystem can return its answer, with references to high quality research articles, which can then be used in the submission. Details of the Auto-SLR subsystem are presented below.

The Document Comprehender Subsystem: The document comprehender (as shown in FIG. 1) is configured with logic to process input data and a set of databases that collect and process relevant information for the Auto-Dossier. It focuses the processing on relevant regulations, guidelines, templates, past trials and past dossiers, and enables the user to draw the best information based on relevant guidelines, internal organizational information, and past example submissions (successes and failures).

The Semantic Study Report Mapper (SRSM) takes as input a parsing goal along with a document, and provides as output a navigation map for the document and set of landmarks pinned to specific locations of the document. The parsing goal can be in the format of natural language, and can read, for example “extract studies that meet the ICH criteria for rodent toxicology studies, include both protocol and results”, and the document can be either scanned pdf, typed pdf, or a word document, for example, containing one or multiple different studies in the form of text, figures, and tables. The document does not need to follow any particular structure. The navigation map is akin to a new table of contents which is meant to optimally navigate the document with the goal in mind. Any goal provides a value hierarchy, and the value hierarchy can be used to organize information. The values are captured into sets of questions and sub-questions. The top level questions are the study protocol and results, as they pertain to the regulatory requirements and output formats (such as ICH document format). Any input document can be re-organized in a way that aligns with the requirements from regulatory body such as ICH or FDA, etc. Therefore, the SRSM can be run to organize sections to the tune of a navigation map which is optimized for submission to one regulatory body such as EMA, and another for FDA, for instance. This is similar to having one political map (country borders-borders of legislation) and one geographic map (nature-borders of mountain ranges) to navigate the same territory (the same report). The landmarks are specific links in the document that connect specific locations in the document to specific locations in the navigation map, and therefore ultimately provide a handle to route the right data in the input documents to the right locations in the output dossier.

The SRSM algorithm processes an input document iteratively and strategically. It begins by finding the table of contents (TOC), the tables of figures and tables if available, and making the decisions for further processing based on these. In the following steps, either the whole document or only selected parts can be processed. The first optional processing step of the algorithm is running an OCR algorithm in case the pages of the document are in image format. The next step is a text-table-figure layout detector and text extractor, which extracts the text content from each of the pages and detects particular areas of text such as titles. In this step, third-party tools like Amazon Textract or a proprietary version trained to handle documents for the regulatory purpose can be used. The output of such tools may represent document layout elements such as text, figures, tables in a format such as JSON, YAML. The document layout elements may be defined in terms of coordinates of their parts such as their corners. These coordinates of their parts are mapped to the derivatives of this information in the data comprehender subsystem, and to the output. This allows the user to trace any input document element to the output and all intermediary elements that use this information. As follows, an LLM is called on the select parts of the documents in a prioritized manner to process the parts of the document that are particularly relevant to the writing of the application or the answering of the regulatory questions that the user is particularly interested in.

The SRSM algorithm does not need to finish processing the document fully. A part of the document may get fully processed to a high resolution detail at the start, whereas another part gets fully analyzed only at the time when the user asks a deeper question about that region. This helps to save time and cost in the project.

The motivation for an algorithm like SRSM is that parsing documents is computationally expensive, and they can be parsed with high quality results if done strategically and carefully. AI models like LLMs can only handle a limited amount of input in their context window and may produce low quality results if their context window gets filled with superfluous data and therefore the input given to a model when asking for results has to be selected carefully. The SRSM provides a solution to this processing problem. The motivation for an algorithm like SRSM is also that AI models such as Large Language Models perform much better if their context is constructed carefully (sometimes referred to as “context engineering”).

The SRSM algorithm can be applied to the output templates, the input documents, and to regulator guidelines. The following sections present an implementation of the SRSM algorithm using calls (or prompts) to LLMs for various tasks related to dossier generation.

LLM call 1: Given TOC of sections, output for each section: probability that it has protocol for a study, probability that is has results for a study, and make your best guess for (1) table of studies (ToSu), (2) table of sections (ToSe), (3) table of tables (ToTa), (4) table of figures (ToFi).

Rank-order the rows in each of the tables 2-4 by the probability that it has protocol for at least one of the studies in your study list X, for element type in sections, tables, figures, for each element, starting processing from the most likely ones, until you are confident that you found the protocol for each of the studies.

LLM call 2: Given the section text, and given table M, update table M to contain data with information that is not yet in table M.

Rank-order the elements by the probability that it has results for at least one of the studies in the study list X. For each section, starting from the most probable ones, until the system is confident that it has found the results expected by the regulatory body such as ICH guidelines and expected by descriptions in the protocol for the studies.

LLM call 3: Given the element content, and given table M, update table M to contain reference to results that are not yet in table M. For each reference, contain its strength.

Output: Final table, containing all the information for all the rows, including references along with likelihood for each of the studies' results and, ranking them so that more importance bits to come first.

Description of table M. The table can have one distinct row for each distinct study. The table can have the following columns: study type, species, study duration, dosing information, observations and additional details, references to protocols, references to results.

Third Process Step of Auto-Dossier Process (generate draft): The third step in Auto-Dossier takes as input the writing plan generated in the second process step, and gives as output written dossier sections. The sections are written through LLM or other AI processor calls, and the output results provide references to the inputs that were used to generate them. This enables the user to determine the origin of each part of the output, and ensure that the LLM generated sections do not include hallucinations as shown in FIGS. 16A and 16B. The user also has the ability to ask for revisions for any section of the output.

Fourth Process Step (review, quality control, and iterate): The fourth step in Auto-Dossier process takes as input the dossier draft generated in the third process step or otherwise (e.g. user can upload their own dossier), and provides as output quality review performed either by AI models, or a combination of humans and AI models. The fourth process step is also referred to as the output process step.

Backend: The backend of Auto-Dossier is set up such that the right LLMs are called at the right time. A table of process queue is maintained for that.

Chat. The user can chat with documents in context. The user can ask to change context to the chat through chat.

Voice. The user can provide instructions through a voice interface.

Custom prompts. The user can write their own prompts.

Custom templates. The user can upload their own templates. The templates can be generated from example documents.

Specializing models. Base models such as LLMs or others can be specialized to work well on the regulatory tasks.

### Process for Generating a Dossier

FIG. 16C presents a process flow diagram (also referred to as a process flowchart) illustrating process steps (or process operations) for generating a regulator-compliant dossier. The process of generating the dossier is implemented by the Auto-Dossier subsystem. As with all flowcharts (of process flow diagrams) herein, it will be appreciated that many of the operations can be combined, performed in parallel or performed in a different sequence without affecting the functions achieved. In some cases, as the reader will appreciate, a re-arrangement of operations will achieve the same results only if certain other changes are made as well. In other cases, as the reader will appreciate, a re-arrangement of operations will achieve the same results only if certain conditions are satisfied. Furthermore, it will be appreciated that the flowcharts herein show only operations that are pertinent to an understanding of the technology, and it will be understood that numerous additional operations for accomplishing other functions can be performed before, after and between those shown.

The process starts at an operation step 1640 at which the Auto-Dossier subsystem receives source documents for generating the dossier. The source documents can be associated with a target for which the regulator-compliant dossier is being generated. The target can be a drug molecule, an entity, a medical device, a drug, a chemical, a food, etc. Source documents can be accessed and/or received from public and private sources of data as illustrated in FIG. 1. The process continues at an operation step 1645 at which the Auto-Dossier subsystem processes the source documents to determine one or more sections in source documents that are correlated with corresponding dossier sections. The method of generating the dossier, disclosed herein, can identify any missing sections in the source documents or any documents such as studies, etc. that are missing. In one implementation, the operation steps 1640 and 1645 can be performed by a first processing engine. The data from the first processing engine are passed on to a second processing engine that is configured with logic to generate a regulator-compliant. The process continues at a subsequent operation step 1650 at which corresponding dossier sections are generated using the respective sections or portions from source documents in dependence upon the section-wise guidelines. At an operation step 1655, the Auto-Dossier subsystem identifies gaps in dossier sections that have not been completed due to lack of support or lack of contents for respective dossier sections in source documents. If one or more gaps are identified at an operation step 1655, the Auto-Dossier subsystem displays the gaps in a user interface for review by the user (operation 1660). The process can then continue at the operation 1640 to gather more data to fill the gaps identified. When there are no gaps identified at the operation 1640, the Auto-Dossier subsystem can continue to generate complete dossier that is compliant with regulator's requirements (operation 1665).

FIG. 16D presents an example document comprehension coarse-to-fine algorithm for automatically generating an optimal regulator-compliant dossier. This figure illustrates how a “coarse-to-fine” algorithm for building an optimal regulatory submission automatically, iteratively builds an increasingly coherent and well-grounded-in-facts narrative in the output. The slanted dotted line on the left labelled “output-sculpt” illustrates how the output trends towards optimal state through steps 1-6. The slanted dotted line on the right labelled “input-interpret” illustrates how the interpretation of the input trends towards its optimal state through steps 1-6. At step 1, the initial narrative is set roughly based on the goal of the applicant (example goal for a user with molecule X: start first-in-human trial for neurological use for molecule X). At step 2, the user uploads documents to AutoDossier and an approximate understanding emerges based on comparing the documents against the goal of the user, discovering gaps (example gaps: 7 missing studies). At step 3, the system or user suggests, based on the available facts in the data, to adjust the goal and narrative based on the improved interpretation of input (example adjustment: switch from neurological trials to oncological trials, since the input data available fits that goal apart from 1 missing study). At step 4, the facts that are relevant to the adjusted goal (oncology not neurology now) and most scientifically sound and from most reliable locations are localized in the inputs, and are organized into arrangements appropriate to that goal (example adjustment: a subset of studies are not relevant since different model organisms and outcome measures are relevant to oncology compared with neurology). At step 5 and 6, the references between the provenance of the facts in the input and the output are refined, ensuring consistency across the dossier and gathering user input for any remaining inconsistencies between the finalized goal and the finalized input interpretations. Finally, the input interpretation and output writing converge to an optimal state and the submission is finalized. In the diagram, this is represented by the two slanted lines getting close to each other.

FIG. 17A presents a graphical illustration (1701) depicting initiation of artificial intelligence (AI) agents with tasks based on goal hierarchy and dependency graph. The dossier generation task is divided into a plurality of smaller subtasks and these subtasks can be further divided into subtasks. These subtasks are arranged in a graph as shown in FIG. 17A. A higher-level task (1705) is at the root node of the graph (represented in a tree structure). For example, as shown in FIG. 17A, the higher-level task is “write a great dossier, that is topical, timely and valuable.” The technology disclosed then breaks down the higher-level task into smaller tasks such as “write a great module 3” (1710), “write a great M4, M2.4, M2.6” (1720) and “have the narrative fit together across all modules and source documents” (1730). The tasks 1720 is further divided into three subtasks, “write accurate M2.6” (1740), “ensure consistency of all the data” (1750) and “write FDA-persuasive 2.4” (1760). The technology disclosed is configured with logic to break higher-level tasks in more granular tasks and then allow the AI agents to work on these tasks. The outputs from these smaller tasks are then combined to complete the higher-level tasks.

The following paragraphs present details of the Auto-SLR subsystem that is configured with logic to perform systematic literature review.

### Auto-SLR Subsystem

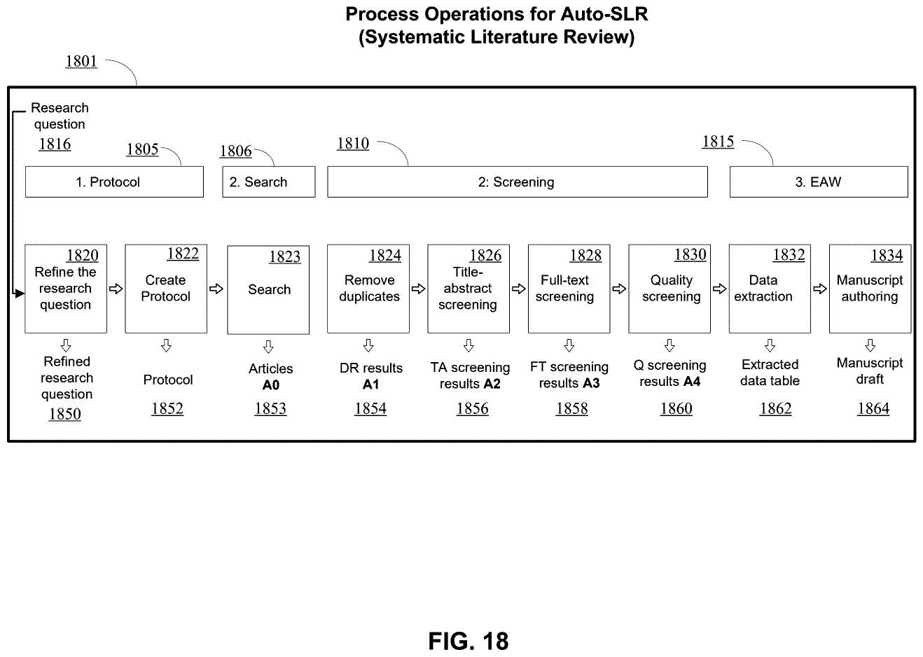

FIGS. 18 to 33B present various aspects of the automated systematic literature review process as implemented by the Auto-SLR subsystem. The SLR (Systematic Literature Review) process comprises four steps: (1) setup and protocol crafting, (2) article search, (3) article screening, (4) data extraction, analysis, and writing. The Auto-SLR subsystem can also perform other types of reviews such as Targeted Literature Review (TLR). From here onwards, we use the term SLR, however, it is understood that Auto-SLR subsystem can also be applied to other types of reviews. Systematic, scoping and targeted reviews can be run by pharmaceutical companies for various reasons to understand their background context to their dossier: which preclinical and clinical trials have run in the past and their respective results. This can inform the design of future preclinical and clinical trials, and the economic and molecular landscape. Often, frameworks such as PICOS (population, intervention, comparator, outcome measure, study design) are used to guide the whole protocol of a literature review.

FIG. 18 presents a high-level architecture (1801) of the Auto-SLR process including data flow through various processing components of the Auto-SLR subsystem. The SLR process starts with a research question (1816), and ends with a report (1864) describing the entire process of the SLR from protocol through search, screening, extraction, risk of bias analysis, to writing, presenting the results of that process and the analysis of the results of the SLR process. Using existing techniques, this process of conducting an SLR is arduous and can take a long time and many human hours to complete e.g., up to multiple months to years (especially screening and data extraction). Existing process techniques are also obfuscated. The Auto-SLR subsystem automates this process from research question through all the steps to the final output, making the process transparent, more robust, faster, and less labor intensive. Further, Auto-SLR subsystem allows human input during each operation step of the process. The four operations (or steps) of the SLR process in are described below.

The Auto-SLR subsystem comprises a user-friendly user interface (or frontend) accessible through a software-as-a-service (SaaS) web-app, a backend which communicates with the frontend, and user-specific databases which contain results for the projects that the user has run or is intending to run. In one implementation, the Auto-SLR subsystem can comprise a database (also referred to as a general database) that can store articles and indices. The core elements of a systematic literature review (or SLR) are protocol, results, and manuscript. The protocol describes how each part of the SLR should be performed. The output comprises results to each of the parts, and the manuscript or report describes both the protocol and the results in a human readable format, with reference made to the original protocol and the results.

In one implementation, the Auto-SLR subsystem uses Large Language Models (LLMs) for performing one or more steps of the SLR. Each LLM can be called in a specific way optimized for the steps of the SLR (as described below). The LLMs may be optimized through either prompt engineering or fine-tuning, or they may be trained from scratch with the purpose of performing the steps of the SLR. In other implementations, other types of processors including machine learning and artificial intelligence models can be used in place of the LLMs. In general, the Auto-SLR subsystem can use a “LxM model” (Large “x” Model) for a task where “x” may stand for language, action, search, or another task that the model has been specialized on.

Further details of Auto-SLR process steps are presented below. References to FIG. 18 are used to described the process steps in the following paragraphs.

Process Step One (step 1): The first process operation (or step) comprises setup and protocol crafting (operation 1805 in FIG. 18). The setup operation takes as input a research question 1816 (RQ), refines the research questions (operation 1820) and gives as output a refined research question (1850) a protocol “P” (, 1852) for running the SLR. The protocol comprises individual sub-protocols for article searching (operation 1810) and download, article screening (operation 1810), data extraction (operation 1815), data analysis, and manuscript authoring or report writing (operation 1834). The protocols are written by calling Large Language Models (LLMs), implemented into pipelines with custom logic, and prompts requesting the writing of these sections.

First, the sub-protocol (or protocol) is generated for each step of the SLR. This generation can optionally take as input relevant past SLR protocols, either supplied by the user, or retrieved from a database by the system, based on similar metrics of similarity (such as indication, population, intervention, comparator, outcome metrics, study design). For example, the protocol/plan may reuse some typical wording for inclusion or exclusion criteria from past relevant studies.

Once a protocol has been generated for each step of the SLR, the system may optionally test the protocol on either LLM-simulated or similarity-retrieved or user-supplied toy dataset, with adjustments made. This can be done agentically (i.e., performed by an AI agent) in an OODA (observe-orient-decide-act) loop by an AI model, without human intervention. Human input and feedback can be supplied, optionally, either through command to the AI, or directly to the protocol content. For example, the generated inclusion-exclusion criteria may be run on three or more example articles of known outcome, to discover problems (for example, the population inclusion criterion “cancer patients” may be too broad) and fix them (for example, the population criterion is reworded to “neck cancer patients”). The fixes may include wording changes, narrowing or expanding the definition, making the whole set of criteria more relaxed or more stringent, or making the individual criteria be more MECE (mutually exclusive, collectively exhaustive) for the screening task at hand. The technology disclosed can provide user interfaces for presenting outputs during the SLR process and receiving human feedback.

The set of protocols can include, a protocol for searching, a protocol for screening, a protocol for data extraction, a protocol for analysis (such as meta-analysis or risk-of-bias analysis), and a protocol for writing. The protocol for searching includes the research question, objectives for the search, the databases to be searched, a set of keywords to be included in or excluded from the search, and specifies a strategy for going from the aforementioned material provided to a final query, using steps like expanding keywords, finding synonyms, using frameworks like PICOS (population, intervention, comparator, outcome measure, study design), specific syntax instructions and so on. The protocol for screening includes the inclusion-exclusion criteria, instructions for the application of inclusion-exclusion criteria, and specification for how and by whom the inclusion-exclusion criteria are to be applied (title-abstract, full-screen). The overall decision procedure may be defined in terms of criteria-wise decisions (for example, if all inclusion and no exclusion criteria are met, include the article in full-text screening). Standards like PRISMA or any others may be used. The protocol for extraction includes the set of features to be extracted (e.g., study type, sample size, interventions, outcomes), tools for extraction, procedures for cross-checking extracted data. The writing protocol includes a template for writing, and instructions on style and content of the different sections. The Auto-SLR subsystem may call AI models asking them to write prompts for each of the sub-steps of the Auto-SLR process.

In Auto-SLR, the protocol may be written iteratively. Each part of the protocol can be dependent on other parts, and parts can be iterated so that they all fit together. For example, the inclusion and exclusion criteria may be adjusted based on the search terms, or the extraction plan may be adjusted based on the criteria. The OODA-agent in the system may test the protocol on a toy dataset and refine it based on the performance on that dataset. The toy dataset may be generated by sampling a semi-random set of articles from PubMed. Often, a framework such as PICOS is used to align each process step with each other (by e.g., designing the query, the screening criteria, the extraction columns, to have components for each of PICOS terms. Examples of user interfaces that are provided for the first process step are presented below.

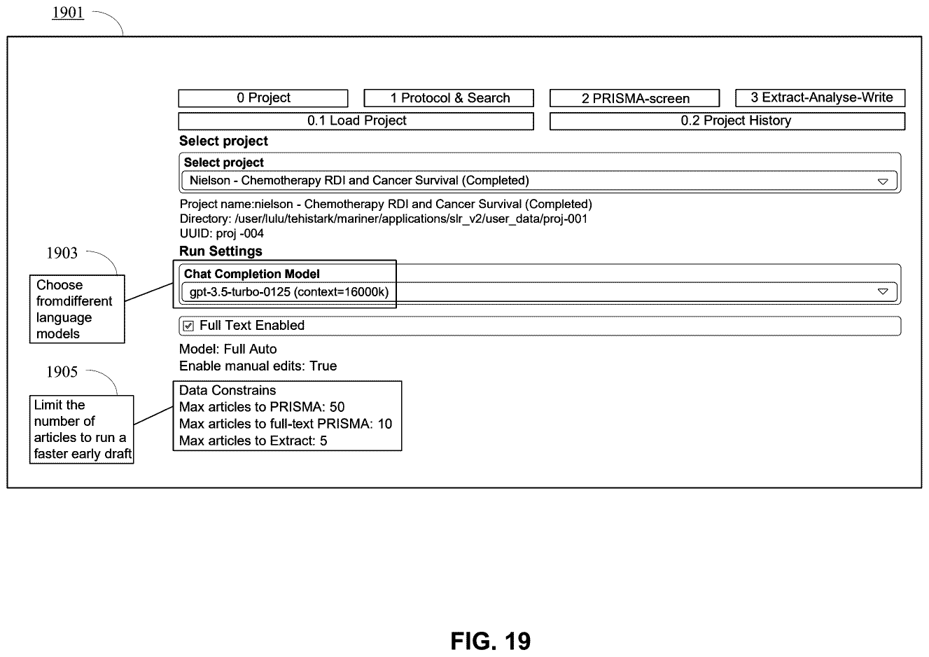

FIG. 19 presents an example user interface 1901 to setup a project for systematic literature review using the Auto-SLR subsystem. A user interface element 1903 can be used to select a particular large language model (LLM) for use in systematic literature review (SLR) process. A user interface element 1905 allows the user to set the limits on the number of articles (or other types of resources) for use in the SLR process.

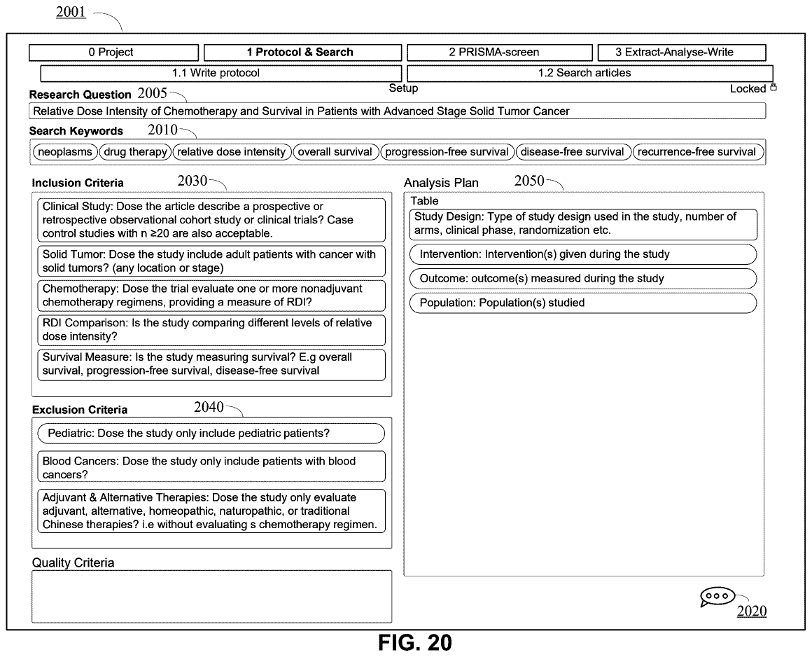

FIG. 20 presents an example user interface 2001 that can be used for protocol writing. A user can provide a research question using a user interface element 2005. In the example shown in FIG. 20, the user has provided a research question, “Relative Dose Intensity of Chemotherapy and Survival in Patients with Advanced Stage Solid Tumor Cancer”. The user can also provide one or more search keywords for SLR process. The search keywords can be input using a user interface element 2010. The user can use the chat feature by selecting a user interface element 2020 to open a dialog box or window to interact with the LLM (large language model) during the process of defining the research question. The user can improve or revise the research question using feedback from the LLM. The user can also provide inclusion and exclusion criteria using respective user interface elements 2030 and 2040, respectively. The user can enter the analysis plan using a user interface element 2050. The inclusion criteria, exclusion criteria and analysis plan can be generated by the LLM or entered by a user independently. In one implementation, the user can work with the LLM to generate and revise the inclusion criteria, exclusion criteria and analysis plan, in combination with the LLM.

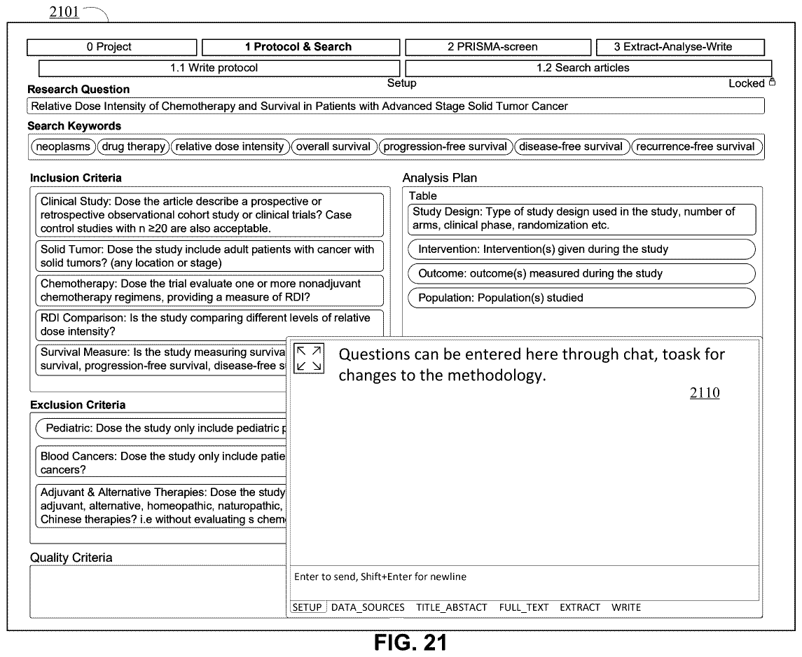

FIG. 21 presents an example user interface 2101 that presents an example dialog box or window 2110 displayed in response to user's selection of the user interface element 2020 in FIG. 20. The user can enter questions using the dialog box 2110 regarding methodology during protocol writing process operation. The user can interact with the LLM to change the methodology and provide feedback regarding changes to the LLM using the window 2110.

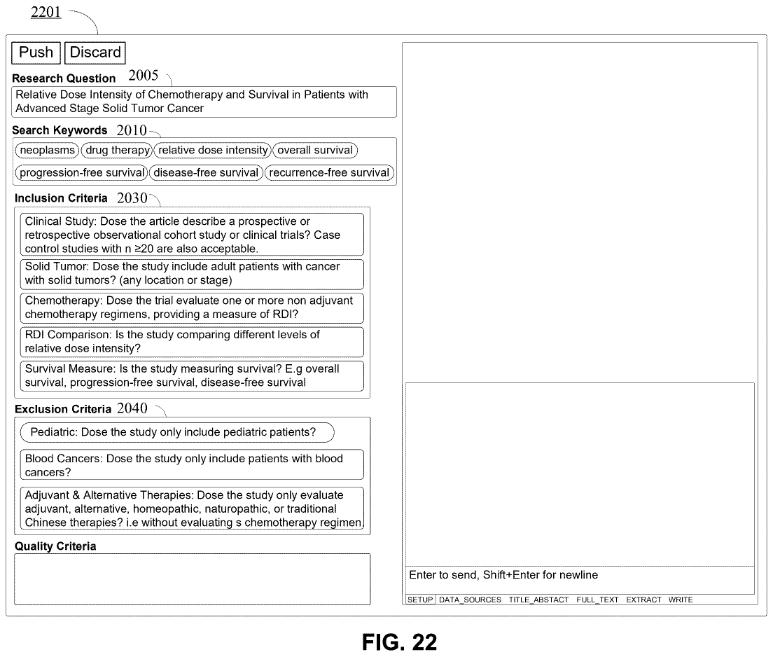

FIG. 22 presents an example user interface 2201 that can be presented to the user during protocol writing process operation. The user interface 2201 presents another implementation in which the details such as research question (2005), search keywords (2010), inclusion criteria (2030) and exclusion criteria (2040) are presented in a pop-up window user interface (2201).

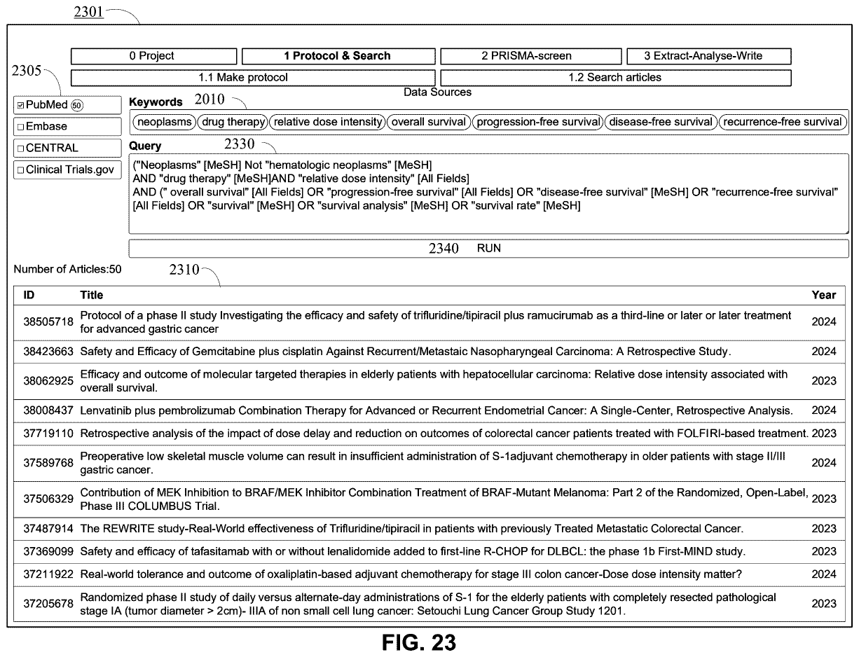

FIG. 23 presents an example user interface 2301 that presents search results comprising articles returned in response to search query. User interface element 2305 lists the names, labels or identifiers of the search databases. Checkmarks are presented against the names of one or more search databases that have been used for article search. For example, in FIG. 23, “PubMed” database has been selected for searching and is shown with a checkmark. A user interface element 2310 presents search results. The search results in user interface element 2310 are presented in a tabular form with an identifier (ID), a title and a year for each search result. Search keywords are presented in the user interface element 2010. A user interface element 2330 presents search query used for performing the search. The search query can be generated by the AI model (such as LLM) and can be edited by a human user. The search query can use a combination of search keywords joined together using various combinations of operators such as “not,” “and,” “or,” “mesh”, “all fields”, etc. A user interface element 2340 can be selected to run (or execute) the search query. The search query can be run a plurality of time by making various edits to the query and/or the search keywords. The results can be updated in the user interface element 2310 after each search execution or search run. The user interface element 2020 as shown in FIG. 20 can be used by the user to interact with the Auto-SLR subsystem, edit query and optimize search results.

Process Step Two (Step 2): The second process step (or operation) comprises article search (1806) comprising search operation (1823). In the second process step, the protocol (1852) generated in the first process step or operation (1805) is taken as input, and returns a set of queries and a set of articles A0 (1853) returned by these queries as an output. The second process step or operation (1805) uses the instructions in the search protocol (1852) to write queries (by calling LxMs or other processors) that are then input to public (e.g., PubMed, EMBASE) or proprietary article search databases to return relevant records. The queries are constructed iteratively, sometimes part-by-part, and tested according to query writing strategies. For example, an LxM may query a database for population keywords first, discover how many articles do different sets of keywords return, and then construct the final query that is likely to return a comprehensive enough coverage at manageable screening volume. The LxM may evaluate the returned set of records either by count, titles, abstracts, pre-computed embeddings of the articles, or other features. It may compute new types of embeddings on subsets of the returned articles to make a decision on how to proceed with the search, and when to stop.

Optionally, the user can be involved in the search process, either in tandem with the LLM, through a natural language interface, or directly by editing the queries

After completion of the second process step, the screening protocol may optionally be adjusted, based on the volume or type of articles found in the screening process, to fit with the timelines or other requirements of the project.

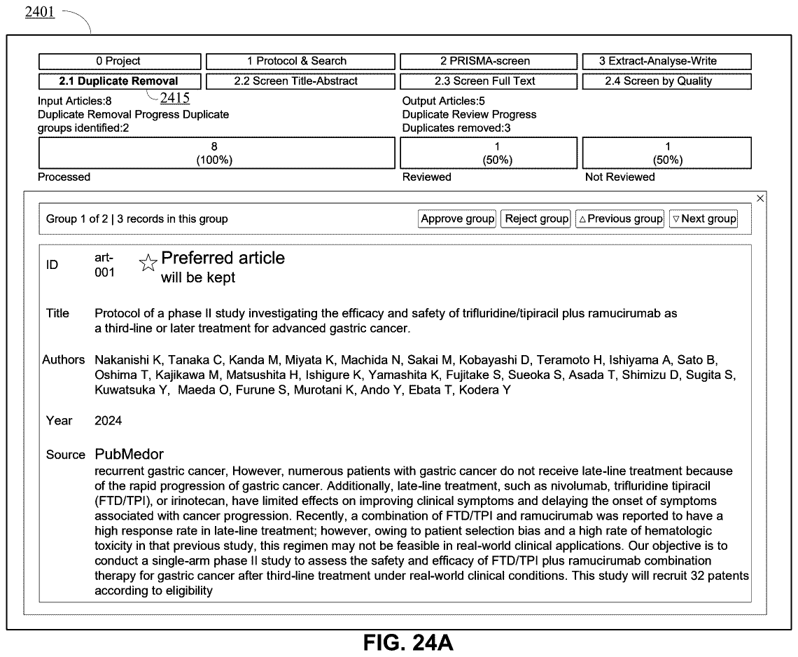

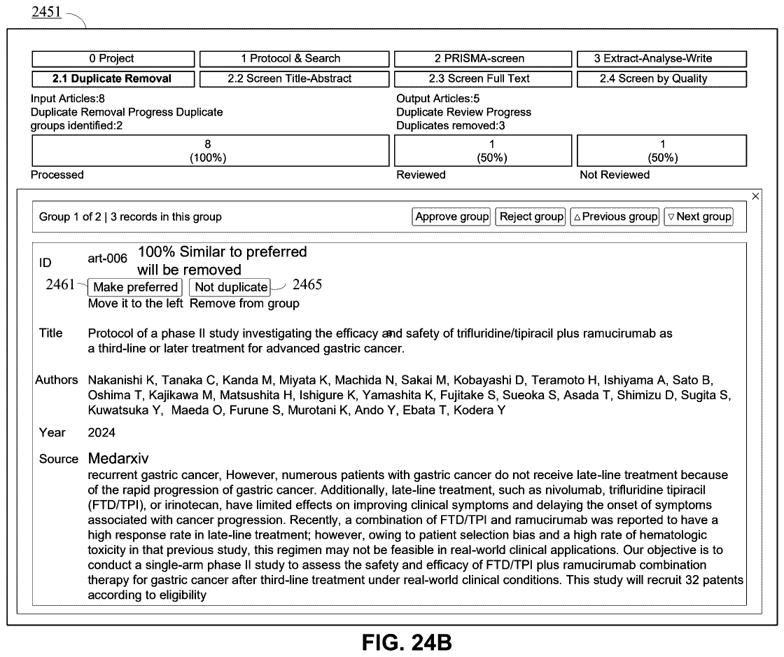

Process Step Three (Step 3): The third process (or operation) step comprises article screening operation 1810 . . . . In the third process step, the set of returned articles, A0 (1853), along with the screening plan and screening criteria returned by the first process step are passed onto the PRISMA screening pipeline. The PRISMA screening pipeline comprises duplicate removal, title-abstract screening, full-text screening, and quality control screening. The duplicate removal operation step 1824 step takes as input the set of articles A0 (1853), and returns as output a set of articles A1 (1854). For the set of articles in A0 (1853), the process includes reviewing article features like title, abstract, authors, publication time, publication venue, and detects groups of duplicate articles, as illustrated in FIGS. 24A and 24B. The process involves selecting the best article to keep for review according to article features. The title-abstract screening operation step 1826 takes as input titles and abstracts for the set of articles A1 (1854), along with the inclusion-exclusion criteria (IEC) and screening instructions, and gives as output include or exclude decisions, along with reasons for the inclusion or exclusion (in particular listing which criteria caused the exclusions and how) and evidence for the decisions (highlighting which elements of the article cause the overall and criteria-wise decisions—where elements of the article may be sections of text or parts or full tables or figures). The technology disclosed denotes the set of articles that received “include” decision as A2 (1856). The full-text screening operation step 1828 takes as input the full texts of the set of articles returned by the previous step, along with inclusion-exclusion criteria and screening instructions for full-text screening, and returns a set of include or exclude decisions, along with explanations or reasoning for these decisions and along with evidence for the overall and criteria wise decisions. These results are referred to as full text (FT) screening results A3 (1858). In order to be full-text screened, the full texts for the articles must be obtained first.

The system performs full-text search automatically, and attempts to download them by crawling known databases and web for them. However, at times, full texts for some articles may be unavailable. The Auto-SLR subsystem, therefore, introduce notation A3 (1858) for the subset of articles A0 (1853) that have full-texts. This set A3 (1858) is the input to FT screening or quality screening operation step 1830. The output from quality screening operation step 1830 is quality screening results (or Q screening results) A4 (1860) as the set of articles that received “include” decision by full-text screening. The full-text screening step may optionally include a further study quality analysis step, where the analysis moves from article level to a study (e.g. a clinical study) level, and each study within A4 (1860) is further quality-screened according to a quality screening protocol (which would be part of output of the first operation step) and quality criteria. The system may ask or allow the user to upload the missing articles, by dragging and dropping them into the user interface. Alternatively, the system may ask the user to authorize the purchase of those articles. After user authorization, the system may then purchase those articles from their sources (such as Elsevier) and automatically ingest the articles from the source databases.

All the article screening sub-steps, like other steps in the Auto-SLR system, enable user input either through natural language chat interface, or other interface elements, to review and correct the AI decisions (i.e., decisions taken by artificial intelligence models such as the LLMs). Examples of user interfaces for screening process operation are presented below.

FIG. 24A presents a user interface 2401 that illustrates removal of duplicate records from search results. A user interface 2451 as presented in FIG. 24B is used in combination with the user interface 2401 (e.g., in one window or user interface) for duplicate removal. The user interfaces 2401 and 2451 present output from the AI model (e.g., the LLM) used for duplicate screening. The AI model determines the likeness (or similarity) between articles based on string similarity between various sections of the articles such as titles, abstracts and authors lists, etc. In one implementation, a distance metric such as Levenshtein distance is used for determining the similarity between articles. In another implementation, distance between embeddings of respective articles as generated by the AI model can be used to determine distance between articles. A threshold for distance can be used to determine whether two or more articles of documents are similar enough to be considered as duplicates. In one implementation, the articles that are similar to each other based on the distance metric are placed in one group of cluster. User interface elements such as 2461 and 2465 can be used to select an article or identify that it is not a duplicate. The user interfaces 2401 and 2451 are displayed as part of the “2.1 duplicate removal process operation step” (2415).

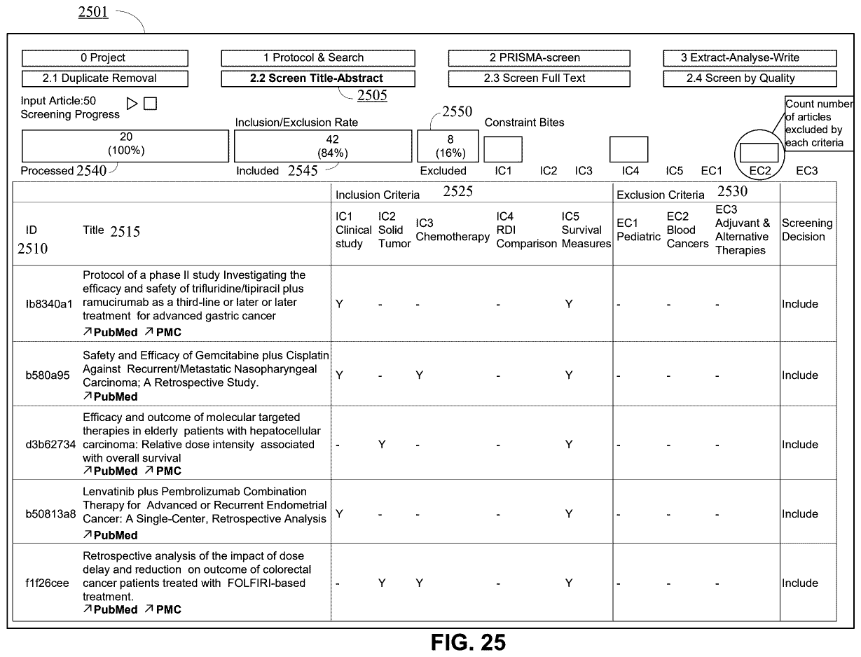

FIG. 25 presents a user interface 2501 for title and abstract screening of the search results. This is part of “2.2 screen title-abstract” process operation step (2505). The articles that passed duplicate removal screening are taken as input to the title-abstract screening process operation step. The articles are presented in rows in a table with columns for article identifier (or ID) 2510, article title (title) 2515, a column for inclusion criteria (2525) and a column for exclusion (2530) criteria. A progress of screening results is presented using user interface elements. For example, a user interface element 2540 indicates number or percentage of articles processed. A user interface element 2545 indicates number or percentage of articles that are included and a user interface element 2550 indicates the number or percentage of articles that are excluded. Graphical user interface elements labeled IC1, IC2, IC3, IC4, IC5 indicate the number of articles or percentage of articles included using inclusion criterion one to inclusion criteria five, respectively. Similarly, graphical user interface elements EC1, EC2 and EC3 identify the number of articles or percentage of articles removed or excluded using exclusion criterion one to exclusion criterion three, respectively.

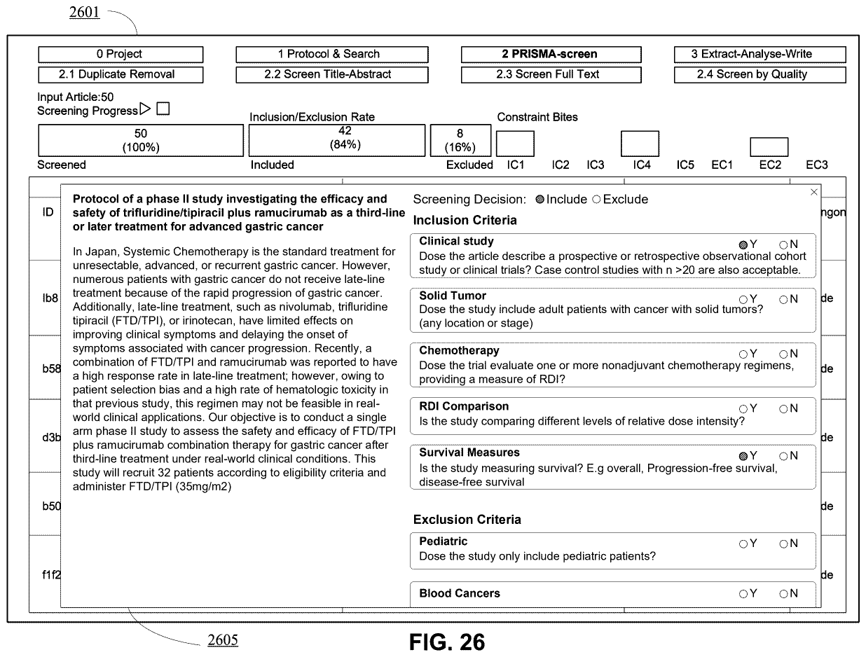

FIG. 26 presents a user interface 2601 that displays an article modal user interface 2605 during the article screen operation. The user can interact with user interface elements on the on user interface 2605 to provide feedback regarding the results of applying various inclusion and exclusion criteria and the overall “include” or “exclude” decision on the article. The user can select a “yes” or “no” option to indicate whether a particular criteria is fulfilled by the article. The user can select a user interface element to send these selections to the Auto-SLR subsystem. The user can edit the decisions that the AI made. The user can chat with AI about the decision to include or exclude the article through the chat interface (same icon as in FIG. 20 appears floating over each screen) or voice. The user can ask the AI to reconsider and article or to provide further justifications. The AI can revise its decisions based on such user input.

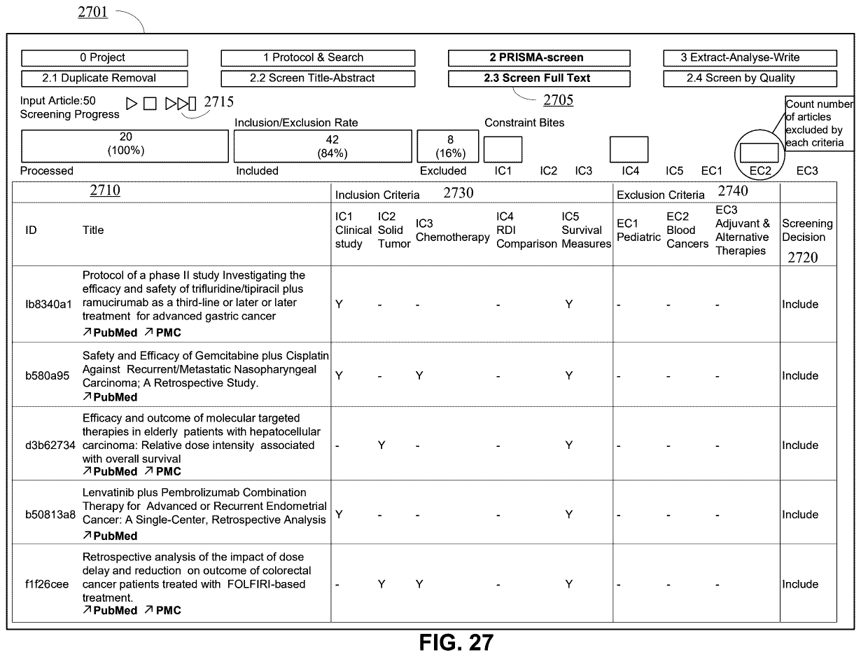

FIG. 27 presents a user interface 2701 that illustrates full text screening of articles. The user interface can be displayed as part of the screening operation “2.3 full text screening” (2705). A table (2710) presents the search results. The table (2710) comprises columns listing article identifiers (IDs), article titles, article inclusion criteria and article exclusion criteria. The table (2710) also includes a column indicating screening decision indicating whether the article is included or excluded. A user interface element (2715) can be selected to skip the full-text screening as shown in user interface 2701 and complete the draft for systematic literature review (SLR) using only title-abstracts. In table 2710, the articles, for which full text is not available, can be displayed in gray color text or gray colored cells and/or rows in the table to indicate to the user that full text of these articles is not available. Screening results (included or excluded) are presented a screening decision column 2720 for articles for which full text is available. Columns 2730 and 2740 in table 2710 present criteria-wise screening decisions for articles. Column 2720 presents overall screening results for articles.

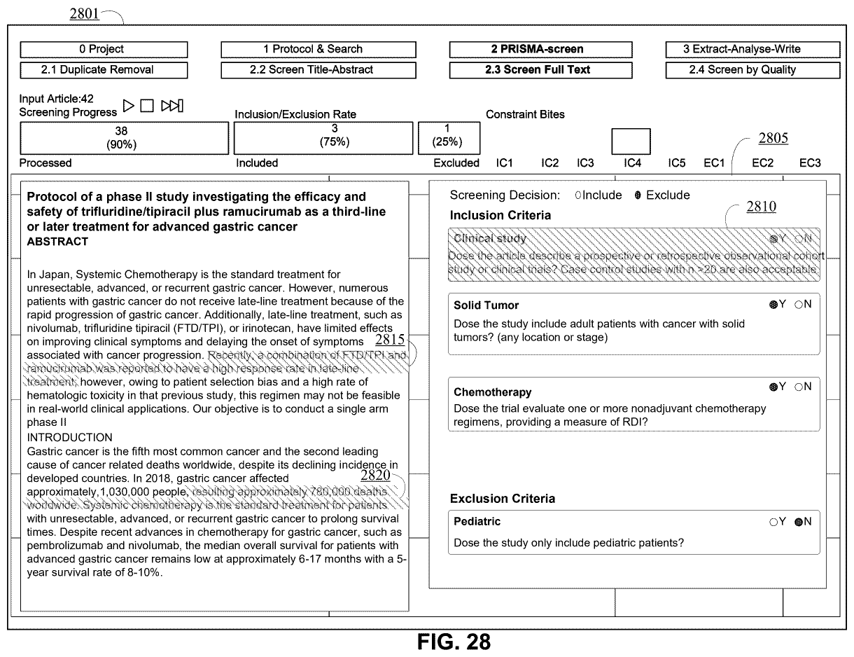

FIG. 28 presents an example user interface 2801 illustrating an Auto-SLR modal screen for screening full text articles. The user interface 2805 shows mapping of inclusion and exclusion criteria to sentences, sections, paragraphs, tables, figures or portions of the full text article. Selection of one or more criteria can highlight the sections in the full text article that support the criteria. For example, when a criteria (2810) is selected, the Auto-SLR system automatically highlights sections 2815 and 2820 in the article to provide the user source locations in the article that support the criteria. Therefore, the technology disclosed provides user with evidence for the decisions taken by the Auto-SLR subsystem for selection of articles. Similarly, feature is also provided by the Auto-Dossier subsystem in which sections or portions of dossier are mapped to sections or portions of source articles or other types of sources. When a section or a portion of the dossier is selected, the Auto-Dossier subsystem automatically highlights sections or portions of source articles from where the content in dossier is taken or adapted from. This is also referred to as provenance feature that allows users of Auto-SLR and Auto-Dossier subsystems to view evidence from source articles.

Fourth Process Step (Step 4): The fourth process step or operation step comprises data extraction, analysis and writing (operation 1815 in FIG. 18). The fourth process step (or step 4) in Auto-SLR process includes the following sub-steps: extraction, analysis, and writing. The data extraction operation 1832 takes as input the set of articles A4 (1860) returned by the previous article screening step, along with the analysis protocol from step 1822 and returns as output the relevant data extracted (1862) from those articles, along with provenance data on the source of each part of extracted data (with precise and specific references to either text, tables or figures in the articles). The data analysis operation step takes as input the output of quality screen operation i.e., A4 (1860), along with the analysis plan from first operation i.e., protocol (1852), and the included articles A4, and gives as output, analysis results that synthesize and interpret the key findings and insights from the studies in the included articles in A4, in a way that provides a useful answer to the research question. This operation step may perform a method similar to Auto-Dossier gap analysis across the studies. Depending on the type of SLR and the analysis plan, the analysis may take the form of thematic analysis, narrative synthesis, meta-analysis subgroup analysis, sensitivity analysis, meta-regression, or another type of analysis. This operation step can include evidence gap analysis map, and any of the analysis can be in visual, tabular, or text format. The manuscript authoring process step (1834) takes as input information from all the operation steps that came before: the protocol, the search, screening, and extraction steps, and provides as output a written manuscript written to the spec defined by manuscript writing protocol from first operation step (defined by a template with varying freedom in writing the different sections). A manuscript typically contains description of the research question, the methodology for the SLR (search terms and queries, data sources, inclusion-exclusion criteria, definition of features or values to extract, analysis plan), the results (screening, extraction, analysis results), discussions and conclusions, and references to the studies included in the SLR. The manuscript can be written by a template that the user can select from a menu in Auto-SLR, or that the user can upload or create inside the app, in some implementations of the invention.

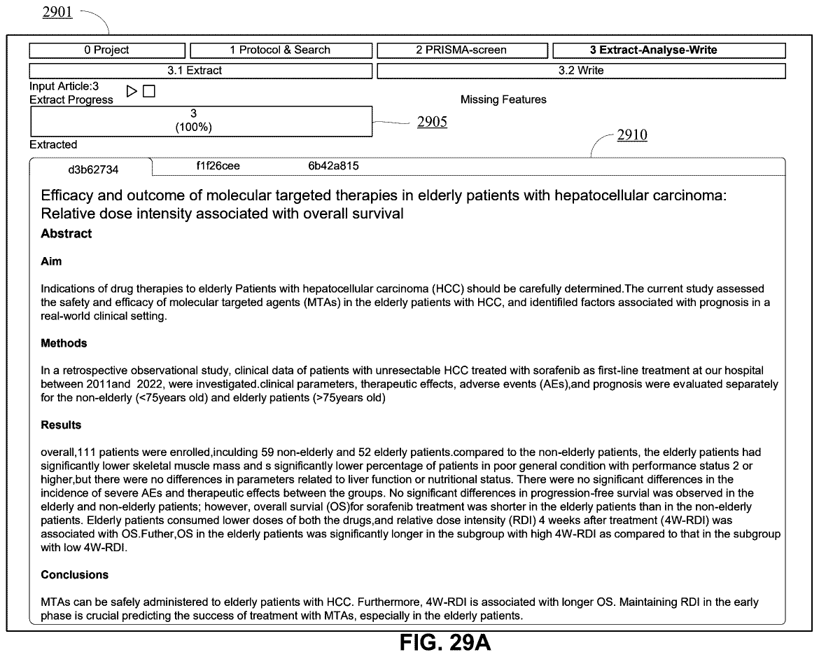

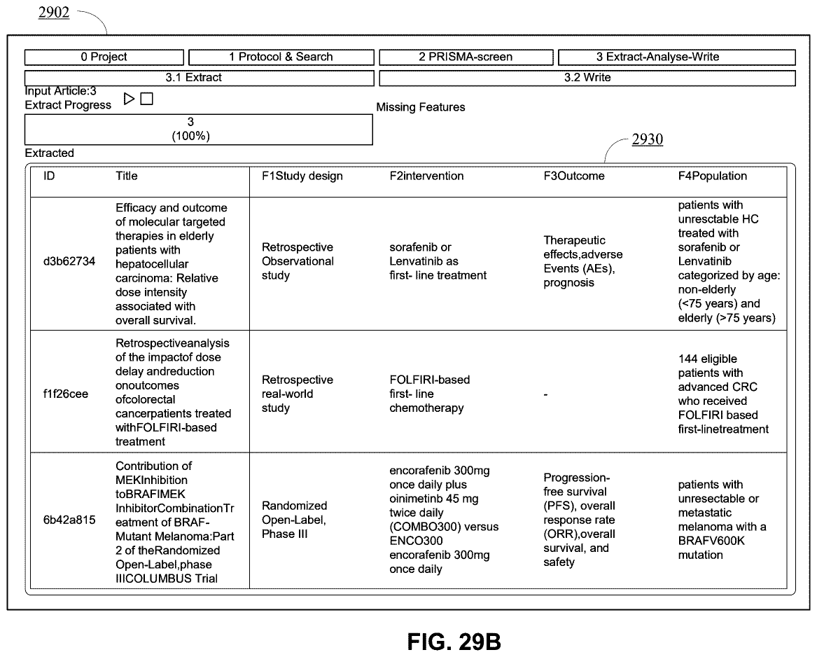

FIGS. 29A and 29B present examples of user interface that presents extraction results during the extract-analyze-write (EAW) operations of the Auto-SLR subsystem. FIG. 29A presents a user interface 2901 that includes user interface elements presenting progress of the data extraction process. A user interface element 2910 presents input articles from which data is extracted. The articles are arranged in tabs and a particular tab with article identifier can be selected to view the full text from the article. In other implementations of the user interface, the articles may be arranged differently. A user interface 2902 (in FIG. 29B) comprises a user interface element 2930 that presents output data extracted from the articles. The output data in the user interface element 2930 can be presented in a tabular format comprising columns for article identifier, title of the article, F1 study design, F2 intervention, F3 outcome and F4 population. Respective output data extracted for each of the columns in the table is listed for all articles. A user interface element 2905 presents progress of extraction process using a progress bar or progress chart.

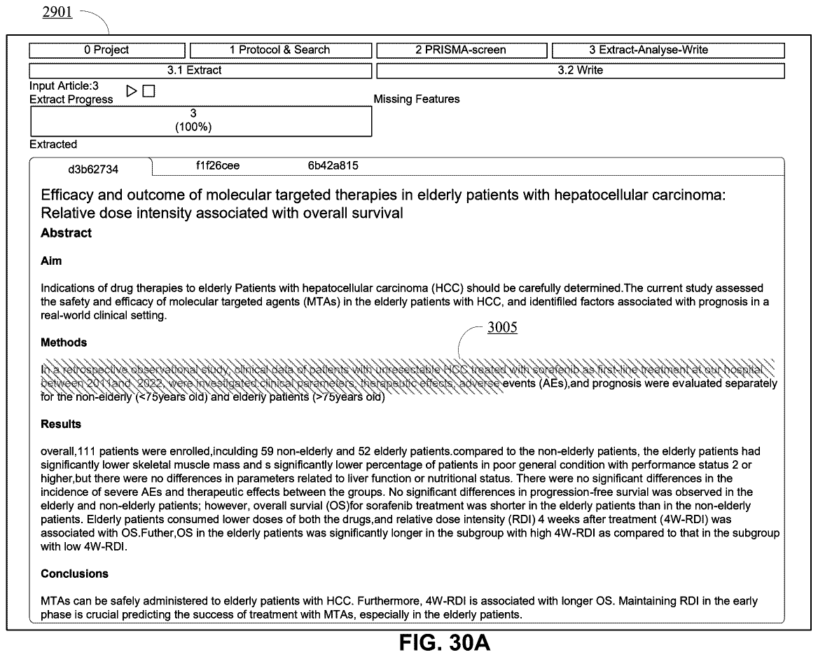

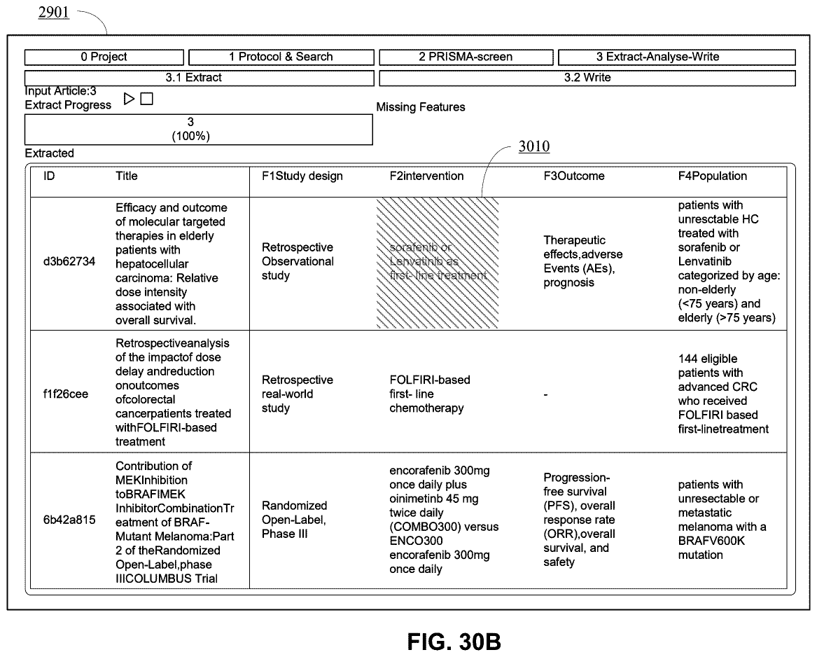

FIGS. 30A and 30B present the user interfaces 2901 and 2902 from FIGS. 29A and 29B, respectively. An output data 3010 (in FIG. 30B) is selected resulting in highlighting of the selected data. The Auto-SLR subsystem automatically highlights the input text segment (3005 in FIG. 30A) from where the content in output data 3010 came from.

Fifth Process Step (Step 5): The fifth process operation (or step) comprises updates to the review. After any of the steps in the Auto-SLR process, or after all of the steps, protocol for any of the operation steps may be updated, and these steps rerun. For example, the extraction step may provide insights into studies, and lead to discoveries of new search terms that ought to be included in the search process in the second operation step. This can lead to an updated set of articles A0 (1853), and subsequently an updated set of articles A4 (1856) included in the final results of the SLR, after running the SLR process. As another example, performing article screening may lead to the discovery that an additional screening criterion is required to perform the screening adequately, or that a screening criterion should be removed as insufficient articles are left otherwise. In one implementation, the old query may be repeated at a future time, to add new incoming studies to a literature review. This is valuable, for example, for pharmaceutical safety teams who track the safety events published about a given set of pharmaceutical products over time.

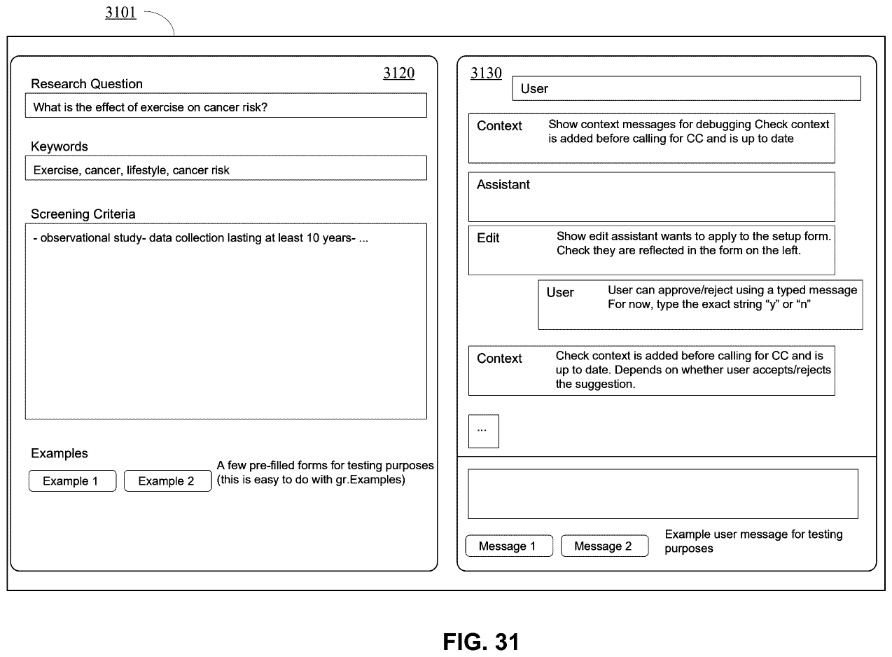

FIG. 31 presents an example user interface 3101 that present a demonstration of a chat assistant feature provided by the Auto-SLR subsystem. A user interface element 3120 presents research question, keywords, screening criteria, examples, etc. A user interface 3130 present shows a portion of a conversation between a user and the assistant.

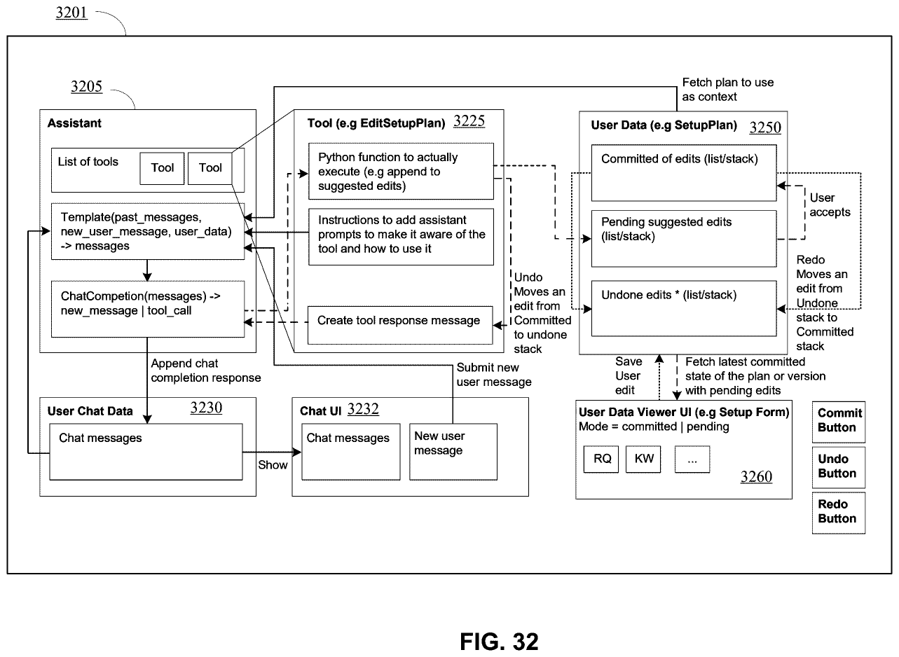

FIG. 32 presents a high-level architecture (3201) of the Auto-SLR's protocol planning assistant system for SLR protocol generation and editing. The architecture illustrates that assistant (3205) comprises a plurality of tools, a prompt template (Template), and a chat completion method (ChatCompletion) that determines whether to invoke a tool call or generate a direct response message. For all tools, functions and instructions are defined. FIG. 32 shows the operation of one tool-EditSetupPlan (3225)—in detail. User chat data module 3230 is configured with logic to interact with users via chat UI 3232. A user data module 3250 maintains all edits and presents the setup to the user via a user data view. A commit button implements the logic to commit user edits, an undo button implements the function to undo the changes or edits and a redo button implements the functionality to redo the edits or changes. The core components of this system are the Assistant, Tools, User Data, User Chat Data, Chat UI, and User Data Viewer. The Assistant comprises of a List of tools, Template, and ChatCompletion API for AI calls (may be OpenAI or Anthropic or another provider or proprietary AI model). The system accepts inputs from the user through Chat UI (3232) and directly at the content through User Data Viewer UI (3260). The user inputs through chat messages get displayed in the Chat UI (3232) and get sent into Template which is subsequently sent to AI through ChatCompletion API. For a given request, AI intelligence can decide to either call one or more tool, or provide response directly in its output. When a tool is called, (such as EditSetupPlan shown at 3225), a Python function is called to actually execute it, and thus produce its effects on the task at hand. For the EditSetupPlan illustrated in the figure, its effects are to append to suggested edits, which then leads to an action on the user data (3250), such as SetupPlan. The edit is sent to pending suggested edits, and there is a list or stack of suggested edits being maintained that can then be executed by AI workers over time. Users can accept an edit, which is then sent to a committed set of edits (list/stack). There is an Undo button that moves (dotted arrow) edits to the undone edits list/stack, and a Redo button that moves (dotted arrow) an edit from undone stack to committed stack. A fetch of the latest committed state of the plan or version with pending edits is retrieved (long dashed arrow) and shown to the user in the UI when the UI is loaded. The boxes at 3230 and 3232 represent the UI. User Chat Data (3230) goes into Chat UI (3232), and User Data Viewer UI (3260) shows elements like research questions (RQ), keywords (KW) and other data. The interface displays Commit button, Undo button, and Redo button, which are buttons that users can use to commit something, undo, or redo.

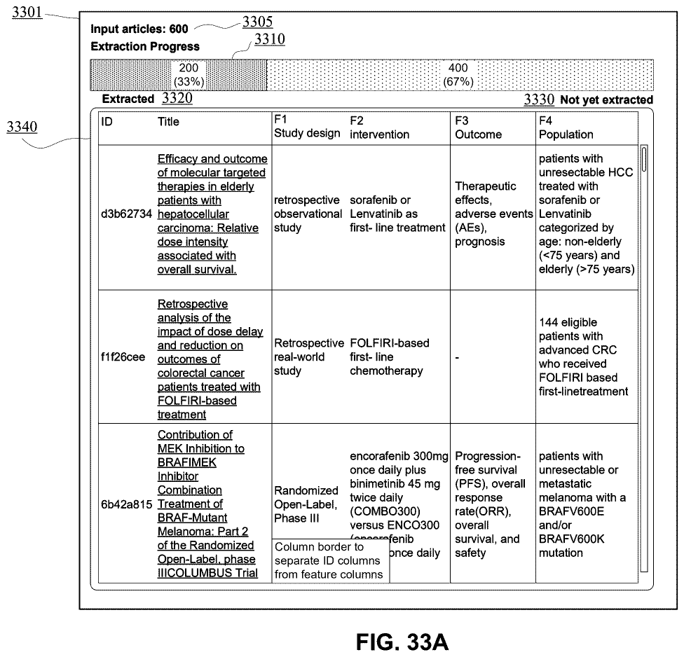

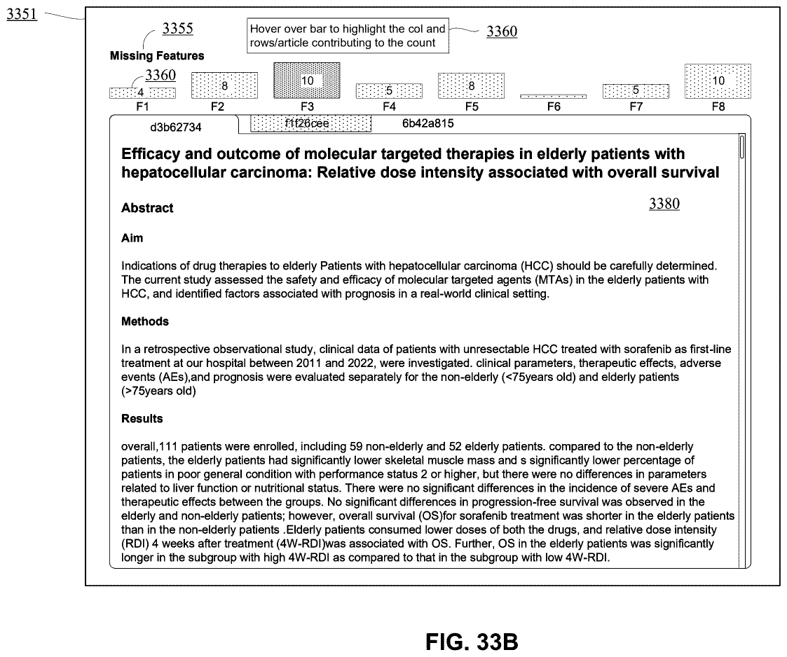

FIGS. 33A and 33B present examples of user interfaces that display various types of information during data extraction process. An example user interface 3301 presents examples of user interface elements that can be used to provide information regarding extracted data and status of data extraction process. A user interface element 3305 presents a number of input articles from which data is being extracted. A graphical user interface element 3310, presents a status of extraction progress. The graphical user interface element 3310 includes a progress bar that graphically identify the extraction progress. In the example shown in FIG. 33A, data from two hundred articles out of a total of six hundred articles has been extracted indicating a progress of about 33% (3320). Similarly, a portion (3330) of the graphical user interface 3310 indicates that four hundred articles have not yet been processed indicating that data from about 67% of total articles is not extracted. A user interface element 3340 comprises a table that displays data from extracted articles. The table comprise columns presenting article identifiers (ID), titles of articles (title) and feature columns with headers that identify F number (F #) identifiers (F1, F2, F3 and F4) for respective columns in the table. For example, in FIG. 33A, there are four feature columns F1 (Study design), F2 (intervention), F3 (outcome) and F4 (population). A user interface 3351 as shown in FIG. 33B presents additional features related to the extraction progress as shown in FIG. 33A. In one implementation, the user interfaces 3301 and 3351 are presented or displayed on a same screen to the user. In such implementation, the user interfaces 3301 and 3351 can be placed side by side or any other orientation to arrange the extraction data information for the user. A user interface element 3355 graphical displays statistics about missing features. For example, the user interface element 3355 shows that feature “F1” is missing from four (4) articles, feature “F2” is missing from eight (8) articles, feature F3 is missing from ten (10) articles, and son. A user can select one of the user interface elements 3360 for a particular feature and the Auto-SLR subsystem comprises logic to display articles (in a tabular format) in which the particular feature is missing. This feature allows users to quickly review source articles in which particular features are missing. A user interface element 3380 displays the full text of the articles in a plurality of tabs. The tabs identify article identifiers and a user can select a tab to review details of the article.

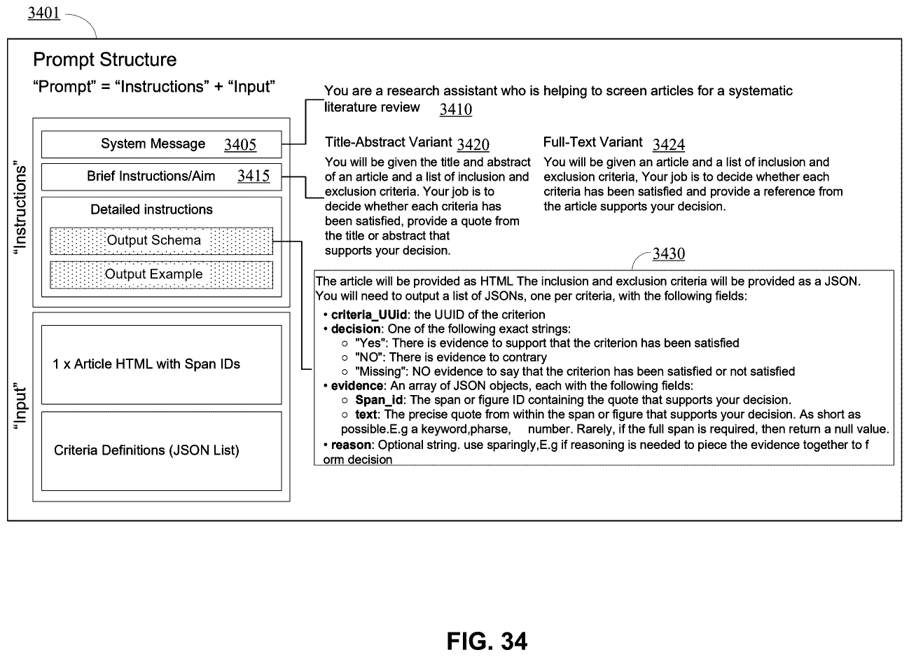

FIG. 34 presents an example “prompt” structure (3401) for a large language model (LLM) for article screening. The “prompt” comprises two parts, i.e., “instructions” and “input.” The instructions further comprise a system message, brief instructions or aim, detailed instructions, output schema and output example. FIG. 34 presents examples of system message (3405) by text 3410. An example of brief instructions or aim (3415) is presented by a text 3420 (for a title-abstract variant) and by a text 3424 (for a full-text variant). An example of output schema is presented by text 3430 in FIG. 34. It is understood that other prompt structures can be used by the technology disclosed and that other parts of the technology disclosed may use similar prompt structures to the one described in FIG. 34.

Document Comprehender application in the Auto-SLR process: As mentioned during the explanations of some of the steps, an SLR at hand may be inspired by a past SLR, for example, some articles may be included from a previously published SLR on the same or similar topic, or protocol elements such as search terms or inclusion-exclusion criteria may be sourced from a similar or related SLR, and henceforth directly used or adapted into this SLR, or a template for writing the SLR may be adapted to this SLR. To this end, Auto-SLR constitutes a Document Comprehender process, which is run offline and is used to gather and index past SLR-s for use in new SLR-s, as illustrated in FIG. 1.

Training of Auto-SLR subsystem and its constituent parts: Any part (component, module, etc.) of Auto-SLR subsystem, implementing one or more operations described above, may be trained either using back-propagation or another technique depending on the algorithm used in it. The adaptations in training may be made through prompt engineering in an Auto-LLM loop, Auto-ML loop, at the level of natural language (where an LLM is used in the place of the machine learning engineer), or on the level of coding language, where a machine learning engineer uses a Q-Lora or another algorithm to run training in Python or another coding language. This may result in specialized base models for steps like screening, extraction, search. The input to the training process is a training dataset and labels. The training dataset may be obtained from the real world, or it may be simulated, possibly by a generative model, in a GAN-like process with discriminator and generator LLM working in tandem.

Active learning in AutoSLR and its constituent parts. Active learning may be performed during any of the steps in the AutoSLR process, and across the whole application. In Auto-Screening (third process operation) for example, the user may manually make inclusion-exclusion decisions on sets of articles, and the system may learn the relevant sets of keywords, inclusion-exclusion criteria or other features that may then be used to automatically make decisions on the rest of the articles input to the screening step. As another example, the system may learn to provide output in the form that suits best a particular user or group of users.

Privacy in learning: In one implementation, the learning loop in Auto-SLR is private. On private datasets, only the set of documents and only the features of the documents that the user has enabled are used for learning, and if they are used, the model that results can be made available only to the specific user that requests model training. Given the sensitive and proprietary nature of data handled by the Auto-SLR subsystem and Auto-Dossier subsystem, the default is to not use customer data for learning, and where enabled, the specific features of user interactions that are used for learning are specified precisely and involve steps to ensure that only anonymized and non-sensitive general insights are used for learning.

### Synergies Between Auto-Dossier and Auto-SLR

Auto-Dossier subsystem may have a more diverse graph for routing because the output is typically much more complicated in Auto-Dossier.

Auto-SLR subsystem has systematic methodology for screening and the other operation steps, and the output from Auto-SLR subsystem can be used as evidence to write some of the dossier sections. For example, the Auto-SLR subsystem may contain research papers, summaries, and a narrative review of published research articles relevant to the use case in hand.

The size and extent of the inputs is typically greater in Auto-Dossier subsystem (CSR-s can contain thousands of pages whereas articles are typically up to tens of pages) however Auto-SLR subsystem may involve a very large count of articles at the screening stage, e.g., up to tens of thousands or more.

Similar to Auto-SLR subsystem, the protocol can be refined in the Auto-Dossier subsystem after initialization, and the effect of different parameter selections and the effect of regulatory strategies can be simulated rapidly more tangibly in order to see their effect more rapidly and tangibly at the early stages of a project, and therefore make better study design and operational decisions, saving biotechnology and other innovative companies time, labor and money.

The Auto-SLR subsystem can implement a protocol for the SLR meant to produce the SLR in an effective and efficient manner, in alignment with evidence synthesis guidelines (e.g., Cochrane guidelines). The Auto-Dossier subsystem has regulatory strategy for the dossier meant to produce the dossier in an effective and efficient manner, in alignment with regulatory requirements and guidelines.

Auto-Dossier Subsystem comprises logic to take as input a set of input documents, allows the user to select a goal (what document they want to submit) and then uses relevant content from the input documents in the right places to write the output document. It then also provides advice to the user through natural language and potentially other modalities. Use of LLMs to both automate steps in document parsing and also make economic optimal decisions on which parts to parse and what to send to humans for parsing.

The input can be in various formats. E.g., SEND, and input an audio or video inputs in the future. The dossier can be shaped based on past dossiers that have been accepted or rejected.

Comparison of learned insights across all studies extracted from the documents.

Provenance behavior and algorithm, for audit trail.

Behavior from user's perspective: when click on output span, the corresponding span where the data came from is highlighted.

Algorithm for producing this behavior: the LLM when writing is asked to enter references during writing time. This behavior is achieved either through prompting or training. The prompt asks the LLM to place the references during writing time. A special character is used for this. To avoid confusing this character, the documents when ingested to the platform are scanned for this character and the character is replaced with other characters. This is achieved by asking the LLM to insert references at the time of writing. It maintains the references through the process. The subsystem prompts the LLM to place references for every fact it uses, as HTML spans. The subsystem requests the LLM to use HTML. The subsystem transforms all documents into HTML in the platform.

Auto-SLR Subsystem: Automates systematic literature review for evidence synthesis using LLMs, starting with initial analyses and iteratively refining methodologies based on dataset feedback. Use of LLM-s to make optimal trade-offs between query precision, screening volume and resource requirements to complete the literature review. In one implementation, the Auto-SLR subsystem comprises, (1) use of chat to edit things on the screens, (2) use of LLM to generate a protocol for a step, and then to execute the step and produce results, (3) follows a standard process, (4) logic for provenance throughout, (5) logic to zoom into a sub-document in the process and optimize that, then return to the top level.

The Auto-SLR subsystem takes as input a research question at a minimum, and provides an answer to that research question as output. Performs evidence synthesis, according to standard guidelines and procedures. The technology disclosed uses PICOS and other frameworks to structure the questions and the screening criteria in the pipeline.

At the data gathering step, it tries different search queries on e.g., PubMed, and looks at the results at increasingly complex levels of analysis (count, title, abstract, full text) at decreasing counts (unlimited, thousands, hundreds, tens). The technology disclosed generates methodology to answer the question, tests the methodology on a subset of the available data, refines its methodology based on the small set of data, and then continues with more confidence.

Humans can be involved at each stage, and may provide input using various user interfaces.

The technology disclosed comprises semantic process prioritization and selection algorithm. The technology disclosed comprises multi-resolution strategic processing under cost and time constraints. LLM can be used to decide what to process next based on its current state of knowledge and the available options for further processing and the goals for the project. The LLM maintains a map of the documents it could process. LLM context use is chosen carefully. This is about how to use the LLM resource (e.g., context window; cost) smartly, optimally in the backend. What questions to ask. Prompts generated from e.g., figures.

Suggests most valuable questions to ask, given user goals. Picks the areas of the input that should be considered for answering the questions.

Prioritizing the key questions that are important to get the therapeutic to the market.

The technology disclosed can send some task to humans, others to LLMs.

The technology disclosed can select the sets of questions to ask based on the documents optimally. The technology disclosed can select the document elements to spend compute (i.e., computational resources) on and focus on based on superficial analysis.

The questions are obtained from an LLM who is prompted for a set of questions.

In one implementation one AI agent or LLM can interact with another AI agent or LLM. The LLM can be asked to produce instructions to other LLMs. For example, asked to produce a prompt for another LLM.

### Computer System

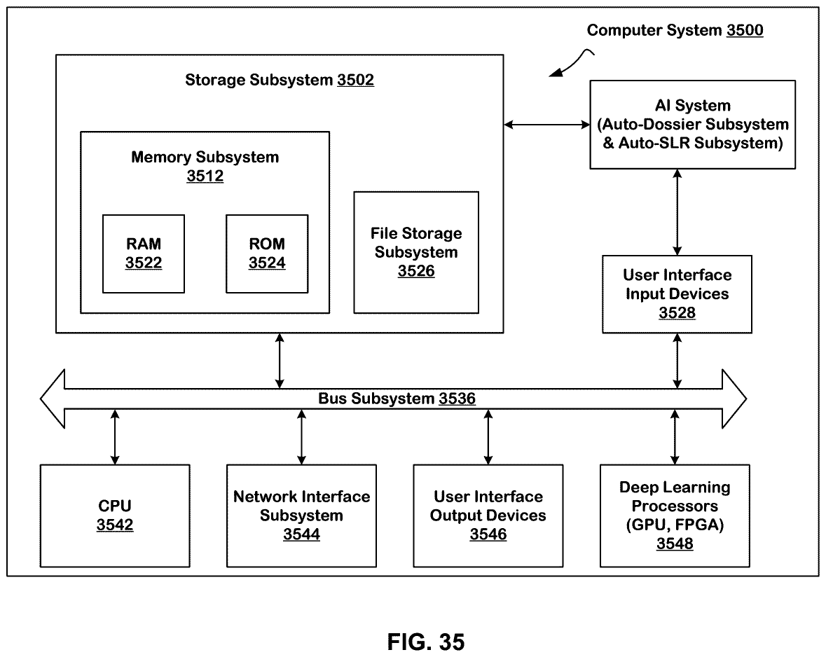

FIG. 35 shows an example computer system 3500 that can be used to implement the technology disclosed. Computer system 3500 includes at least one central processing unit (CPU) 3542 that communicates with a number of peripheral devices via bus subsystem 3526. These peripheral devices can include a storage subsystem 3502 including, for example, memory devices and a file storage subsystem 3526, user interface input devices 3528, user interface output devices 3546, and a network interface subsystem 3544. The input and output devices allow user interaction with computer system 3500. Network interface subsystem 3544 provides an interface to outside networks, including an interface to corresponding interface devices in other computer systems.

In one implementation, the disclosed Auto-Dossier subsystem and/or Auto-SLR subsystem are communicably linked to the storage subsystem 3502 and the user interface input devices 3528.

User interface input devices 3528 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 3500.

User interface output devices 3546 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 3500 to the user or to another machine or computer system.

Storage subsystem 3502 stores programming and data constructs that provide the functionality of some or all of the modules and methods described herein. These software modules are generally executed by processors 3548.

Processors 3548 can be graphics processing units (GPUs), field-programmable gate arrays (FPGAs), application-specific integrated circuits (ASICs), and/or coarse-grained reconfigurable architectures (CGRAs). Processors 3548 can be hosted by a deep learning cloud platform such as Google Cloud Platform™, Xilinx™, and Cirrascale™. Examples of processors 3548 include Google's Tensor Processing Unit (TPU)™, rackmount solutions like GX4 Rackmount Series™, GX13 Rackmount Series™, NVIDIA DGX-1™, Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 3512 used in the storage subsystem 3502 can include a number of memories including a main random access memory (RAM) 3522 for storage of instructions and data during program execution and a read only memory (ROM) 3524 in which fixed instructions are stored. A file storage subsystem 3526 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 3526 in the storage subsystem 3502, or in other machines accessible by the processor.

Bus subsystem 3536 provides a mechanism for letting the various components and subsystems of computer system 3500 communicate with each other as intended. Although bus subsystem 3536 is shown schematically as a single bus, alternative implementations of the bus subsystem can use multiple busses.

Computer system 3500 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 3500 depicted in FIG. 35 is intended only as a specific example for purposes of illustrating the preferred implementations of the present technology disclosed. Many other configurations of computer system 3500 are possible having more or less components than the computer system depicted in FIG. 35.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 35 is a schematic of an exemplary computer system or computing node (also referred to as a network node). Computing node 3500 is only one example of a suitable computing node and is not intended to suggest any limitation as to the scope of use or functionality of embodiments described herein. Regardless, computing node 3500 is capable of being implemented and/or performing any of the functionality set forth hereinabove. As used herein, the computing node (or network node) is an addressable hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Computing nodes or network nodes can be implemented in a cloud-based server system and/or a local system. More than one virtual device configured as a network node can be implemented using a single physical device.

In the Computing node 3500 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, mobile computing devices including mobile phones, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 35, computer system/server in computing node 3500 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

### Clauses

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:
1. A system for automating generation of dossiers that are compliant with regulatory guidelines, comprising:
   dossier generation logic configured to generate a regulatory-compliant dossier for a target, comprising:
      a first processing engine configured to take as input a set of source documents associated with the target and a set of dossier requirements associated with the regulatory-compliant dossier;
      the first processing engine further configured to process source documents in the set of source documents in dependence upon dossier requirements in the set of dossier requirements, and to determine one or more source sections in the source documents that are correlated with corresponding dossier sections in the regulatory-compliant dossier; and
      a second processing engine, in communication with the first processing engine, and configured to take as input the source documents and section-wise guidelines for generating the corresponding dossier sections, and to generate as output the regulatory-compliant dossier containing the corresponding dossier sections.
2. The system of clause 1, wherein the source sections include tables of content, figures, tables, and studies.
3. The system of clause 1, wherein the source documents include at least one study report.*
4. The system of clause 3, wherein the study report is a clinical study report.
5. The system of clause 3, wherein the study report is a non-clinical study report.
6. The system of clause 3, wherein the source sections of the study report include tables that summarize toxicology data in model organisms, tables that summarize pharmacokinetic data in model organisms, tables that summarize pharmacology data in model organisms, tables that estimate maximal safe dose across model organisms, tables that estimate minimal therapeutic dose across model organisms adverse effect result tables, and sections that describe toxic effects in particular individual animals.*
7. The system of clause 6, wherein the source sections of the study report include sections that describe pharmacokinetic effects in particular individual animals, sections that describe pharmacological effects in particular individual animals, sections that describe the methodology applied for data analysis, figure that shows the maximal safe dose across model organisms, and figure that shows the minimal therapeutic dose across model organisms.
8. The system of clause 1, wherein the first processing engine is further configured to independently process each of the source documents.*
9. The system of clause 8, wherein the first processing engine is further configured to detect a table of contents in each of the source documents.*
10. The system of clause 9, wherein the first processing engine is further configured to use the table of contents in each of the source documents to determine the source sections that satisfy the dossier requirements.*
11. The system of clause 1, wherein the dossier requirements specify a dossier writing task.
12. The system of clause 11, wherein the dossier writing task is determined from at least one of the source documents.
13. The system of clause 12, wherein the source documents include at least one target product profile, wherein the dossier writing task is determined from the target product profile.
14. The system of clause 1, wherein the dossier requirements specify a plurality of variables.
15. The system of clause 14, wherein the plurality of variables includes application type, target population, target indication, product dose form, approval geography, regulatory pathway, use endpoint, location of clinical trials, applicant's commercial preferences, approval likelihood, budget constraints, and timeline constraints.
16. The system of clause 15, wherein the dossier type includes clinical trial applications, market authorization applications, reimbursement applications, and compliance applications.
17. The system of clause 15, wherein the clinical trial applications include first-in-human clinical trial applications and investigational new drug applications.
18. The system of clause 15, wherein the market authorization applications include label claim applications, new drug applications, and biologics license application.
19. The system of clause 15, wherein the dossier type includes reimbursement applications such as health technology applications.
20. The system of clause 1, wherein the second processing engine is further configured to generate the corresponding dossier sections in a Common Technical Document (CTD) data format.*
21. The system of clause 1, wherein the target is a drug molecule.*
22. The system of clause 21, wherein the source documents include Chemistry, Manufacturing, and Controls (CMC) information about the drug molecule.*
23. The system of clause 22, wherein the CMC information is in a Drug Master File.
24. The system of clause 23, wherein the second processing engine is further configured to include molecular structure information of the drug molecule in the regulatory-compliant dossier.
25. The system of clause 23, wherein the second processing engine is further configured to include manufacturing process flowcharts of the drug molecule in the regulatory-compliant dossier.
26. The system of clause 23, wherein the second processing engine is further configured to include batch records of the drug molecule in the regulatory-compliant dossier.
27. The system of clause 23, wherein the second processing engine is further configured to include clinical information of the drug molecule in the regulatory-compliant dossier.
28. The system of clause 1, wherein the first processing engine is further configured to generate summaries of at least some of the source sections.*
29. The system of clause 28, wherein the second processing engine is further configured to take as the input the summaries, and to generate as the output the regulatory-compliant dossier containing the corresponding dossier sections.
30. The system of clause 1, wherein the section-wise guidelines are configured to specify output information to be included in the corresponding dossier sections.*
31. The system of clause 30, wherein the section-wise guidelines are further configured to specify authoring information on how the corresponding dossier sections are to be authored.
32. The system of clause 31, wherein the authoring information is configured to specify information sequencing, summarization ways, tone, and text length.
33. The system of clause 30, wherein the section-wise guidelines are in an unstructured natural language format.
34. The system of clause 30, wherein the section-wise guidelines are in a structured prescriptive format.
35. The system of clause 30, wherein the section-wise guidelines are sourced from The International Council for Harmonisation of Technical Requirements for Pharmaceuticals for Human Use (ICH).
36. The system of clause 30, wherein the section-wise guidelines are sourced from The United States Food and Drug Administration (FDA or US FDA).
37. The system of clause 30, wherein the section-wise guidelines are sourced from expertise of consultants with prior experience in dossier drafting.
38. The system of clause 30, wherein the section-wise guidelines are sourced from example dossiers.
39. The system of clause 30, wherein the section-wise guidelines are sourced from dossier templates.
40. The system of clause 30, wherein the section-wise guidelines are generated by a large language model (LLM).*
41. The system of clause 40, wherein the LLM is configured to generate the section-wise guidelines as prompts in response to processing the example dossiers and the dossier templates, along with some explanatory directives (e.g., papers on prompt writing).
42. The system of clause 1, wherein the second processing engine is further configured to take as the input example pairs of source sections and corresponding dossier sections from the example dossiers, and to generate as the output the regulatory-compliant dossier containing the corresponding dossier sections.
43. The system of clause 1, wherein the second processing engine is further configured to take as the input certain contextual information about the regulatory-compliant dossier, and to generate as the output the regulatory-compliant dossier containing the corresponding dossier sections.
44. The system of clause 1, wherein the certain contextual information includes overall goal of the regulatory-compliant dossier, overall goal of the target, and overall goal of a company seeking the regulatory-compliant dossier.
45. The system of clause 1, wherein the second processing engine is further configured to generate as the output provenance information mapping which portions of the corresponding dossier sections are generated from which portions of the source sections.*
46. The system of clause 45, wherein the mapping is at a word resolution, a sentence resolution, a paragraph resolution, a page resolution, and a section resolution.
47. The system of clause 1, wherein the first processing engine is a first large language model (LLM).*
48. The system of clause 47, wherein the second processing engine is a second large language model (LLM).*
49. The system of clause 1, wherein the target is an entity.
50. The system of clause 49, wherein the target is a medical device.
51. The system of clause 50, wherein the target is a drug.
52. The system of clause 50, wherein the target is a chemical.
53. The system of clause 50, wherein the target is a food.
54. The system of clause 1, wherein the first and second processing engines are same.
55. The system of clause 1, further configured to verify the regulatory-compliant dossier.*
56. The system of clause 55, further configured to verify that the regulatory-compliant dossier is compliant with guidelines.
57. The system of clause 55, further configured to verify that facts in the regulatory-compliant dossier are coherent with each other.
58. The system of clause 1, further configured to receive user input and make changes to the regulatory-compliant dossier based on the user input.
59. The system of clause 58, wherein the user input comprises user clicks to portions of the regulatory-compliant dossier.
60. The system of clause 59, wherein the portions include sentences.
61. The system of clause 1, further configured to comprise a checker-LLM configured to check work of prior LLMs.
62. The system of clause 61, wherein the checker-LLM is further configured to check human works.
63. The system of clause 1, further configured to comprise a publishing logic that pushes the regulatory-compliant dossier to one or more regulators.*
64. The system of clause 1, wherein the source documents that are to be used with the corresponding dossier sections in the regulatory-compliant dossier.
65. The system of clause 1, wherein the source documents include public documents.
66. The system of clause 1, wherein the source documents are scouted from the Internet.
67. The system of clause 66, wherein an Auto-SLR processor scouts the source documents from the Internet.
68. The system of clause 14, wherein the dossier requirements specify a set of guidelines based on matching an applicant's goals to a department of a subject regulator.
69. The system of clause 68, wherein the set of guidelines is applied based on precedents of the department and matches of the plurality of variables.
70. The system of clause 68, wherein the set of guidelines is applied based on advice from consultants selected based on their recent experience in similar disease area.
71. The system of clause 1, wherein the target is at least one of medical devices, patent applications, proposals, and legal contracts.
72. The system of clause 1, further configured to integrate the regulatory-compliant dossier with EDMS systems, TMF systems, CRO systems, and/or consultants.
73. The system of clause 1, further configured to chunk the source documents into multiple chunks.
74. The system of clause 73, further configured to perform an initial processing based on extraction from part of the source documents, and then perform a later more granular extraction and routing and writing done based on substantial portions of the source documents.
75. The system of clause 1, further configured to plan the construction of the regulatory-compliant dossier.
76. The system of clause 1, wherein the regulatory-compliant dossier includes FDA meeting minutes.
77. The system of clause 1, wherein the regulatory-compliant dossier includes clinical study reports.
78. The system of clause 1, wherein the regulatory-compliant dossier includes global value dossiers (GVDs).
79. The system of clause 1, wherein the regulatory-compliant dossier includes health technology assessments (HTAs).
80. The system of clause 1, wherein the regulatory-compliant dossier is deployed partially on cloud including public data, and partially on local compute including user data and/or proprietary data.
81. The system of clause 80, wherein at least some of the proprietary data is masked out or anonymized.
82. The system of clause 1, wherein the regulatory-compliant dossier is sent to regulators in FHIR standard.
83. The system of clause 1, wherein the source documents are checked for self-consistency and for whether they meet regulator acceptance criteria based on regulator guidelines, meeting minutes, public precedence parts, and/or proprietary precedents.
84 The system of clause 1, wherein one or more guidelines are selected based on regulator guideline matching to target product profile variables, public precedent matching to regulator guideline variables, private precedent matching to TPP variables, and/or published research around the subject.
85 The system of clause 1, further configured to inform later studies.
86 The system of clause 1, further configured to have multiple logins and multiple users working concurrently.
87. A system for automating generation of dossiers that are compliant with regulatory guidelines, comprising:
   dossier generation logic configured to generate a regulatory-compliant dossier for a target, comprising:
      one or more processing engines configured to:
         take as input a set of source documents associated with the target and a set of dossier requirements associated with the regulatory-compliant dossier; and
         generate as output the regulatory-compliant dossier containing dossier sections that are correlated with source sections in the source documents.
88. The system of clause 87, wherein the processing engines are large language models (LLMs).
89. A system for automating generation of dossiers that are compliant with regulatory guidelines, comprising:
   dossier generation logic configured to generate a regulatory-compliant dossier for a target, comprising:
      a first processing engine configured to take as input a set of source documents associated with the target and a set of dossier requirements associated with the regulatory-compliant dossier;
      the first processing engine further configured to process source documents in the set of source documents in dependence upon dossier requirements in the set of dossier requirements, and to determine one or more source sections in the source documents that are correlated with corresponding dossier sections in the regulatory-compliant dossier; and
      a second processing engine, in communication with the first processing engine, and configured to take as input the source documents for generating the corresponding dossier sections, and to generate as output the regulatory-compliant dossier containing the corresponding dossier sections.
90. A system, comprising:
   one or more processing engines configured to:
      take as input a set of source documents;
      generate as output at least one output document containing output sections that are correlated with source sections in the source documents; and
      generate provenance data identifying which portions of the output sections are generated from which portions of the source sections.
91. The system of clause 90, wherein the processing engines are large language models (LLMs).
92. The system of clause 1, further configured with logic to receive feedback on the regulatory-compliant dossier and automatically update parameters of the at least one of the first processing engine and the second processing engine to improve future dossier generation based on the feedback.

1. A system for automating generation of dossiers that are compliant with regulatory guidelines, comprising:
dossier generation logic configured to generate a regulatory-compliant dossier for a target, comprising:
a first processing engine configured to take as input a set of source documents associated with the target and a set of dossier requirements associated with the regulatory-compliant dossier;
the first processing engine further configured to process source documents in the set of source documents in dependence upon dossier requirements in the set of dossier requirements, and to determine one or more source sections in the source documents that are correlated with corresponding dossier sections in the regulatory-compliant dossier; and
a second processing engine, in communication with the first processing engine, and configured to take as input the one or more source sections in the source documents and section-wise guidelines for generating the corresponding dossier sections, and to generate as output the regulatory-compliant dossier containing the corresponding dossier sections.

2. The system of claim 1, wherein the source documents include at least one study report.

3. The system of claim 2, wherein the one or more source sections of the at least one study report include tables that summarize toxicology data in model organisms, tables that summarize pharmacokinetic data in model organisms, tables that summarize pharmacology data in model organisms, tables that estimate maximal safe dose across model organisms, tables that estimate minimal therapeutic dose across model organisms adverse effect result tables, and sections that describe toxic effects in particular individual animals.

4. The system of claim 1, wherein the first processing engine is further configured to independently process each of the source documents.

5. The system of claim 4, wherein the first processing engine is further configured to detect a table of contents in each of the source documents.

6. The system of claim 5, wherein the first processing engine is further configured to use the table of contents in each of the source documents to determine the one or more source sections that satisfy the dossier requirements.

7. The system of claim 1, wherein the second processing engine is further configured to generate the corresponding dossier sections in a Common Technical Document (CTD) data format.

8. The system of claim 1, wherein the target is a drug molecule.

9. The system of claim 1, wherein the first processing engine is further configured to generate summaries of at least some of the one or more source sections.

10. The system of claim 1, wherein the section-wise guidelines are configured to specify output information to be included in the corresponding dossier sections.

11. The system of claim 10, wherein the section-wise guidelines are generated by one or more large language models (LLMs).

12. The system of claim 1, wherein the second processing engine is further configured to generate as the output, provenance information mapping which portions of the corresponding dossier sections are generated from which portions of the one or more source sections.

13. The system of claim 1, wherein the first processing engine comprises one or more first large language models (LLMs).

14. The system of claim 13, wherein the second processing engine comprises one or more second large language models (LLMs).

15. The system of claim 1, further configured to verify the regulatory-compliant dossier.

16. The system of claim 8, wherein the source documents include Chemistry, Manufacturing, and Controls (CMC) information about the drug molecule.

17. The system of claim 1, further configured to comprise a publishing logic that pushes the regulatory-compliant dossier to one or more regulators.

18. A system for automating generation of dossiers that are compliant with regulatory guidelines, comprising:
dossier generation logic configured to generate a regulatory-compliant dossier for a target, comprising:
one or more processing engines configured to:
take as input a set of source documents associated with the target and a set of dossier requirements associated with the regulatory-compliant dossier; and
generate as output the regulatory-compliant dossier containing dossier sections that are correlated with source sections in the source documents.

19. A system for automating generation of dossiers that are compliant with regulatory guidelines, comprising:
dossier generation logic configured to generate a regulatory-compliant dossier for a target, comprising:
a first processing engine configured to take as input a set of source documents associated with the target and a set of dossier requirements associated with the regulatory-compliant dossier;
the first processing engine further configured to process source documents in the set of source documents in dependence upon dossier requirements in the set of dossier requirements, and to determine one or more source sections in the source documents that are correlated with corresponding dossier sections in the regulatory-compliant dossier; and
a second processing engine, in communication with the first processing engine, and configured to take as input the one or more source sections in the source documents for generating the corresponding dossier sections, and to generate as output the regulatory-compliant dossier containing the corresponding dossier sections.

20. A system, comprising:
one or more processing engines configured to:
take as input a set of source documents;
generate as output at least one output document containing output sections that are correlated with source sections in the source documents; and
generate provenance data identifying which portions of the output sections are generated from which portions of the source sections.
